(19) United States
(12) Patent Application Publication
(10) Pub. No.: US 2011/0078028 A1
(43) Pub. Date: Mar. 31, 2011

(54) ONLINE INTERACTIVE WEBSITE

(76) Inventors: Manuel Glynias, Cleveland, OH (US); Steve Gustafson, Brentwood, TN (US); Joseph Shuster, Bay Village, OH (US); Steven Kidwell, Strongsville, OH (US); Al Wojcik, Downers Grove, IL (US); Diane Fligiel, Schiller Park, IL (US); James Harrington, LasVegas, NV (US); Kevin Schroepfer, Lake Elmo, MN (US); Denny Hilgers, Roseville, MN (US); Matthew Hendricks, Menomonee Falls, WI (US); Dora Fields, Trenton, IL (US); David Stimpert, Cleveland Heights, OH (US); Wendy Glowski, San Diego, CA (US); Lori Vannelli, Cleveland Heights, OH (US); Adam Brown, Beachwood, OH (US); Nick Bleibtrey, Akron, OH (US); Larry Podluzne, Macedonia, OH (US); Joel McGahen, Richfield (OH); John McDonough, Avon Lake, OH (US); Lauren Rummel, Westlake, OH (US)

(21) Appl. No.: 12/570,087

(22) Filed: Sep. 30, 2009

(51) Int. Cl. G06Q 30/00; G06F 17/30; G06F 3/048; G06F 3/01

(52) U.S. Cl. 705/14.73; 707/769; 715/764; 715/760; 707/E17.014; 705/27.1

(57) ABSTRACT

An interactive online website enabling users to order products or services. The website dynamically provides a prepopulated order sheet displaying at least some sales history of products or services previously purchased by a website user. The order sheet may be organized to display a plurality of categories showing at least some of the products or services purchased by the consumer during a predetermined past period. The website may be configured to permit the user to browse the prepopulated order sheet and to enter order quantities for selected products or services.

### BACKGROUND OF THE INVENTION

The present invention generally relates to an online interactive website. More specifically, the invention relates to such a website enabling the customized purchase of goods and services, and offering customized deals tailored to the purchaser's preferences.

Online interactive websites can be relatively slow and cumbersome to use. It would be advantageous to provide a web site that is easy to access, fast and dynamic in nature, and facilitates ordering by providing customized deals tailored to the purchaser's preferences based on known purchaser history.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

“Achievement indicator” means a notification to the web site user that a consumer has qualified for a prospective deal.

“Combo” means a grouping of products or services that, when ordered together in predefined quantities, qualify the consumer for a discount or a free good, or some combination thereof.

“Consumer” means any individual or entity which is permitted to order products or services, either directly or indirectly on behalf of another, from the interactive online website, including but not limited to distributors, stores, retail chains, individuals, etc.

“Cross-sell” refers to one or more products or services which may be ordered on the website of the present invention and which are linked through a particular data feed relationship, such that when a user views such products or services, the user is presented with an option to swap the displayed product(s) or service(s) with another.

“Customized deal” means a deal in which one or more components of the deal have been constructed based on a customer parameter known to the website. (Customer parameters may include: the customer's ordering history, the customer account number (which may be associated with special account deals, for example), the type of customer (chain discounts might apply, for example), product level discounts (e.g., book discounts), and schedule deals (e.g., delivery date may determine whether or not customer will see a particular schedule discount).)

“Deal” means an offer by a party hosting the website or a party having a contractual arrangement with the party hosting the website.

“Dynamic” as applied to a webpage means a webpage that updates and changes in response to user interaction with the webpage.

“Espot” means an advertisement of one or more products or services which may be ordered on the website of the present invention, and for which the content is controlled by the website provider.

“Offline” means information conveyed by means other than through the Internet (e.g., by fax, telephone, paper or other transmission).

“Online” means information conveyed by means of the Internet.

“Order review screen” means a website page or portion thereof displayable on a screen, monitor or other display device, in which a preview of products or services which have been selected for ordering by a website user are shown, including quantities and pricing.

“Order sheet” means a website page or portion thereof displayable on a screen, monitor or other display device, in which products or services which may be ordered by a website user are shown.

“Pay link” means a link redirecting the website user to a separate website other than the interactive online website which is the subject of the present invention, enabling the website user to pay for products or services ordered during one or more sessions on the interactive online website. The pay link may be hosted by the host of the website of the present invention, or may be hosted by a third party (e.g., Pay Pal, E-Pay, etc.).

“Prepopulated” means the website is populated with information concerning a user and/or customer before the user enters any information on the website other than his/her login information, which enables the website to access user and/or customer history.

“Proximity indicator” means a notification to the website user that by taking a specific action, the consumer will qualify for a deal (e.g., “Order two more cases of [X product] to qualify for this deal.”).

“Single click” is used in reference to a computer peripheral device (whether the device is used to control a laptop or desktop computer or a PDA, for example), and means that a user, through a single manual action, such as by depressing a key or moving a lever, is able to commence an action, such as ordering products or services that were previously selected, without necessarily having to provide billing or shipping information (which was already provided and associated during the customer log-in procedure).

“Trade-up” refers to one or more products or services which may be ordered on the website of the present invention and which may be linked through a particular data feed relationship, such that when a user views such products or services, the user is presented with an option to swap the displayed product(s) or service(s) with a similar or comparable product(s) or service(s) of greater value.

“User” means anyone authorized to use the website, whether or not such user qualifies as a “consumer” as defined above. (“Users” may order on behalf of others, much as clearing houses can trade or engage in other activities on behalf of third parties.)

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings, in which:

FIGS. 1-4, 5A-5B, 6, 7A-7B, 8, 9A and 9B are selected, exemplary screen shots illustrating various features of the present invention, generated by a preferred embodiment of the website of the present invention;

FIG. 10 is a state diagram for the overall application, according to the preferred embodiment;

FIG. 11 is a state diagram for the deal display widget, according to the preferred embodiment;

FIG. 12 is a state diagram for user account management, according to the preferred embodiment;

FIG. 13 is a state diagram for transaction flow, according to the preferred embodiment;

FIGS. 14A-14GG are screen shots of the given state, according to the preferred embodiment, highlighted as necessary, that indicate where new information not elsewhere displayed on the web page may be retrieved from;

FIG. 15 is a general process flow describing the log-in and initialization procedures for the preferred embodiment;

FIGS. 16A-16L are flow charts describing individual custom-written services, as indicated, according to the preferred embodiment; and

FIGS. 17A-17J contain a description of nightly data loads, according to the preferred embodiment.

The components in the drawings are not necessarily to scale, emphasis instead being placed upon clearly illustrating the principles of the present invention.

### DETAILED DESCRIPTION OF THE PREFERRED EMBODIMENT

Set forth below is a description of what are believed to be the preferred embodiments and/or best examples of the invention claimed. Future and present alternatives and modifications to the preferred embodiments are contemplated. Any alternatives or modifications which make insubstantial changes in function, in purpose, in structure, or in result are intended to be covered by the claims of this patent.

Other websites have utilized IBM's e-commerce platform, Websphere Commerce (“WC”). While WC may be used, it was found that certain aspects of an interactive website, such as the generation of deals and the use of the browser/search engine, would benefit in terms of generation speed and efficiency, from the use of a search layer such as Lucene (with search layers, HTMLs are not always generated). Instead, to generate appropriate user interfaces, UI (a Google Web Tool Kit) may be used, for example, to generate dynamic HTML web pages using JAVA script.

### Easy Ordering

One of the challenges presented by prior websites and solved by the present invention was to create an interactive, online ordering website which would substantially reduce the amount of time that sales representatives spend on taking orders from customers, while allowing more time to focus on customer relationships and product promotion, and making it quick and easy for customers to re-order. The solution is to provide a user-friendly interface through which customers may place orders. The order sheet calculates user prices, providing discounts driven by customer history and by individual state laws, for example. Features such as up-selling, deal proximity indicators, and mix-and-match deals are provided, as further described below.

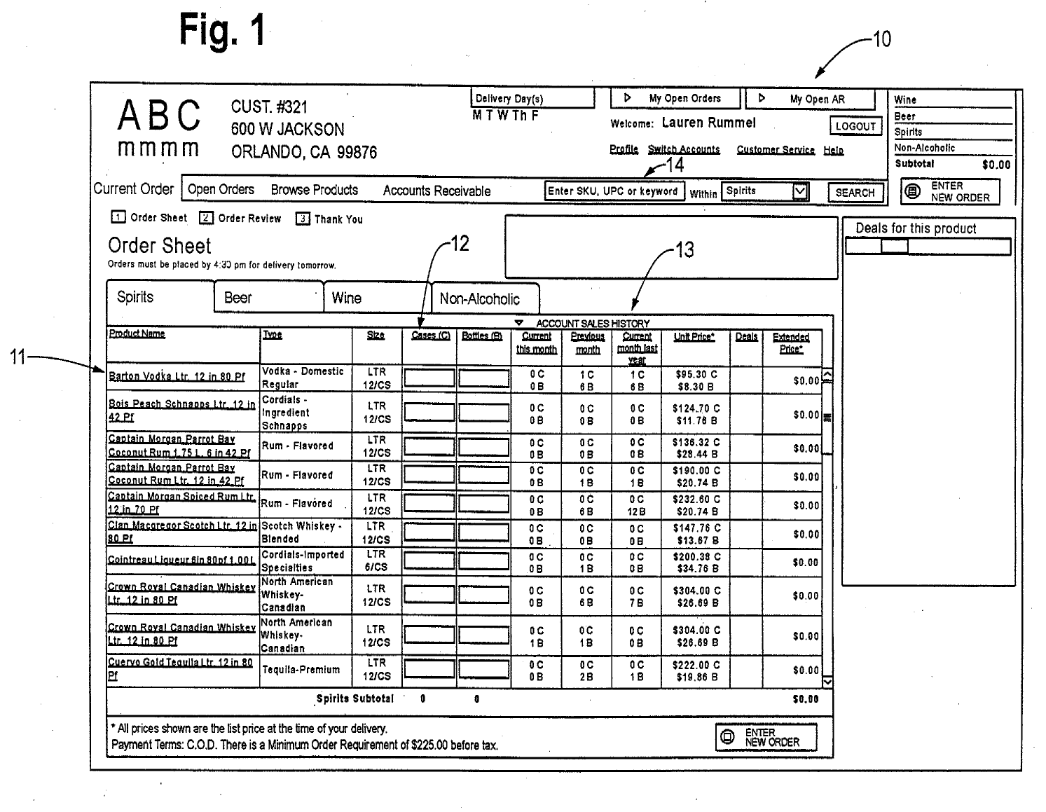

Several site elements facilitate the placement of orders by customers using the website to place orders with ease. One such site element is a prepopulated order sheet. A customer's displayed order sheet may be prepopulated with products or services that may be selected for ordering derived from that customer's sales history. The customer can browse through a prepopulated order sheet and enter order quantities as desired. Referring now to FIG. 1, an example of a prepopulated order sheet 10 which may be generated by the website and which may be displayed on a monitor, screen or other display device, is shown. Order sheet 10 may be organized into product/service category tabs 11. Each product/service category tab 11 may be populated with a customer's “Favorites,” or products or services that they have ordered in a preselected span of sales history (e.g., 5 months), such as: current month, previous month, two months prior, current month/last year, and next month/last year (to provide a view of seasonal products when on the cusp of a new season).

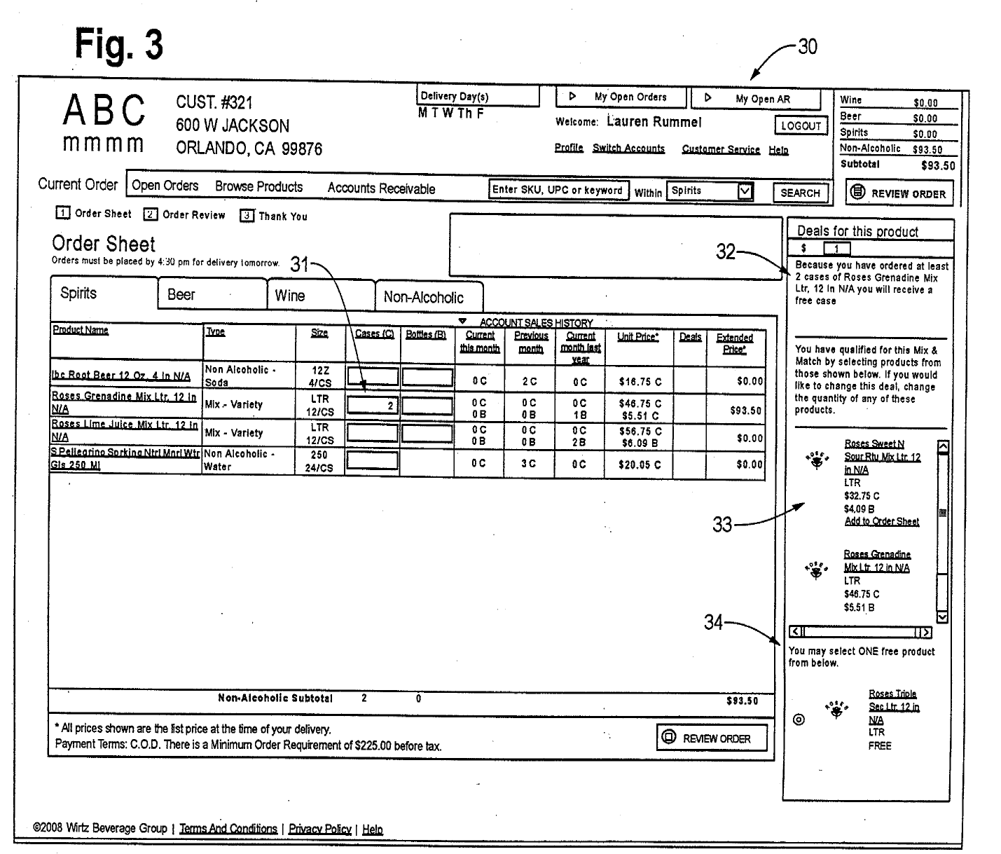

The order history may be drawn from an accumulation of data records sent from (e.g.) the manufacturer to the website provider, such as by nightly data feeds. (Data feeds may be used to drive the information a user sees; these feeds may be used to link products/services, and to determine what displays and deals the customer sees.) Each time a customer is invoiced for an order, a data feed with this record may be sent to the website provider. The website provider may accumulate the details of these orders, and pull (e.g.) five months' worth of order history to populate an Order Sheet (e.g., FIG. 3) with the customer's “Favorite” items. By populating the Order Sheet with items purchased in these five months, the application can account for ordering trends and seasonality; it can also tailor the ordering experience to a specific customer's preferences.

Referring back to FIG. 1, as shown in column 12, customers may select the product by container, such as (in the case of alcoholic beverages) cases, bottles, or a combination of both, for each product or service listed on order sheet 10. Referring to column 13, for each item on order sheet 10, a preselected amount of sales history data (e.g., 3 months) may be displayed: (e.g.), current this month, previous month, and current month/last year.

If a customer desires to order an item that is not in its sales history, the customer may use an advanced search tool, identified at 14, to search for a product by name, SKU # or UPC #; products so located may then be automatically placed in the customer's order sheet with a single click of a button. Customers may be offered an extensive product catalog, with a wide variety of products (e.g., in the case of beverages: spirits, wine, beer and non-alcoholic products). To provide the website with an easy way to browse this catalog, the application may feature a search field that dynamically reads each piece of a customer's search term(s) as it is entered and generates a list of auto-suggested terms. For example, as “water” is typed, after “w” is typed 20 search terms might be shown, whereas after “water” is typed, a drop-down may be displayed for “water,” “watermelon,” etc. Users can search by product name, SKU or UPC and view results across all product categories, or within one specific category. To further enhance the search experience, single-click, on-the-fly search results are provided; for example, certain results will be displayed for the search “France/Liter/Price”; now, if “Liter” is deleted, search results for “France/Price” will automatically be displayed (i.e., not limited to just those France-originating beverage products in liter bottles, and organized by price). Additionally, orders may be automatically repriced whenever a quantity is changed (e.g., added or removed, or quantity changed).

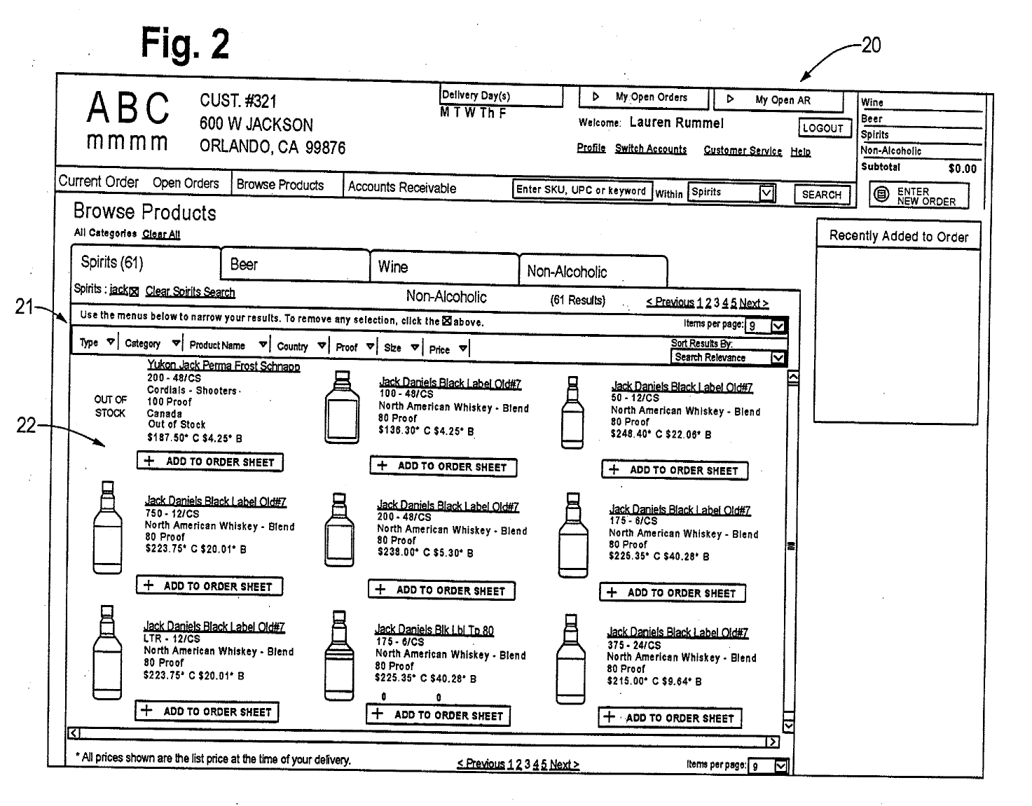

These and other features of the present invention may now be better understood by reference to exemplary screen shots which may be generated by a website designed according to the principles of the present invention, for display to a customer or other website user. Referring to the exemplary screenshot shown at FIG. 2, once a user submits his or her search, each product category tab may be populated with products that match the term(s) entered by the customer. The product category tab with the highest number of results may be displayed on top, and the number of results found is visible on the tabs for the other categories. Screen shot 20 may be generated when a customer and/or website user wishes to browse certain products, such as those generated when searching the website search engine. For example, when a user desires to locate an item that is not prepopulated on order sheet 10, browse panel 21 may be used for finding the item based on its product attributes (e.g., type of alcohol, container type, country of origin, etc.). Once the desired product is found, it can be automatically added to a customer's order sheet by clicking “Add to Order Sheet” panel 22.

Customer information (delivery, billing, etc) may be transmitted from a website provider, manufacturer, dealer or other party to a website host in periodic data feeds, for example. For example, when a customer logs in with his or her customer number, this information may be stored in the customer's session. As a result, there is no need for the customer to enter additional information—beyond the items they wish to order—before placing an order. Further, all pricing and order information may be displayed dynamically throughout a customer's session, so all that remains to be done once items are selected is the click of the Place Order button.

Various other features of the website of the present invention will be apparent from the disclosure provided below.

### Deals and Pricing

Another of the challenges presented by prior websites and solved by the present invention was to create an interactive, online ordering website which would: present users with current pricing information on items in the product catalog; display deals for which a customer qualifies; and prompt users to buy more of a product when they reach proximity to a deal (e.g., if at 60% to a deal, the user may see new deals designed to appear at this threshold for this type of customer). The preferred website of the present invention displays up-to-date and accurate pricing based on a customer's next delivery date. Pricing may be dictated by this and other product and customer attributes which may be defined based on periodic and/or contemporaneous data feeds provided to the website provider or host by customers or by product manufacturers or others.

In a preferred embodiment of the website, when a customer enters a quantity for a product or service on its order sheet, the deal display section of the site may be populated with information on applicable deals for the customer and the selected item. The site may be designed to award any type of deal including: Discounts, Free Goods, Mix and Match deals, and Combos (groupings of products that, when ordered together in pre-defined quantities, qualify a user for a discount and/or free good).

The Deal Display screen may show both “achievement” (“You have qualified for this deal) and “proximity” (“Order 2 more cases to qualify for this deal”) messaging. The website may be designed to automatically update the Deal Display based on the item selected on the order sheet. The Deal Display may also be visible on the order review screen so that all achieved deals may be reviewed before placing an order. Items on the order review screen may also be red-flagged (e.g. “#1 missed deal . . . ”) for the user.

Additionally, further adjustments to the pricing and discounts may be applied, such as but not limited to: taxes, delivery fees and keg deposits. These adjustments may be applied online if applicable to a particular customer or order item. These charges may be included in a customer's order total and may be viewed on the Order Review sheet.

Referring now to FIG. 3, exemplary screen shot 30 is shown, and may also be generated by the website of the present invention for display to a customer or other user. Screen shot 30 is an example of an order sheet. Several features of the order sheet are shown here. In the currently preferred embodiment, deal display 31 may change depending on the item active on order sheet 30. For example, deal messaging may only display if a user has reached proximity or achievement for a deal on the active item. (“Deal messaging” are messages that pop up to advise the user what he/she can achieve or will achieve, in terms of deals.) As another example of the currently preferred embodiment, deal achievement messages 32 may present the user with details on the applied deal. In screen shot 30 shown, for example, a free good deal has been applied based on order quantity for the Roses Grenadine product. Mix-and-match deals 33 may be provided, and allow a user to buy a combination of products to achieve a discount or free good deal. Items in a mix-and-match deal may be displayed when the deal is displayed. Referring to area 34, users may also view the item they receive as part of a free good deal in the deal display.

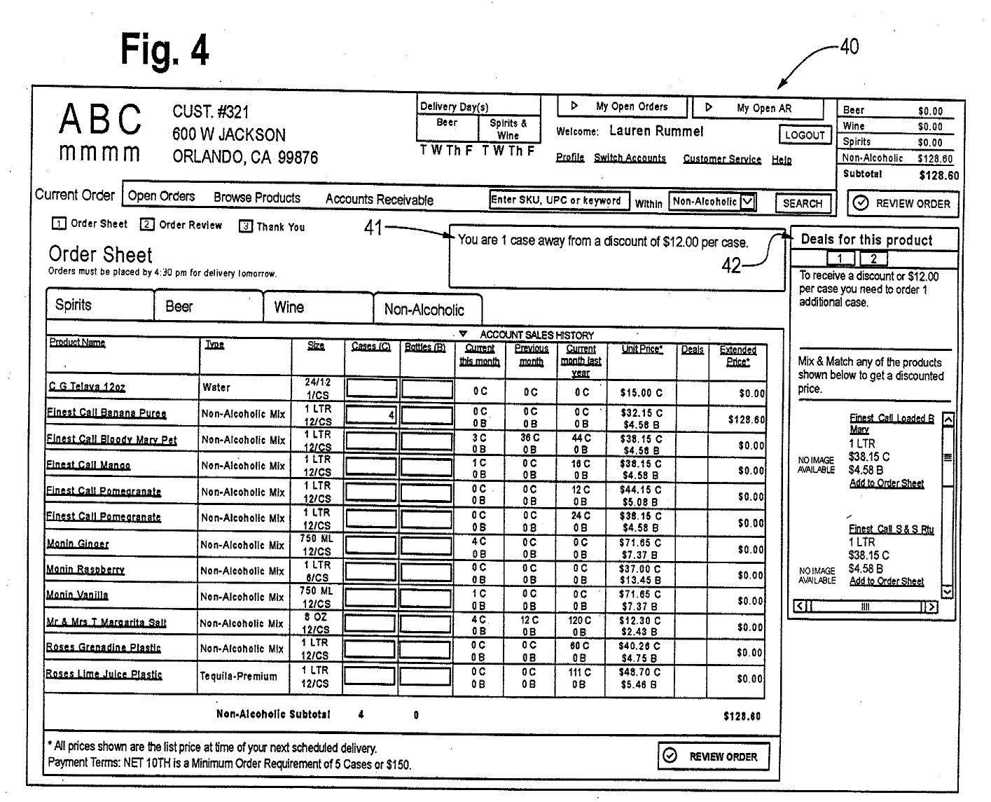

Referring now to FIG. 4, screen shot 40 is an example of a displayed order sheet which may be generated when a user has entered an order quantity at or above a defined proximity threshold for a deal. Proximity message 41 may then appear, prompting the user to order “x” more items to achieve a deal. A proximity message may also appear in the deal display 42. In exemplary screen shot 40, the user has achieved a deal and is being prompted to buy one more case to achieve the next tier of the deal.

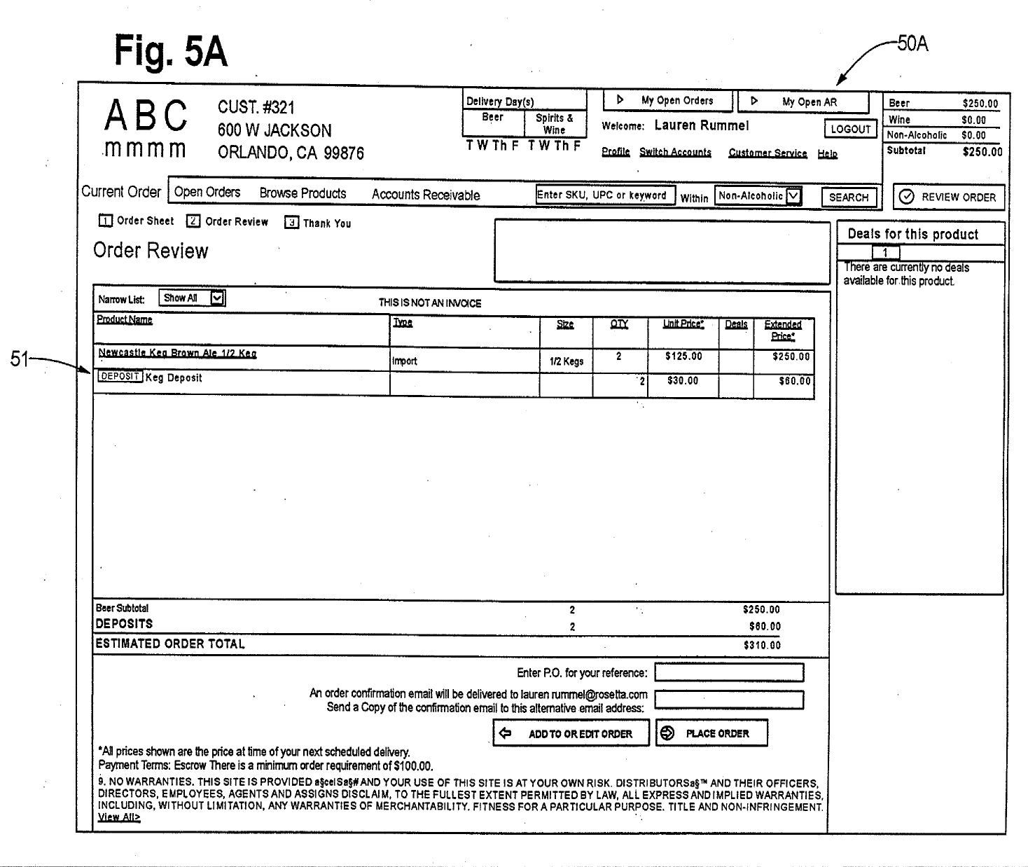

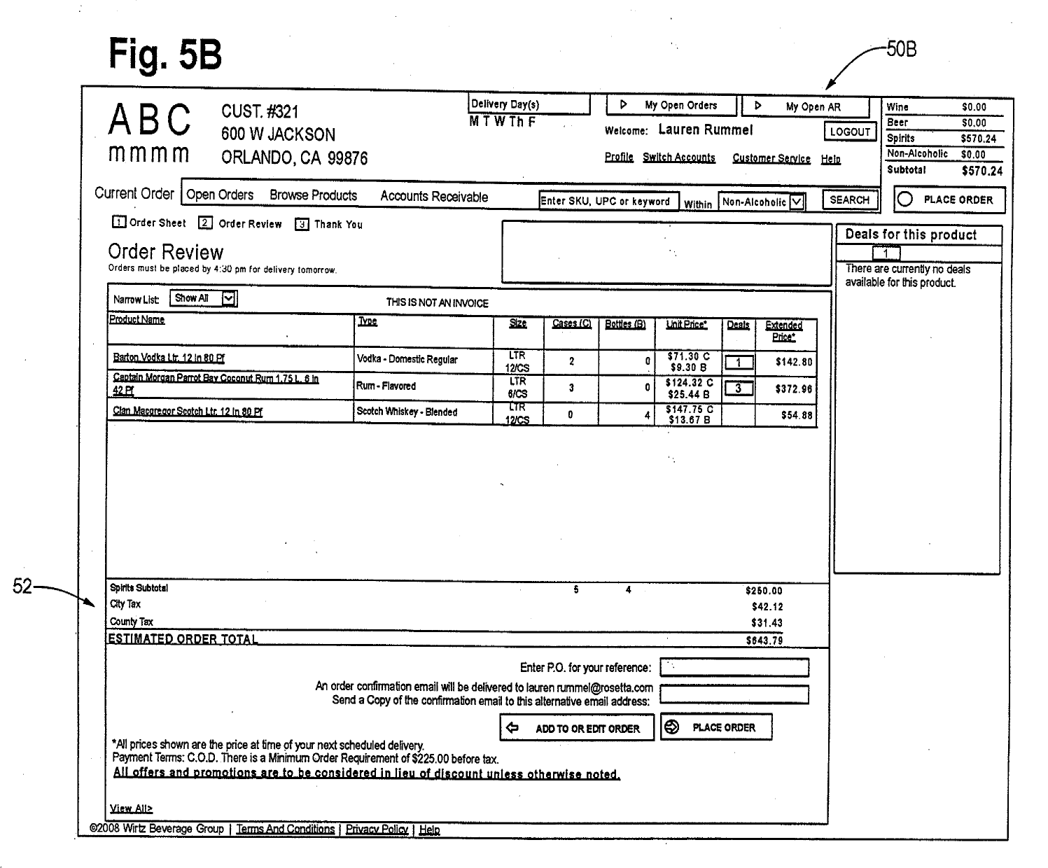

Referring now to FIGS. 5A and 5B, exemplary screen shots 50A and 50B, which constitute order review sheets, may be generated by using the website of the present invention are shown. As shown in these screen shots, the website may automatically calculate various additions or deductions to the price of the ordered item, in addition to the discounts discussed above, based on the items ordered. Such adjustments may include (e.g.) keg deposits 51 which may be applied to a customer's order for kegs of beer, and taxes 52 which may be charged through the site if applicable to the customer and/or ordered items. Charges 51 and/or taxes 52 may be displayed on order review sheet 40A/40B.

In the currently preferred embodiment, final order placement may be a two-click process. Once a customer has added all of the desired items and their order quantities to the order sheet, the customer may review the order. The order review screen may display all items on order and the applicable deals and prices for each. From the order review screen, a customer may simply click “Place Order” to submit the order for payment.

In a particularly preferred embodiment, each time a quantity on the order sheet is added, removed or changed, the following steps may occur in order to select the applicable deals to the user's current products and quantity on order:
1. Product numbers, quantity types (cases or bottles), and quantities of each are sent as http post name value pairs to a Java Spring backed service.
2. This service, via Spring, creates an instantiation of a deal engine. Based on which URL is passed, the deal engine may be customized for each type of pricing that is required.
3. Each product number and quantity type may then be added to the deal engine's order representation, with the engine coalescing all entries sharing the same product number to a single item with potentially multiple quantities and types stored internally.
4. For each product on order, indices specific to each House may be searched for all applicable deals and discounts. These deals and discounts may be retrieved and apply to the items on order. From raw Lucene documents, deal objects may be created, containing varying tiers for each different quantity and quantity type combination found in the deal or discount.
5. After each index is searched, retrieved deals may be processed to remove tiers for which the quantity purchased does not meet the minimum order requirement. In most cases, this may be the sum of the quantities of all products referenced in the deal, but with a configuration flag set, this may look at all products in the order with a defined “mix and match code” matching one of the products in the tier.
6. Any tiers that do not meet requirements for application may be evaluated as potential proximities to be presented to the user as upsells. The total quantity for a deal in a customer's order may be compared to the quantity for the tier multiplied by a factor between 0 and 1, the proximity percentage. These are specific to each customization.
7. After ineligible tiers are removed, other deal rules may be applied. These may have a variety of options and may correspond to geographic locations of distribution areas. Rules may range from applying (e.g.) case deals to bottles, where the discount has been divided by the number of bottles per case, doing the reverse, applying bottle discounts to cases, and even the way different quantity types are treated (either as completely separate entities, where no quantity of bottles will affect case deals or amounts, or as linked amounts, where the engine is aware of how many bottles are in a case, and convert appropriately).
8. Once all available deal rules are applied, the “best” deal may be selected for each product, unless the engine is configured to return all available deals. This may be done in two phases. Internally, each deal item may store a tier comparator, used to compare each tier, given a set of rules. During the selection of a “best” deal, each “best” tier may be compared through a similar method, with a deal comparator stored in the engine. Both the deal and tier comparators may be configurable via the Spring XML.
9. These best deals may be stored in a list with a corresponding list of all product ids participating in that deal.
10. After best deals are selected, a similar, but slightly different method may be used to select the proximity to display. If the distribution location has returned all deals selected, this may not occur, as all may be returned, depending upon the business practices and/or legalities of the location and/or state involved. Using tier comparators, the tier out of all deals closest to the current quantity on order, yet still having a “better” discount or free good, may be selected, and stored in a way like that of deals.
   This information may then be serialized and returned to the client via JSON (JAVA-script object notation, the language from the server to the client side).

Typically, website pricing has been done using a standard database look-up table (e.g., using a Websphere Commerce's Promotion engine). A searching scheme such as above, using a Lucene-backed service, provides both more customer customization and a faster response time. (Lucene is the JAVA open source application that performs indexing and searching.)

### Viewing AR Records

Another goal of the present invention is to improve transparency for customers who wish to view account receivable information and invoice details for all orders placed. To meet this goal, another feature of the present invention is providing a website which allows customers to view all invoice records for orders placed both online and offline. In one preferred embodiment, the website provider and/or a manufacturer of the products offered on the website may send invoice records in periodic (e.g., nightly) data feeds. These records may be processed and loaded so that a customer may view all invoice records when logged into an account.

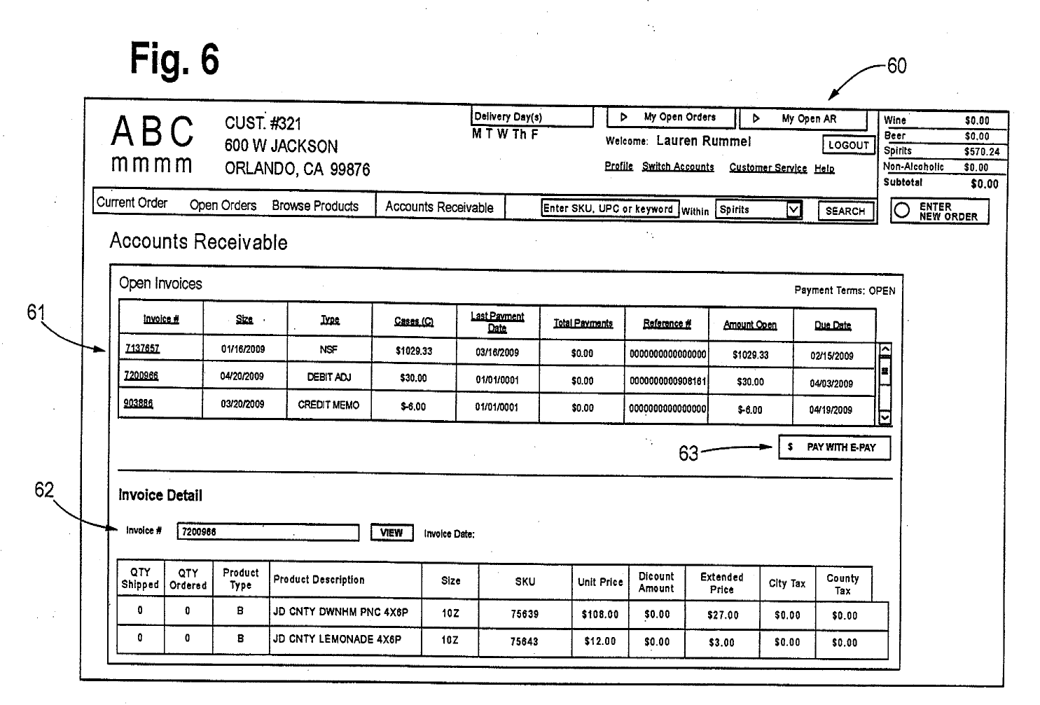

Referring to FIG. 6, exemplary screen shot 60 shows an Accounts Receivable web page. Referring to panel 61, a customer may view all open invoices for orders placed both online and offline. As shown in panel 62, clicking on an invoice number will display the details for that particular invoice. In addition to displaying invoice records, Accounts Receivable page 60 may also include a link 63 to a paying website such as E-Pay. For customers who are set up to use E-Pay (for example), a button appears that, when clicked, redirects that customer to a payment site which may be hosted by the website provider or an agent for the provider. Here, the customer may submit payment on any open balances.

### Increase Top Line Revenue

Yet another goal of the present invention is to increase top line growth by driving customer ordering behavior. To accomplish this goal, a particularly preferred embodiment of the interactive online website of the present invention may utilize several advanced marketing tools, including techniques such as trade-ups, cross-sells, e-spot placement and customer segmentation.

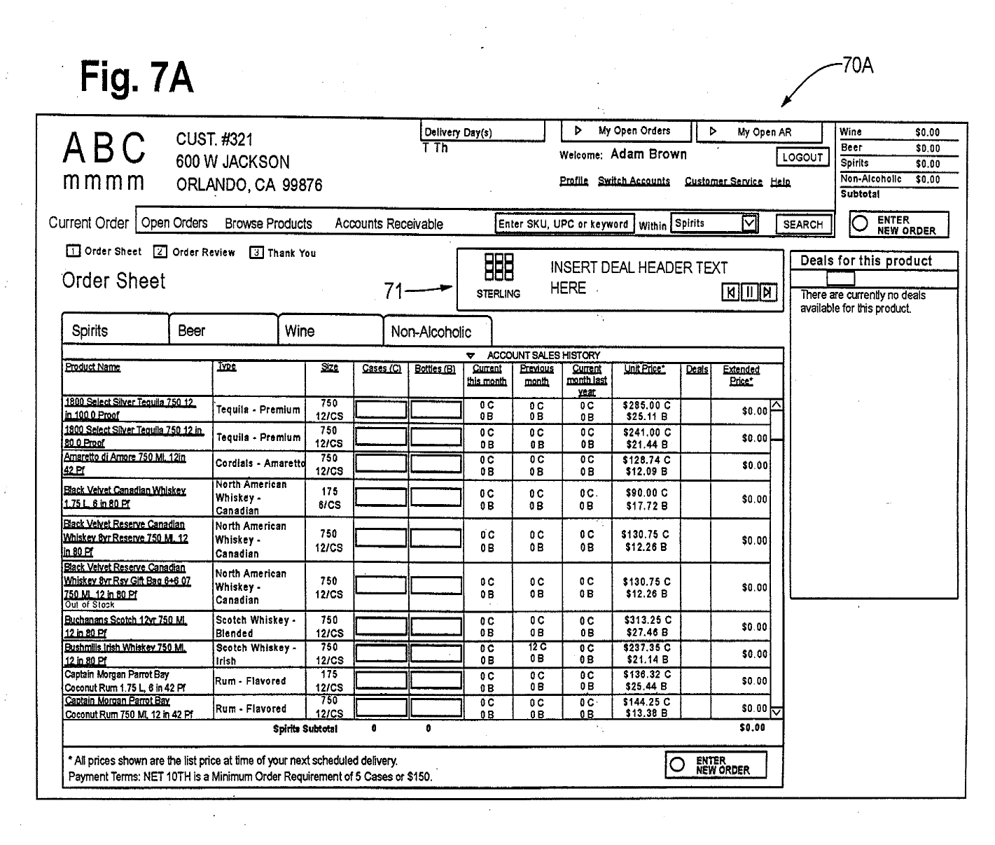

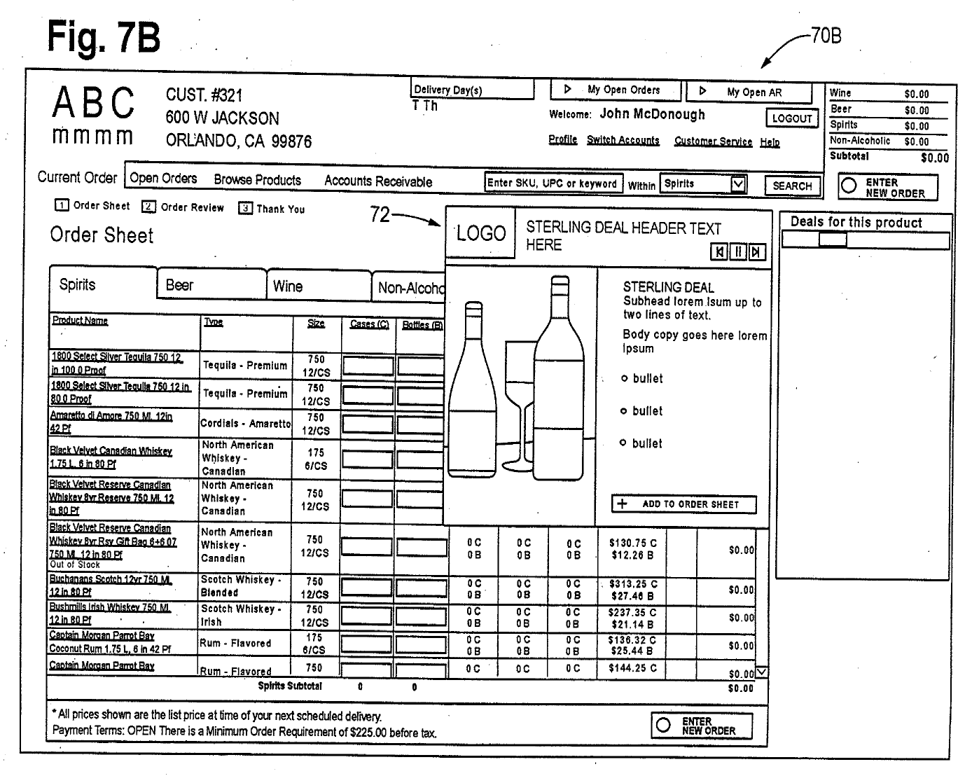

Referring first to FIG. 7A, exemplary screen shot 70A shows an e-spot (advertisement spot) 71 displayed on a customer's Order Sheet. E-spot 71 may be designed to rotate content on a predetermined number (e.g., up to five) of featured products or deals. Referring now to exemplary screen shot 70B of FIG. 7B, a user may scroll over e-spot 71 and it may be designed to expand with more information into panel 72. The website may be designed such that the rotation of the e-spot is constant unless a user clicks the Pause button.

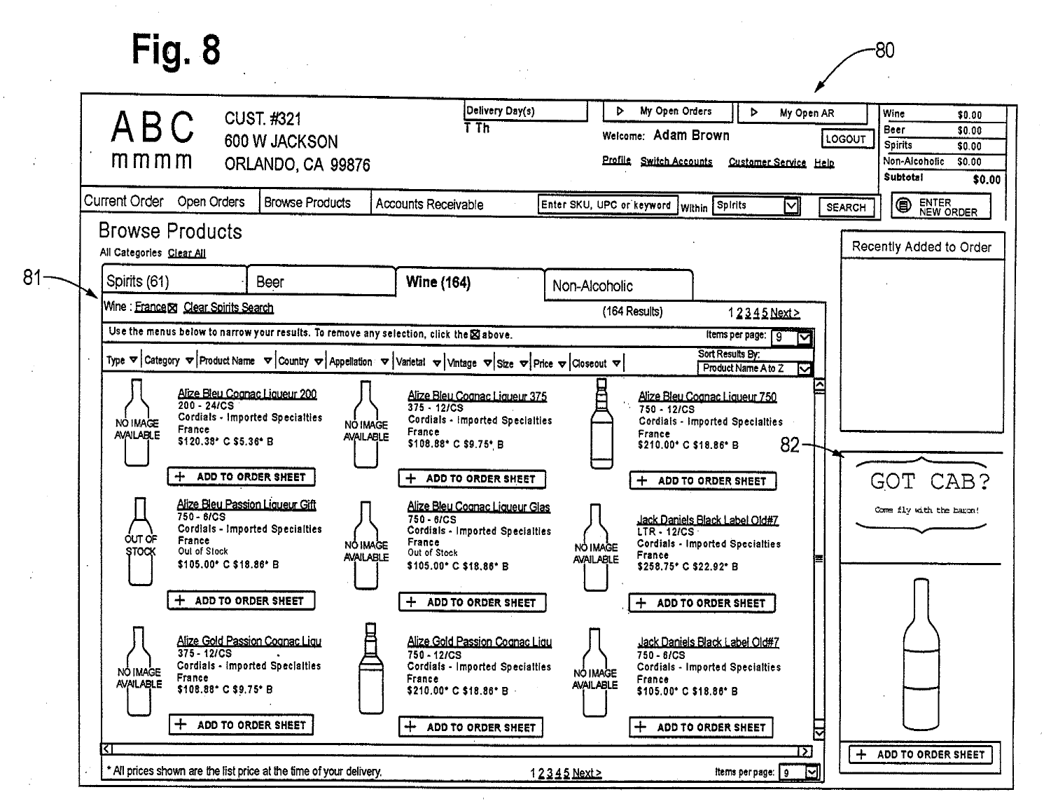

Referring to exemplary screen shot 80 of FIG. 8, panel 81 shows that the website may be designed such that e-spots on the Browse Products page 80 may change depending on a user's filter or search query. For example, if a user filters on Type, Country or Price, the e-spot displayed may change to become relevant to the filter. For example, when the user has applied a French wine filter, e-spot content 82 may be set up to display when this filter is applied.

The content of the e-spots may be controlled by users through the Commerce Management Center (a tool within Websphere Commerce). Preferably, the content of e-spots is dynamic and may be targeted to specific customer segments as defined in a data feed.

In the preferred embodiment, WebSphere Commerce's standard e-spot mechanism was customized through Java logic to work on the basis of the active organization's attributes instead of those of the active user. In a B2B application, this provides enhanced relevance and other information not previously available. Beyond the initial customization, e-spots may be enabled, via HTML meta-data, to have attributes triggering varying display options in a user's web browser. The information passed via meta-data may enable a displayed e-spot to function as a static advertisement, an advertisement with a flyout panel, or a flyout panel with an action button to either add a product to the user's order, or to perform a search. All e-spots returned from commerce (e.g., up to 5) may be rotated through in a timed display. Additionally, all e-spot information may be cached in the user's browser to allow for only one request from the server.

In a similar fashion, the website may be designed to provide trade-ups and cross-sells. In another words, products may be linked through a data feed relationship so that when viewing one product, a customer may be presented with an option to swap the viewed item for a similar product of higher value. Thus, when a product detail page is displayed, a request may be sent to a Spring-backed Lucene service, containing the product number. This information may then be used to search an index containing corresponding cross-sell and trade-up information. If any results are returned from the search, the first cross-sell or trade up may be serialized, and returned to the client via JSON.

### Multi-User Functionality

Another goal of the present invention is to provide third party website users with multiple accounts, to enable such users to access these accounts online using one login, and to provide users (e.g., salespersons) with access to the site and to all accounts to which they are associated. To accomplish this goal, the preferred embodiment of the website of the present invention allows users to associate themselves with multiple accounts. For example, if a user is the owner and manager of several restaurants, the user may log in and place orders on any one of these accounts using one login ID and password.

Preferably, other multi-account users such as sales representatives, CSRs (customer service representative) or House representatives may log in and place orders on any one of their assigned accounts using a single login ID and password. Having the ability to easily access and switch between multiple accounts will enable these users to directly assist website customers with questions about products, pricing, or functionality.

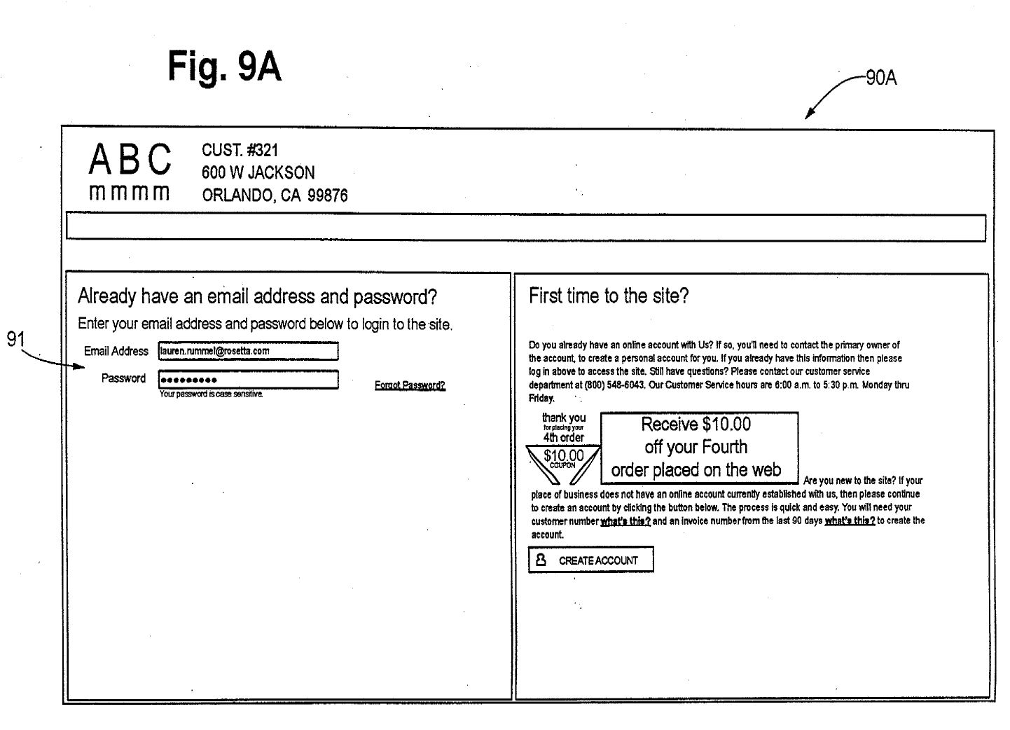

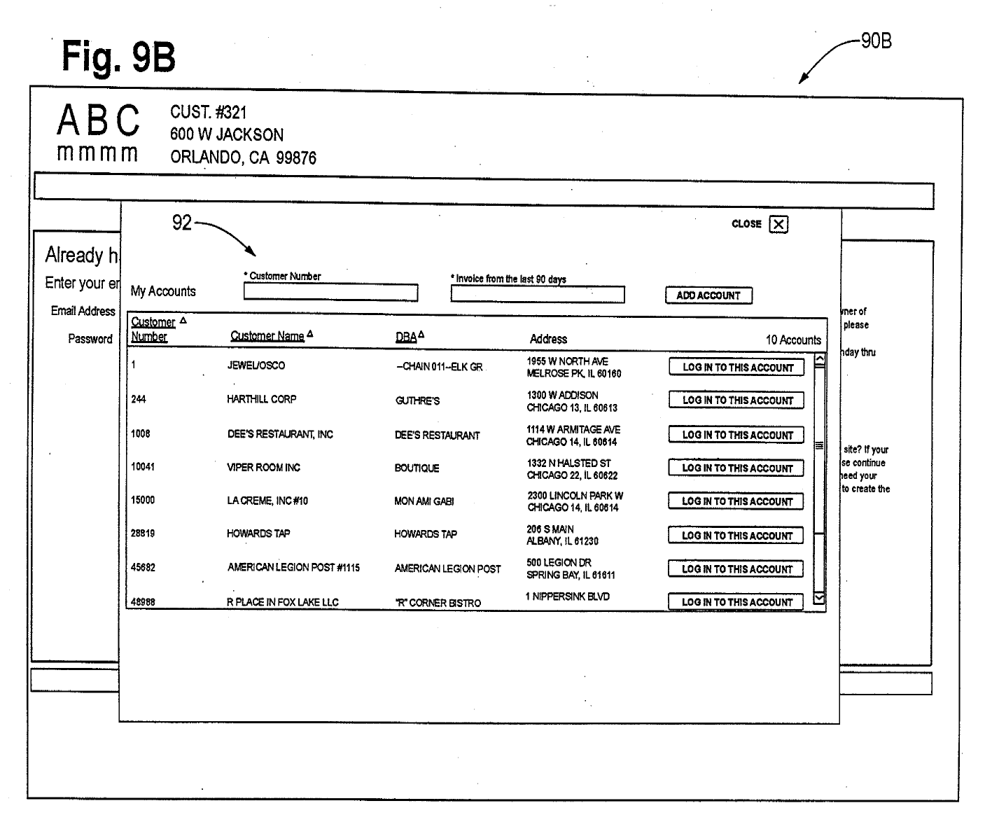

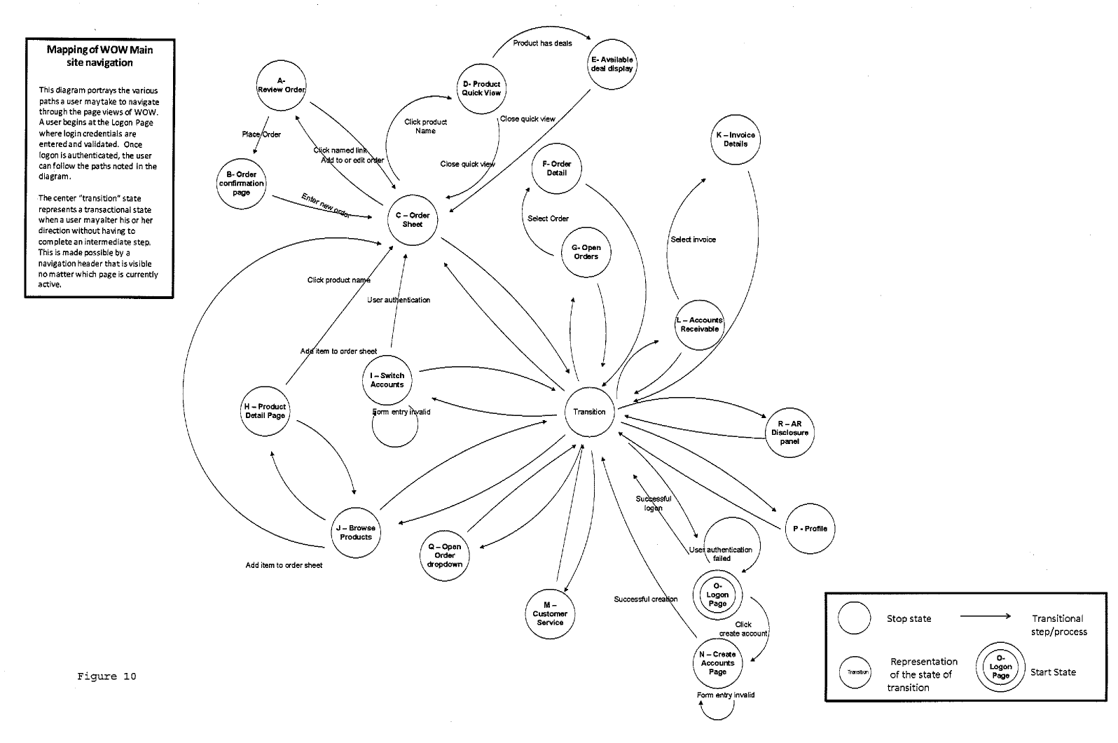

Referring now to FIG. 9A, exemplary screen shot 90A demonstrates that, with multi-user functionality, one user who is associated with multiple accounts may log in to any one of these accounts using a single sign-on, as shown at panel 91. Referring to screen shot 90B of FIG. 9B, a multi-account user may select an account from the login screen 92, and switch easily between accounts within the same login session.

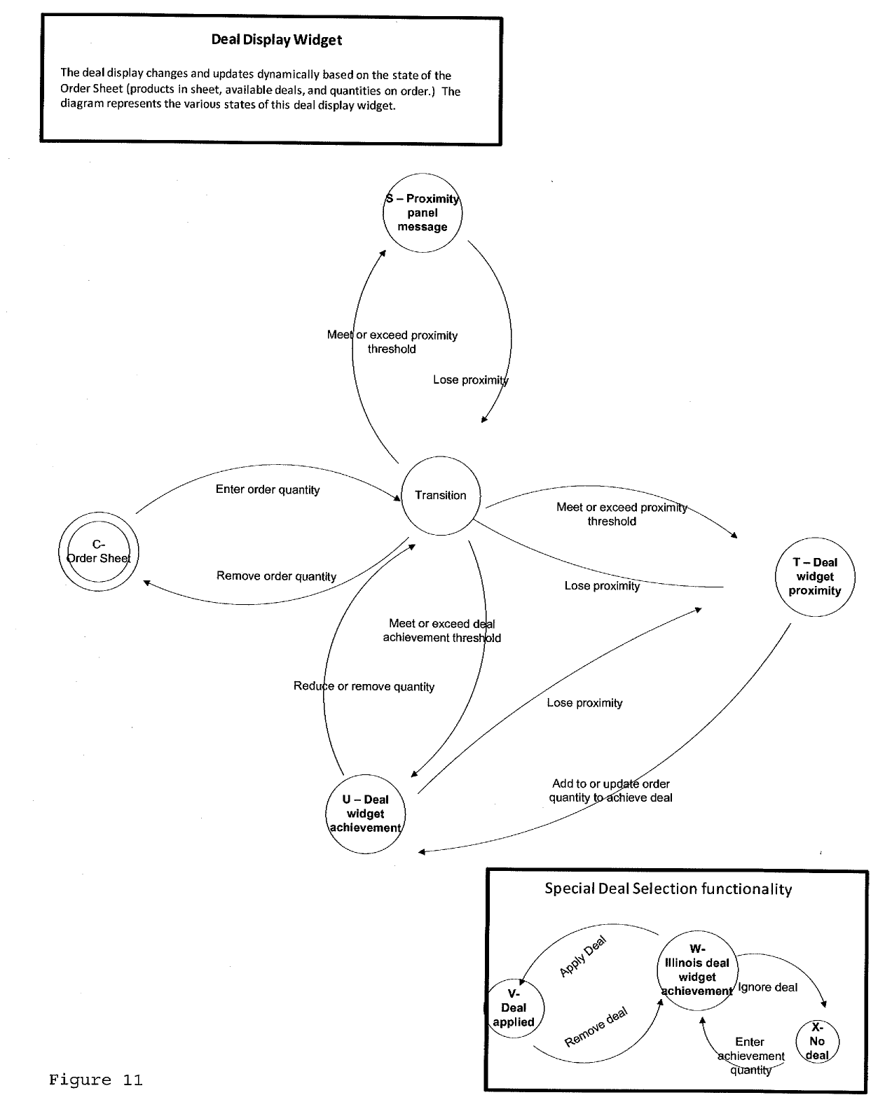

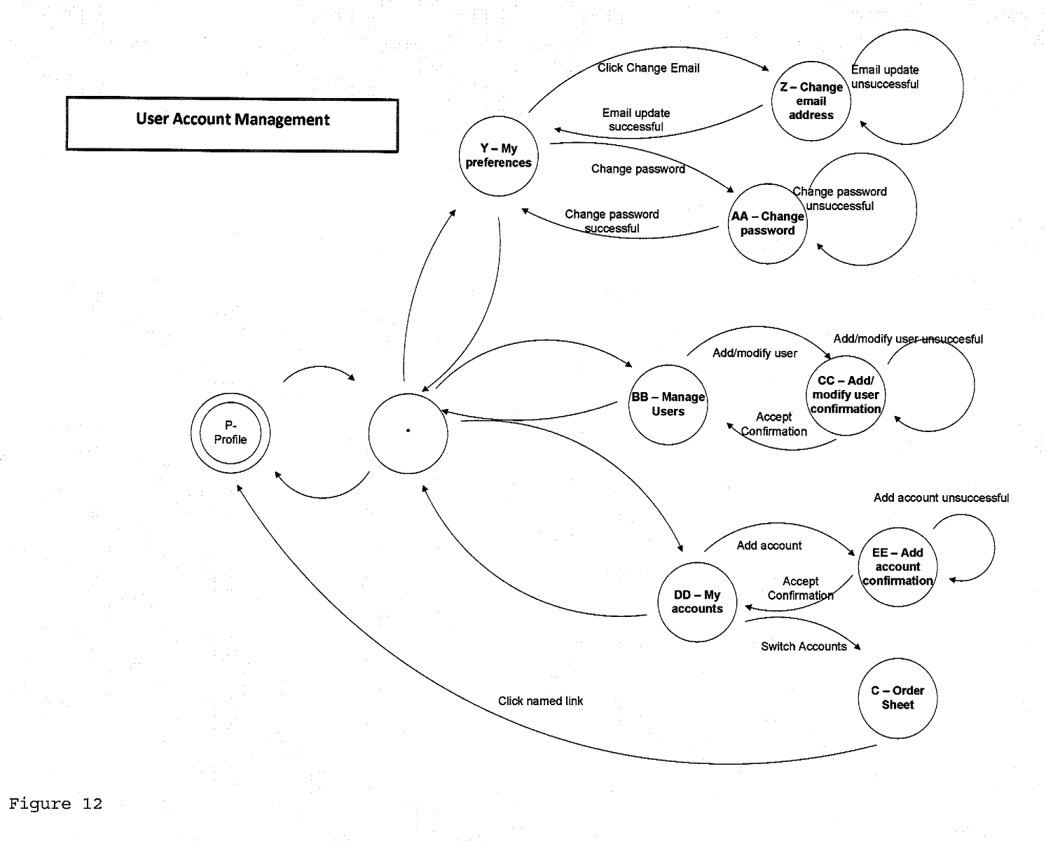

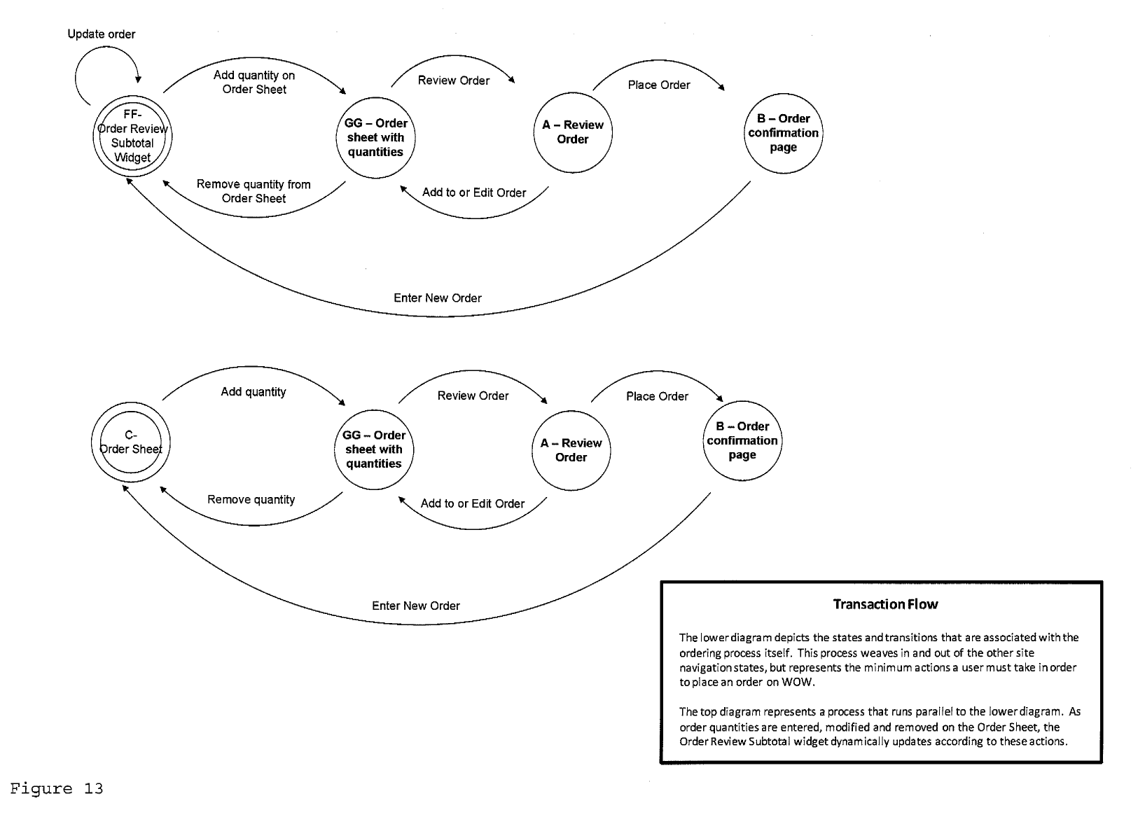

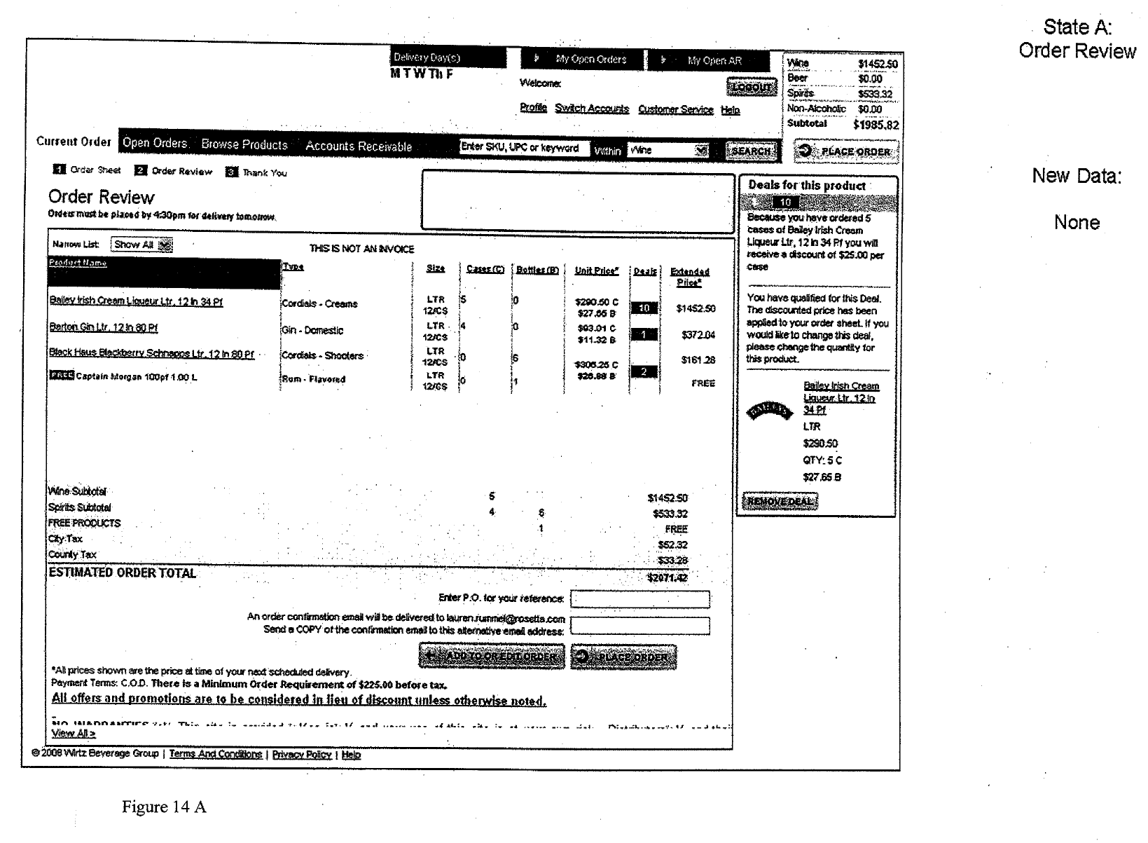

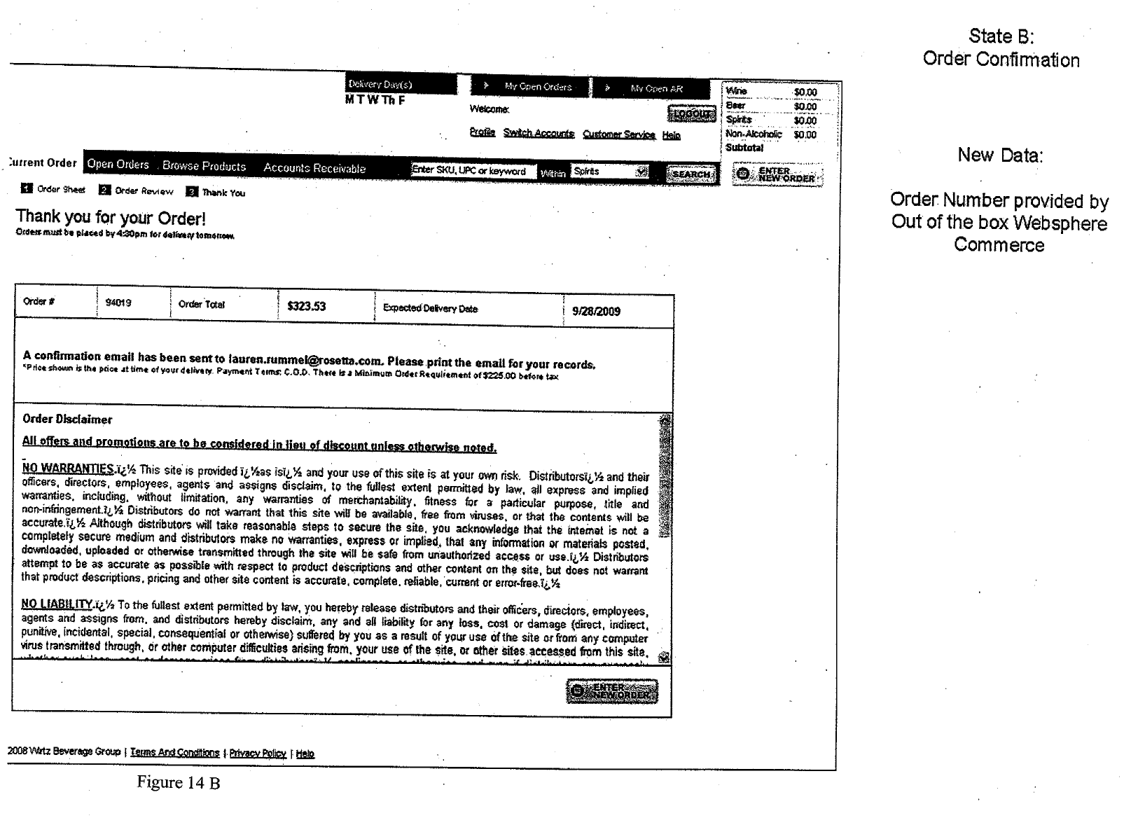

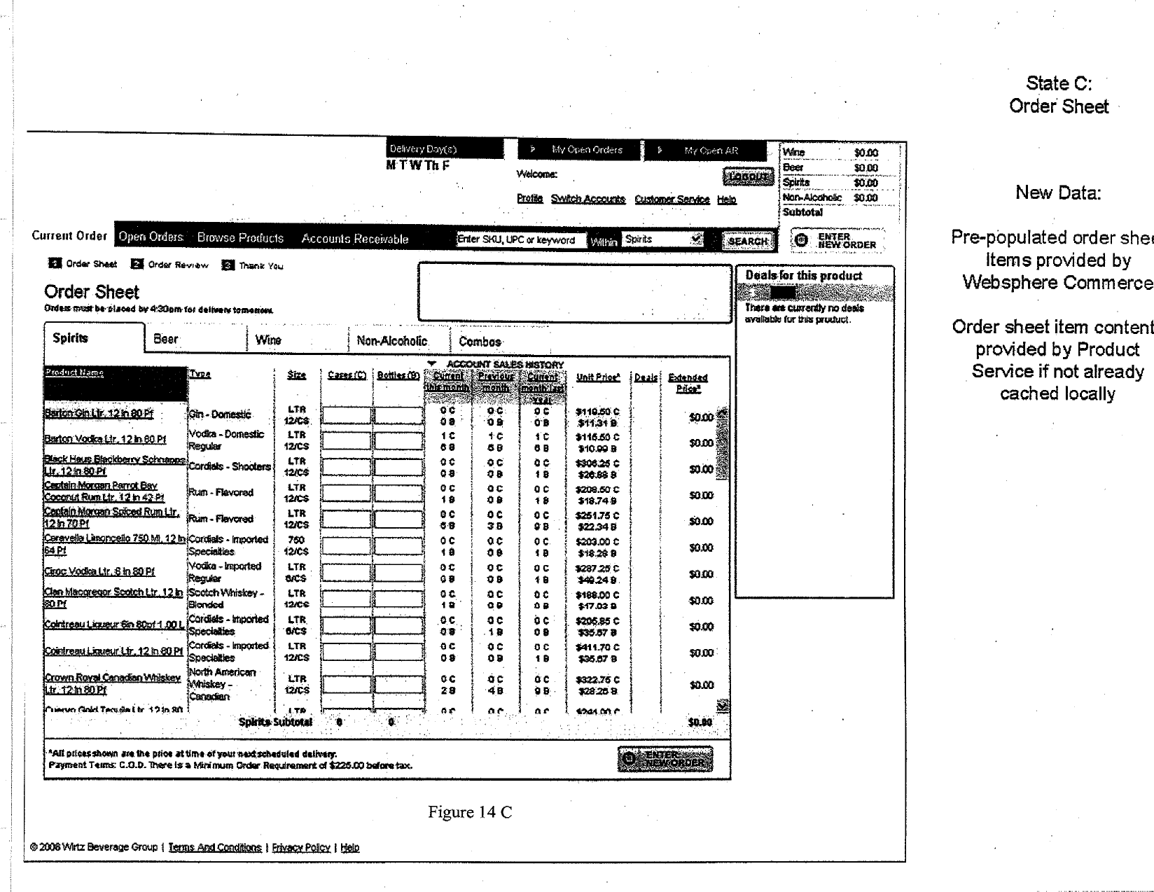

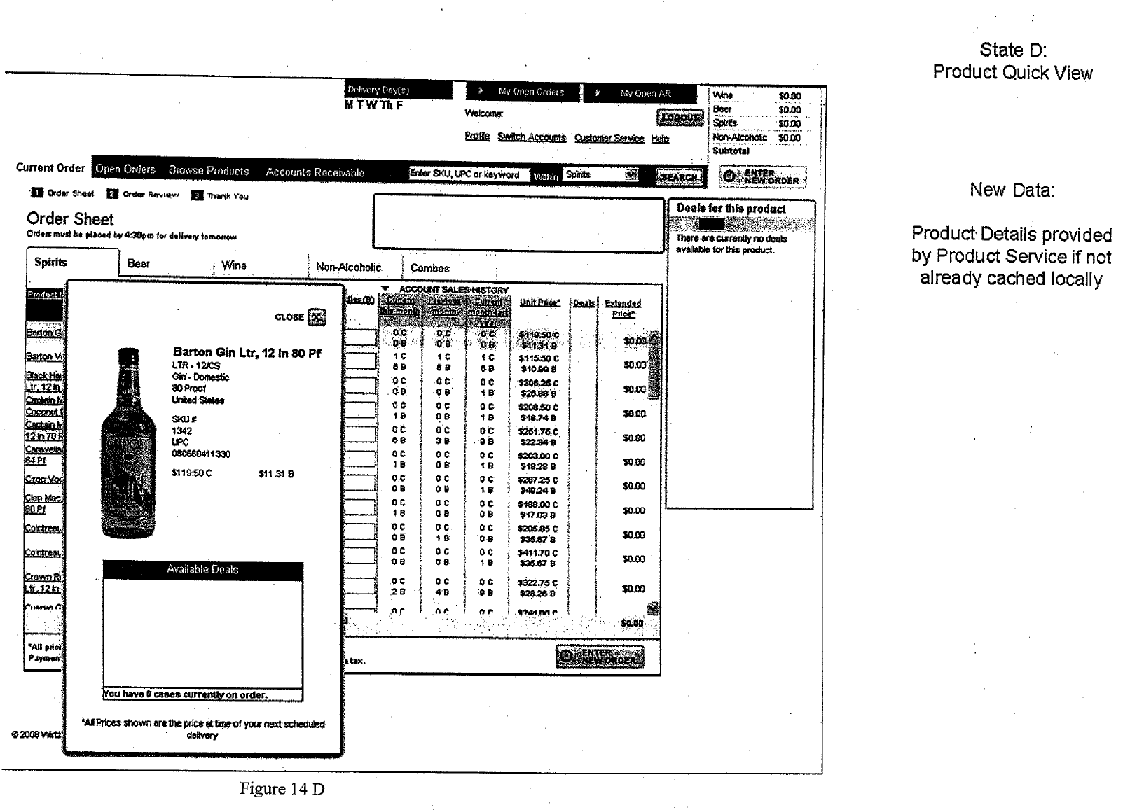

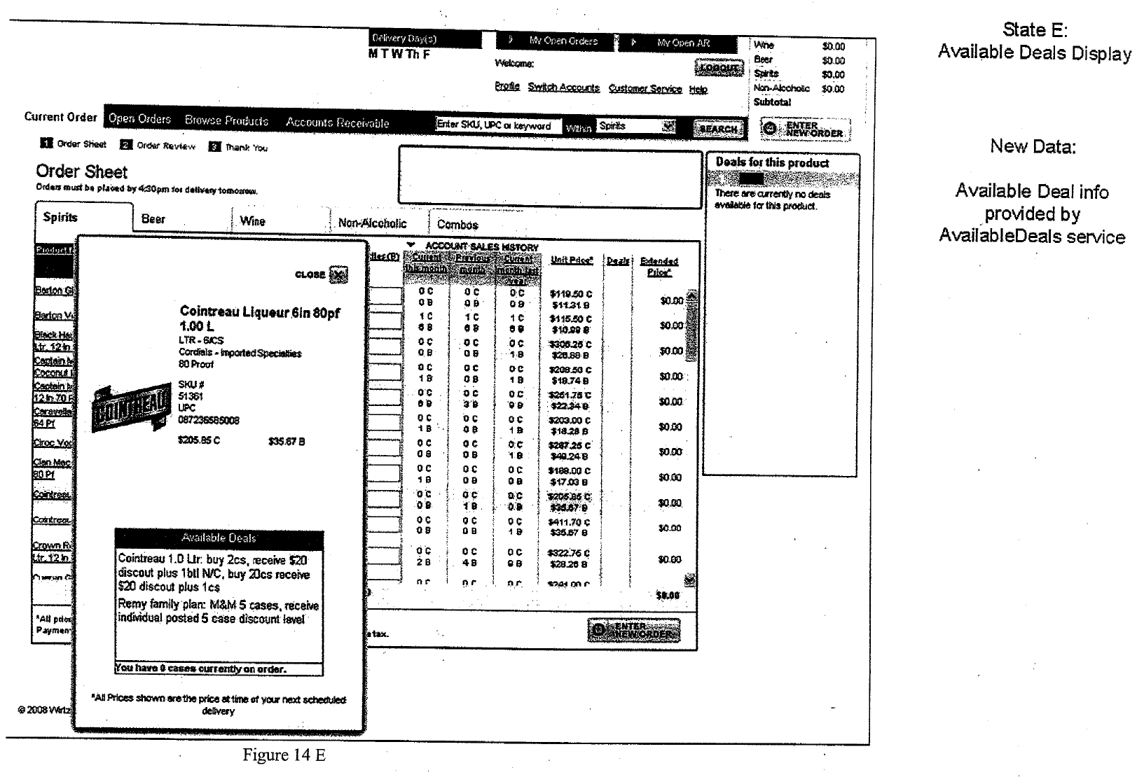

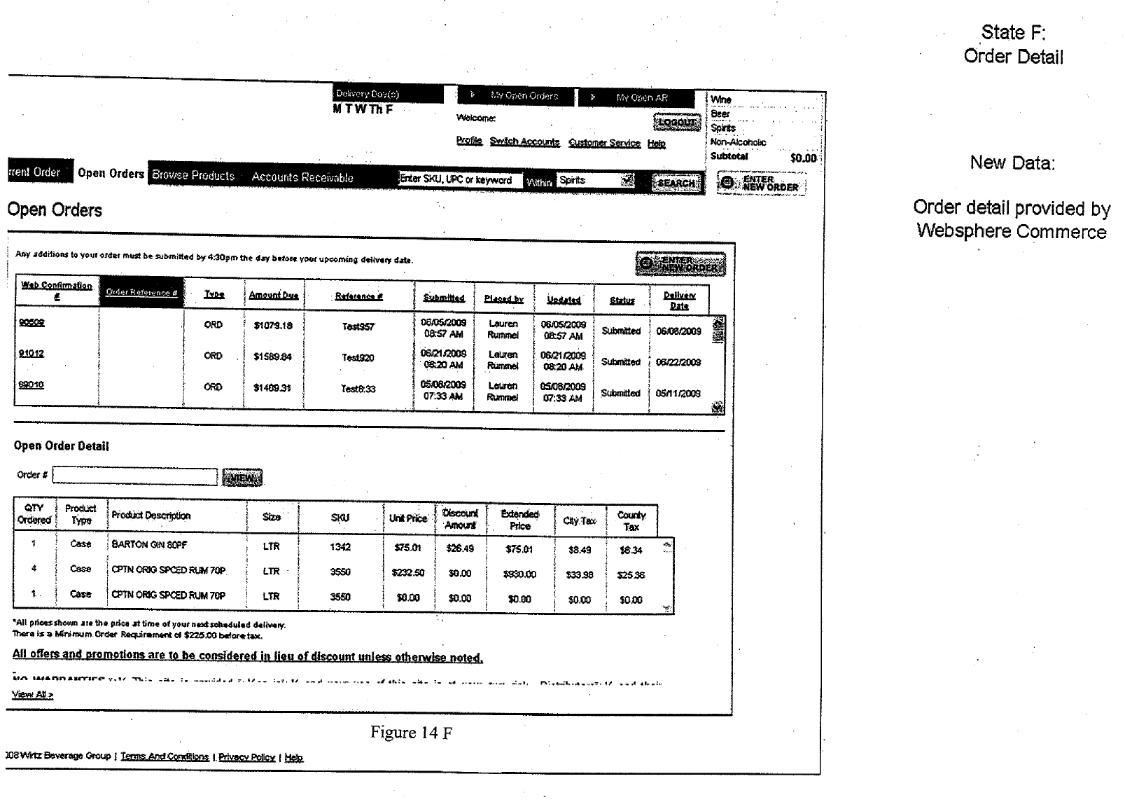

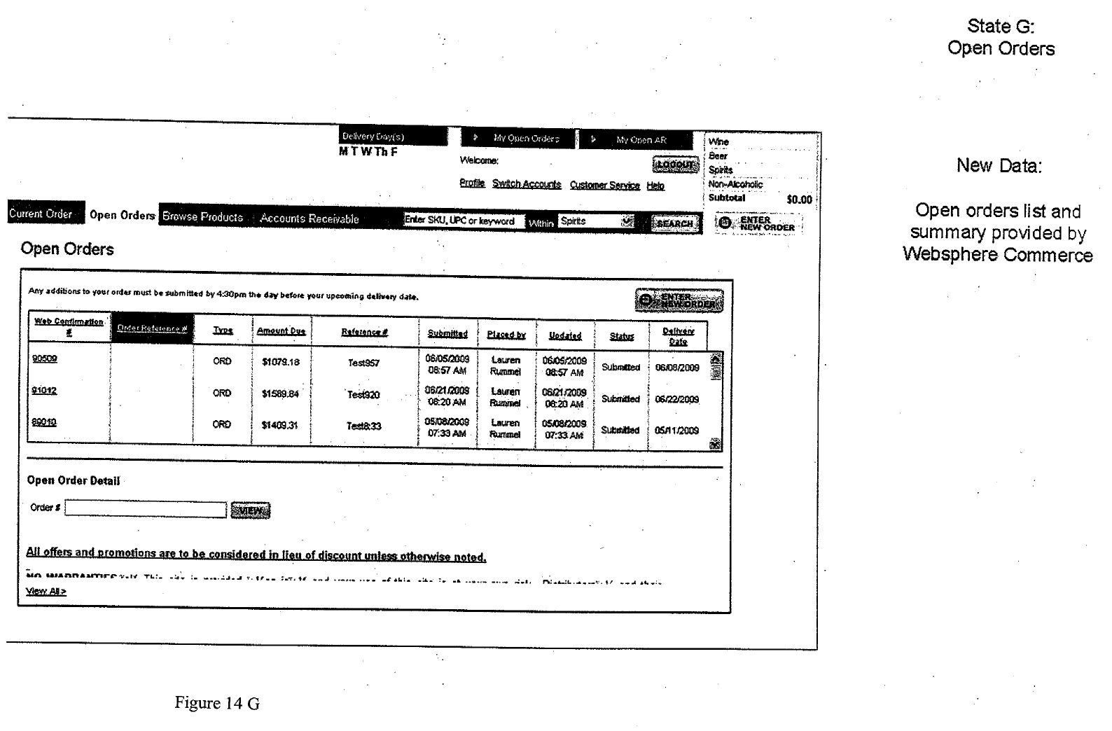

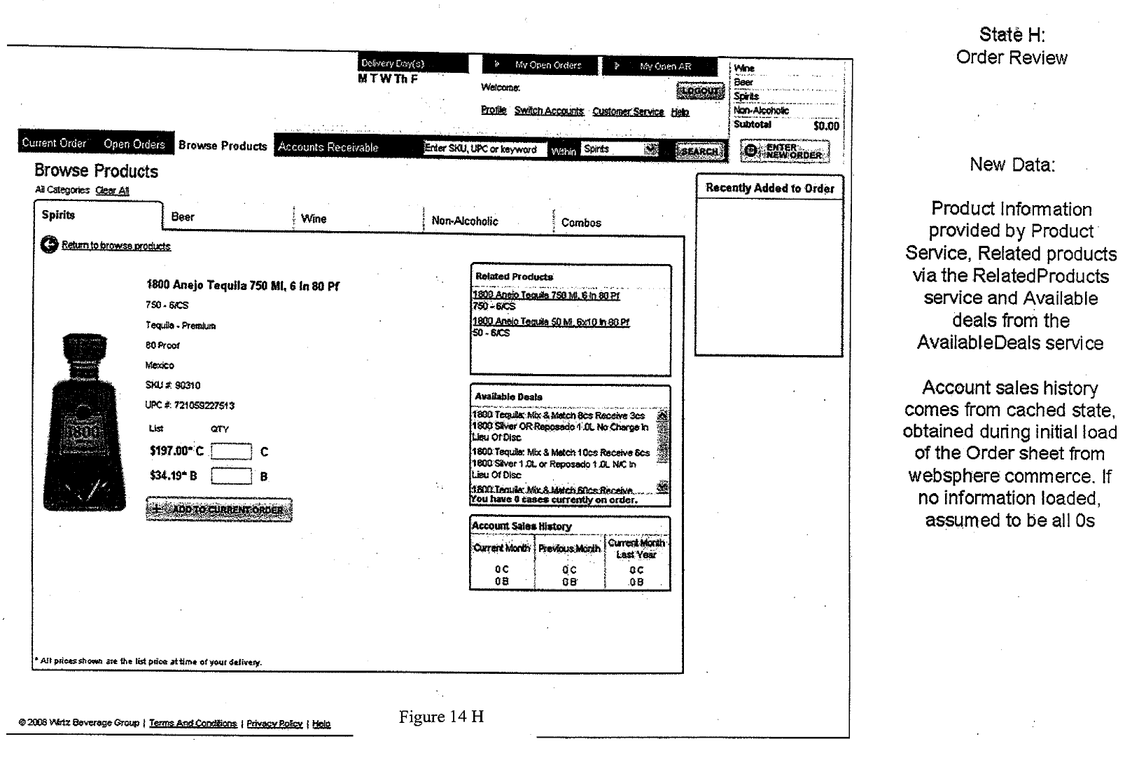

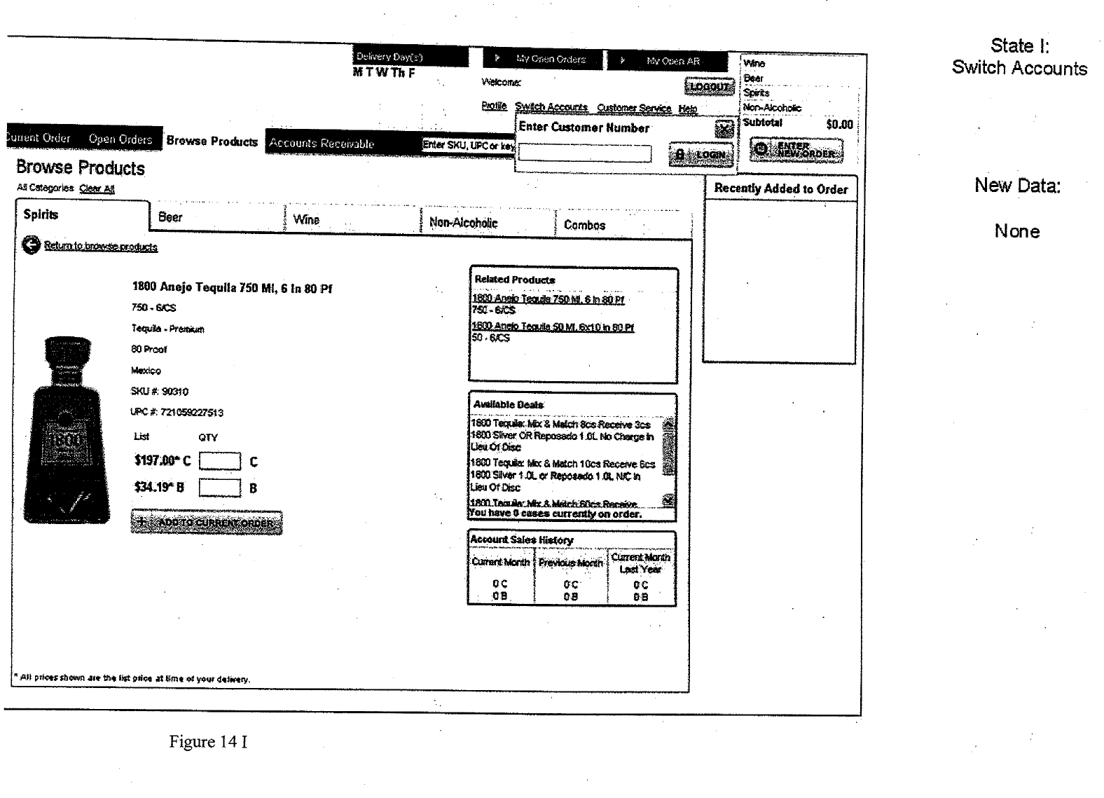

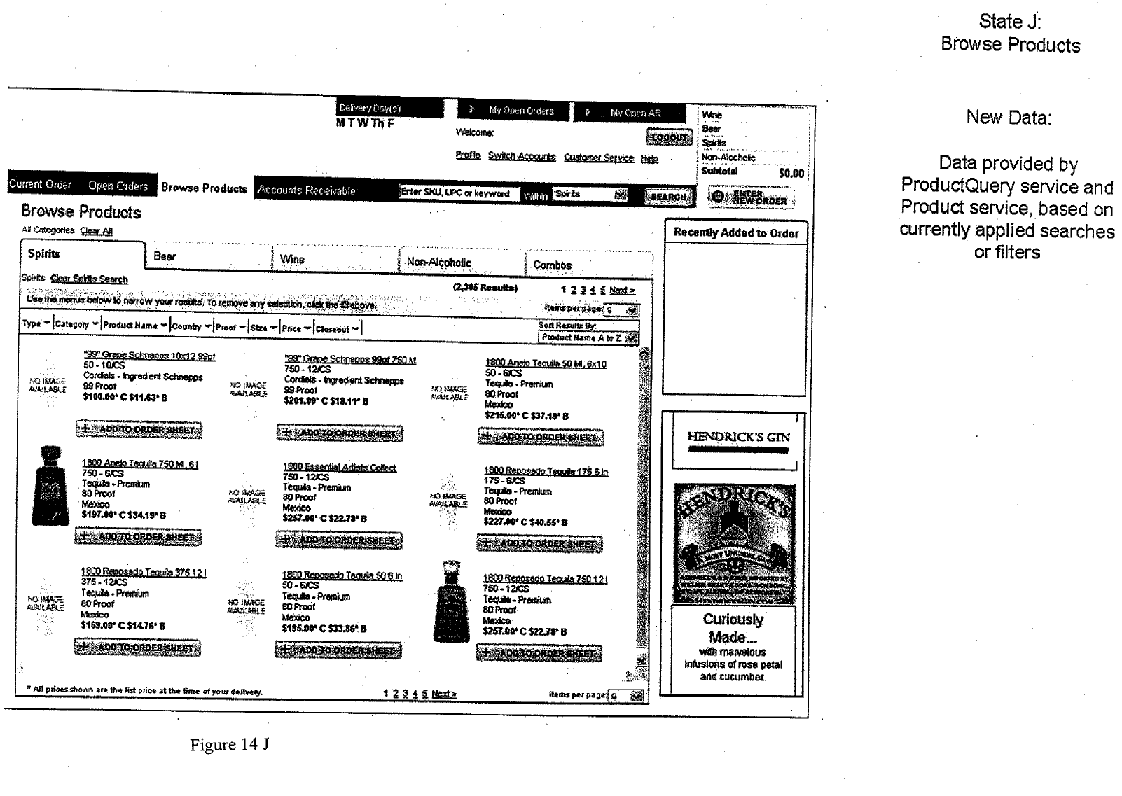

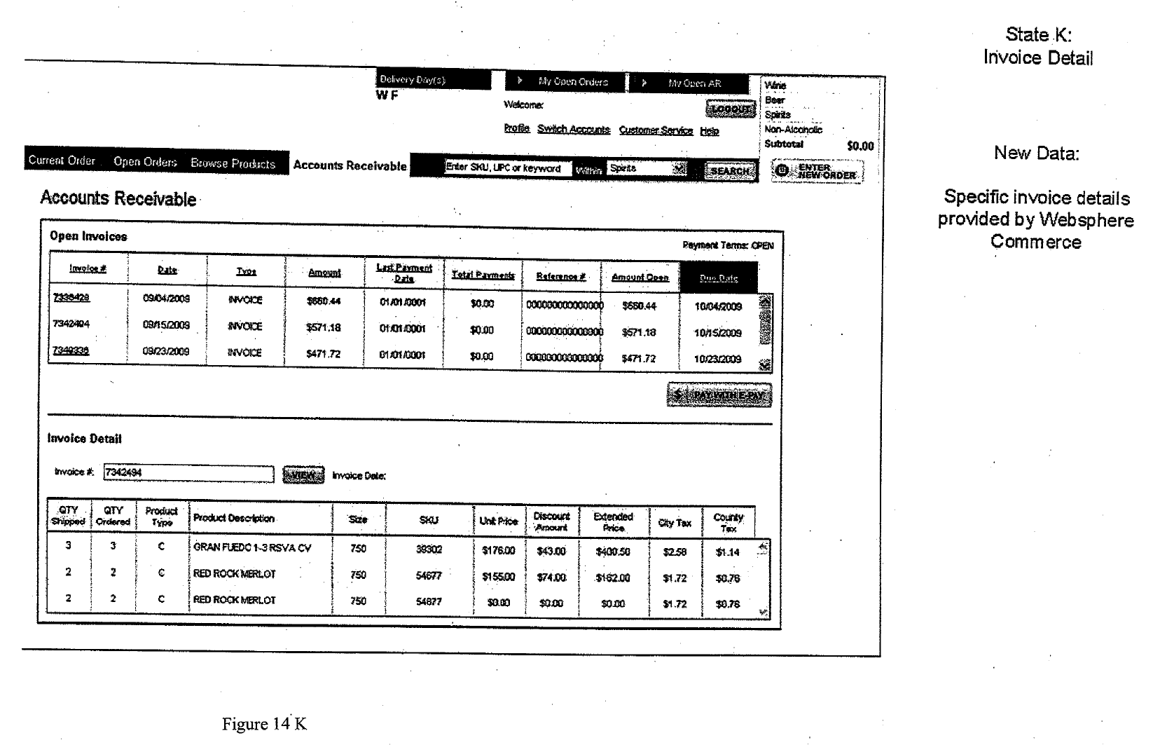

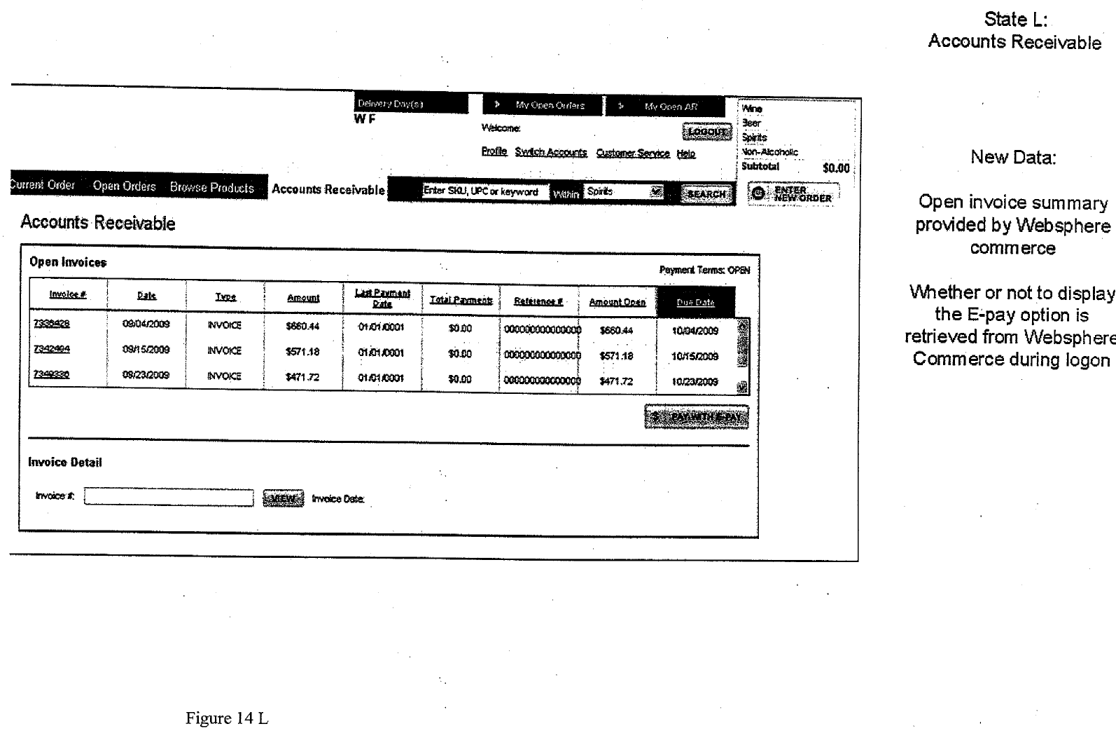

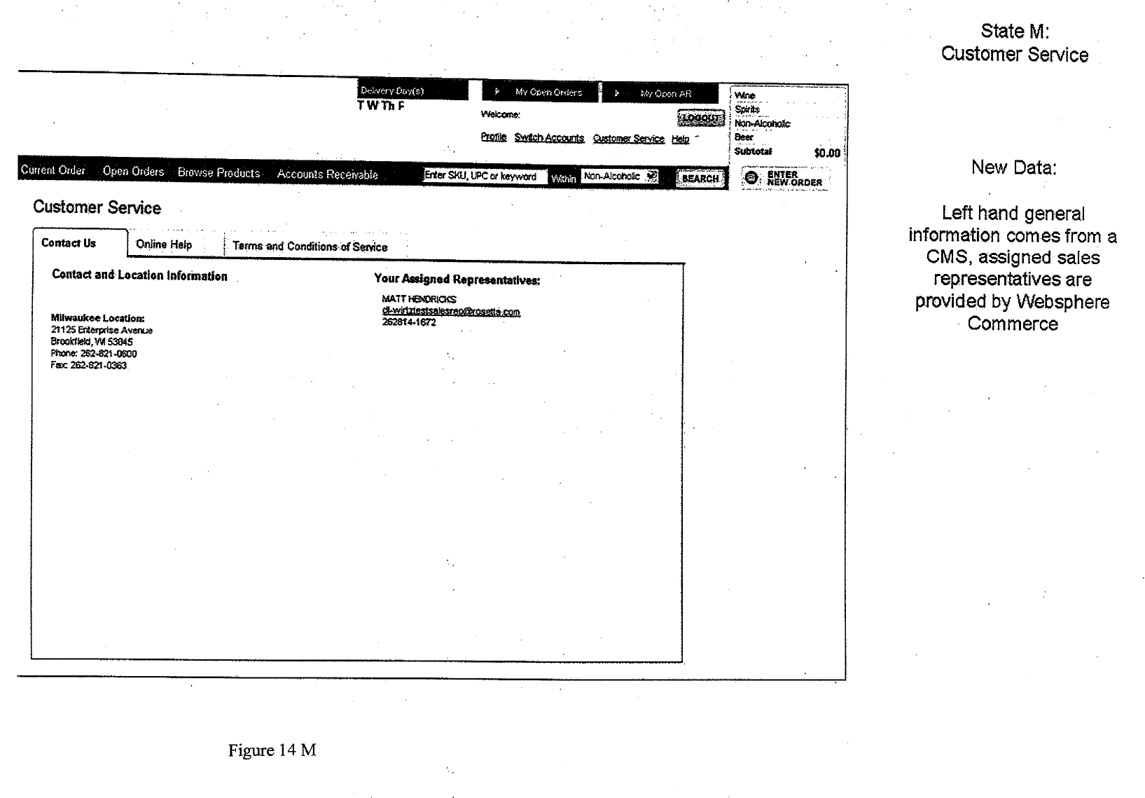

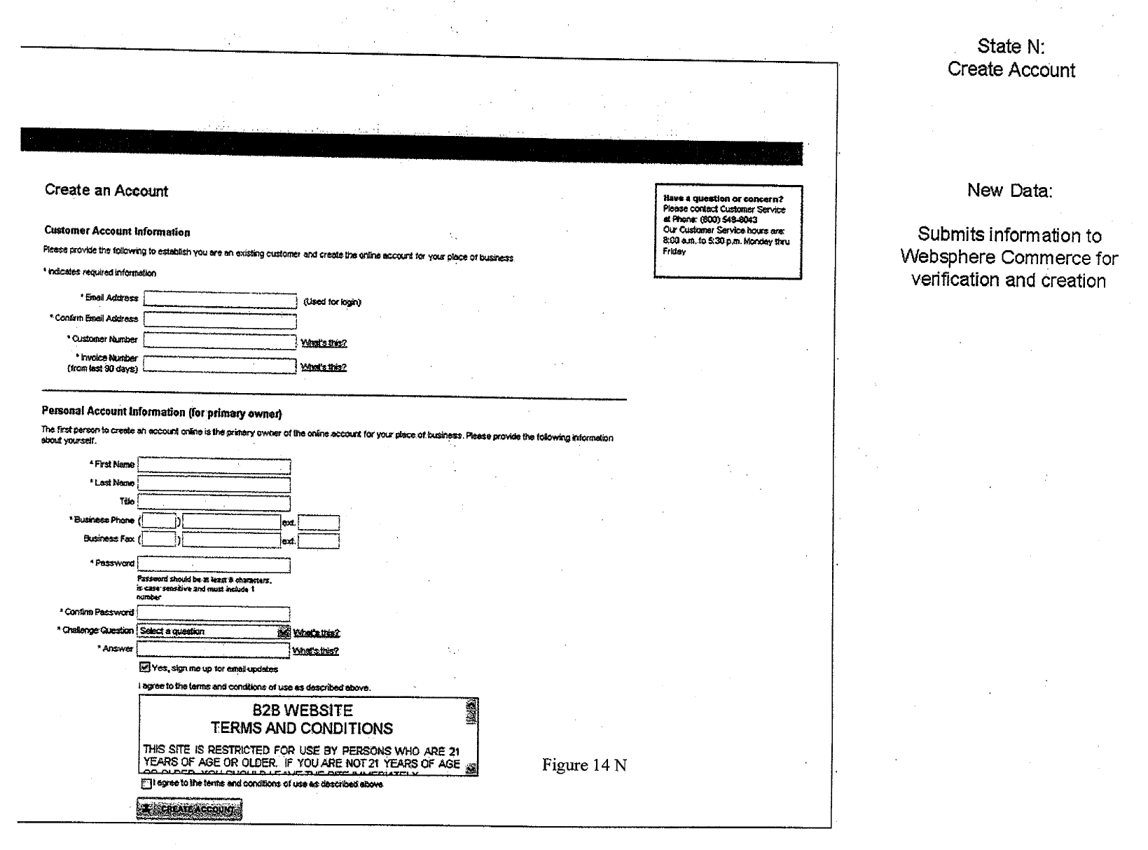

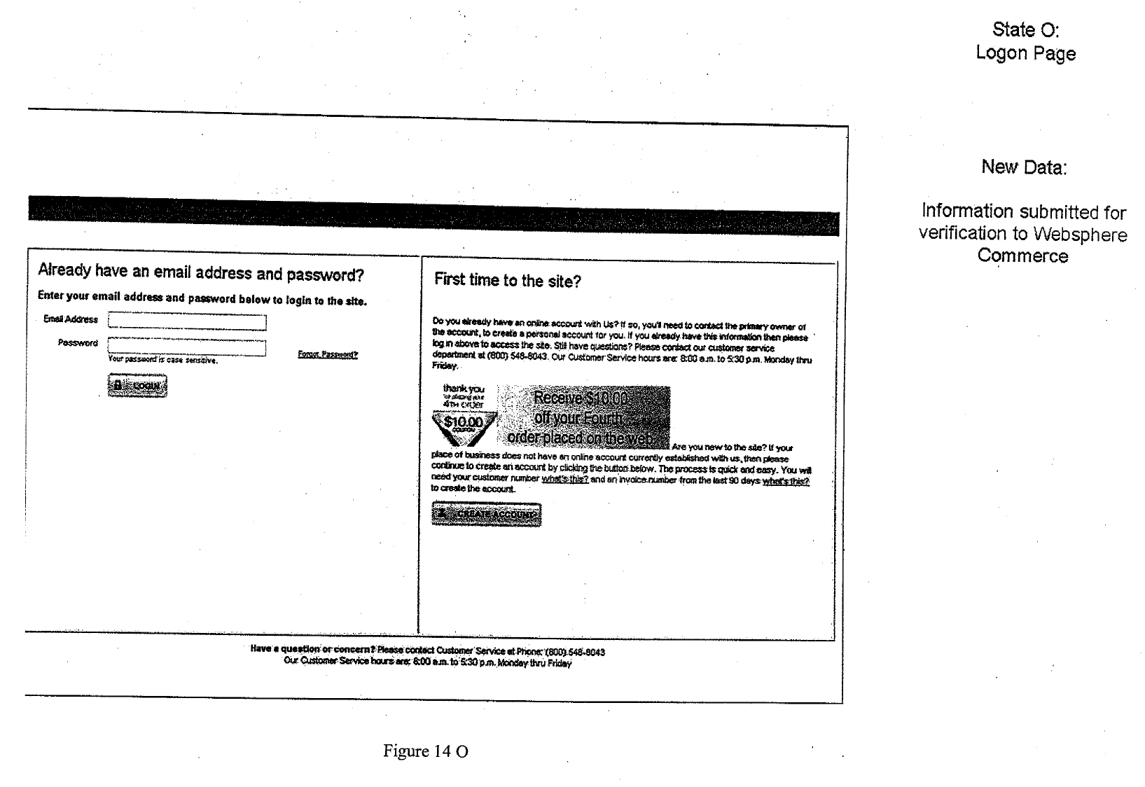

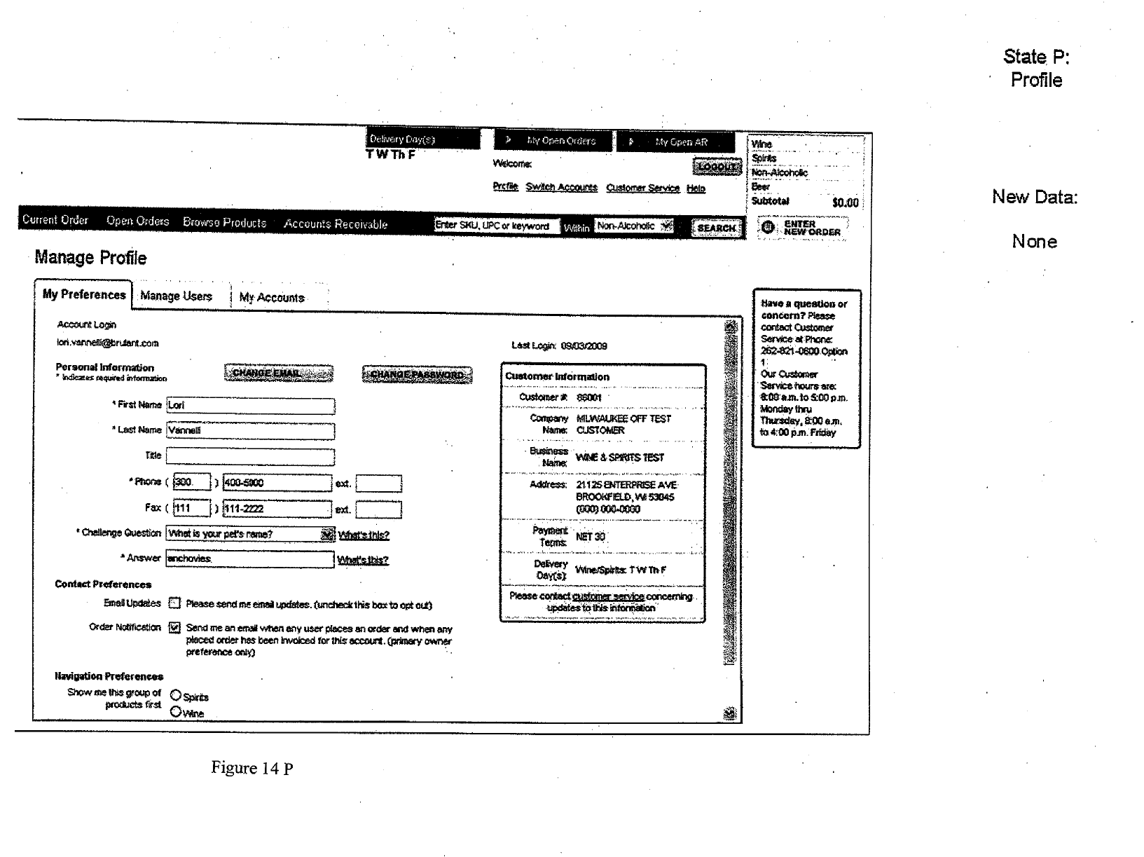

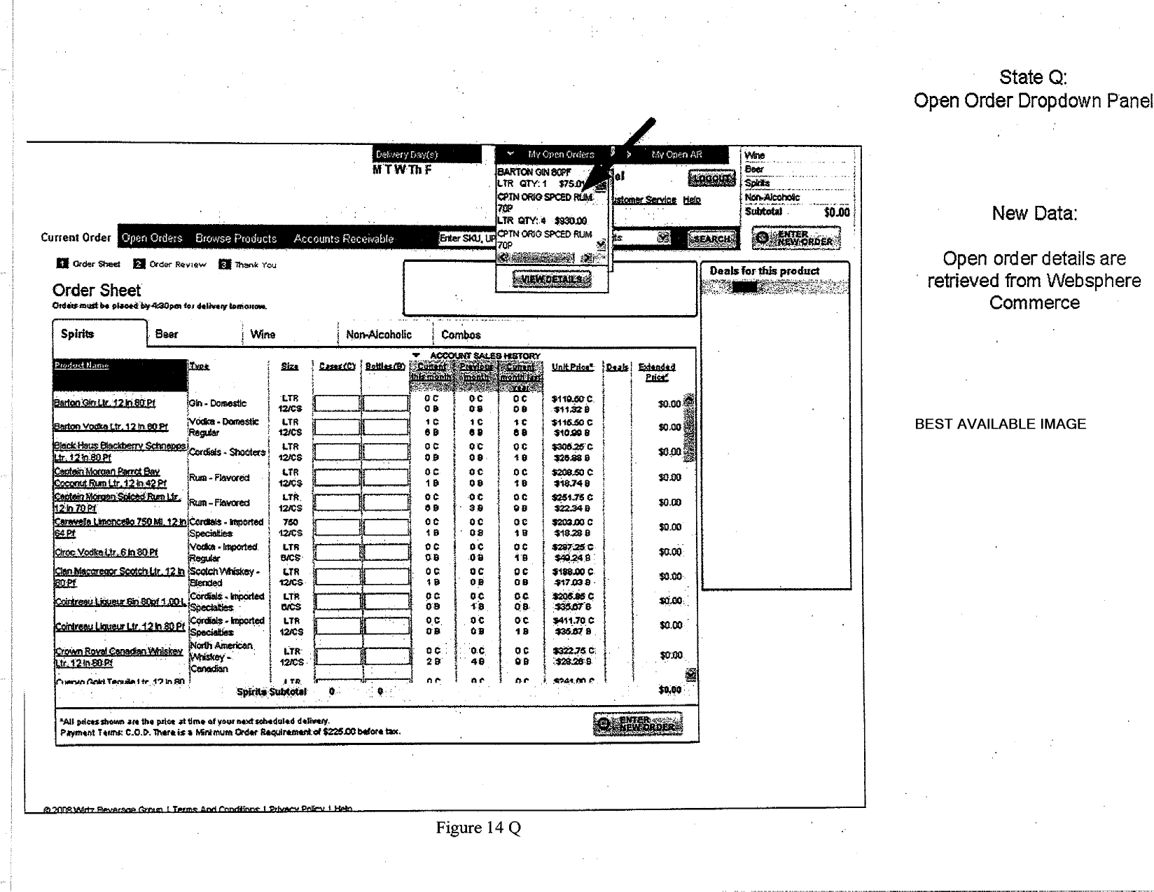

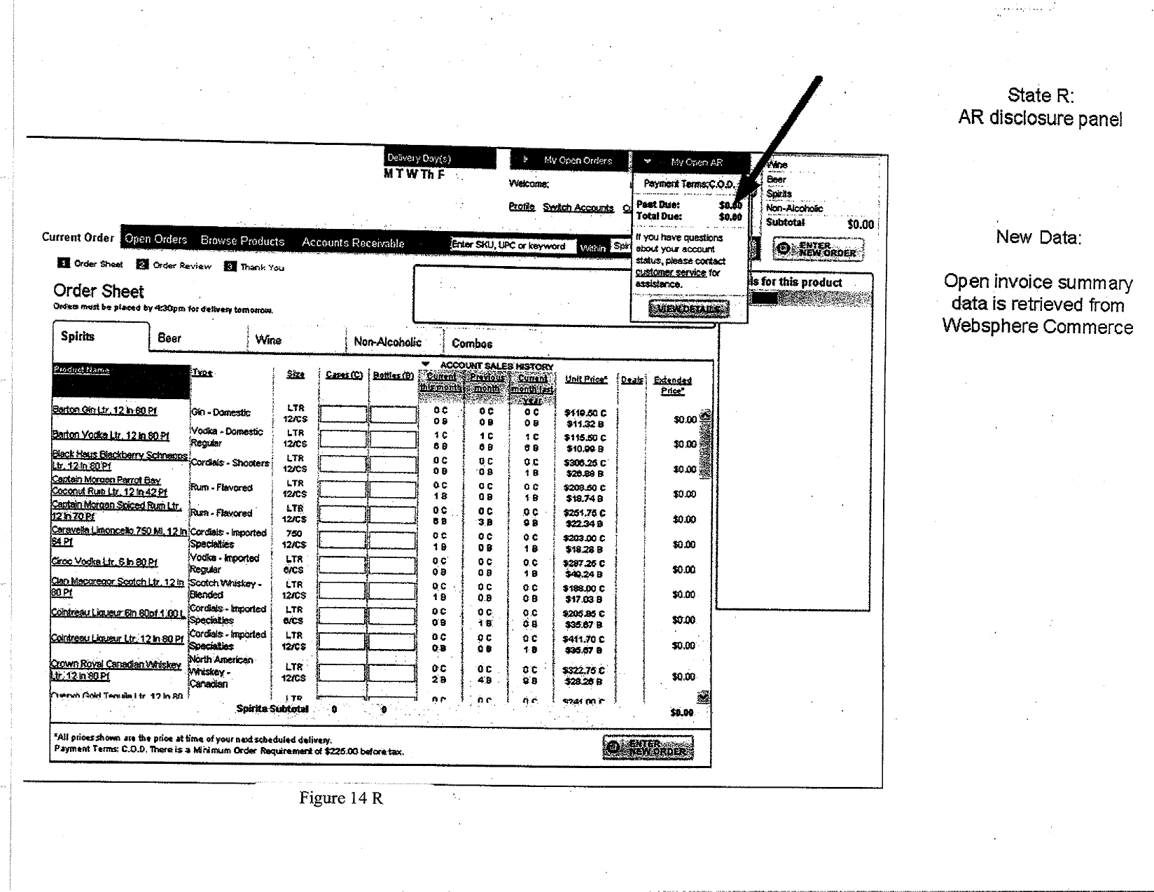

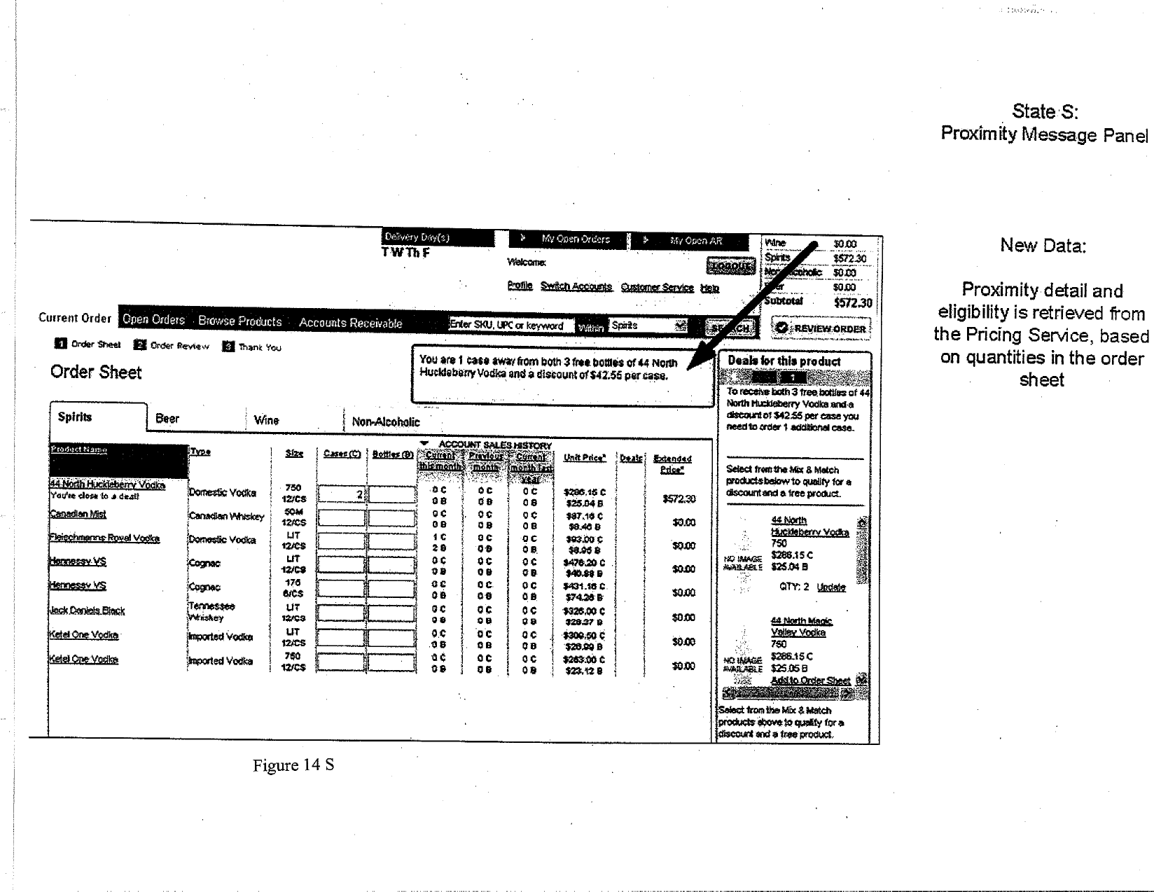

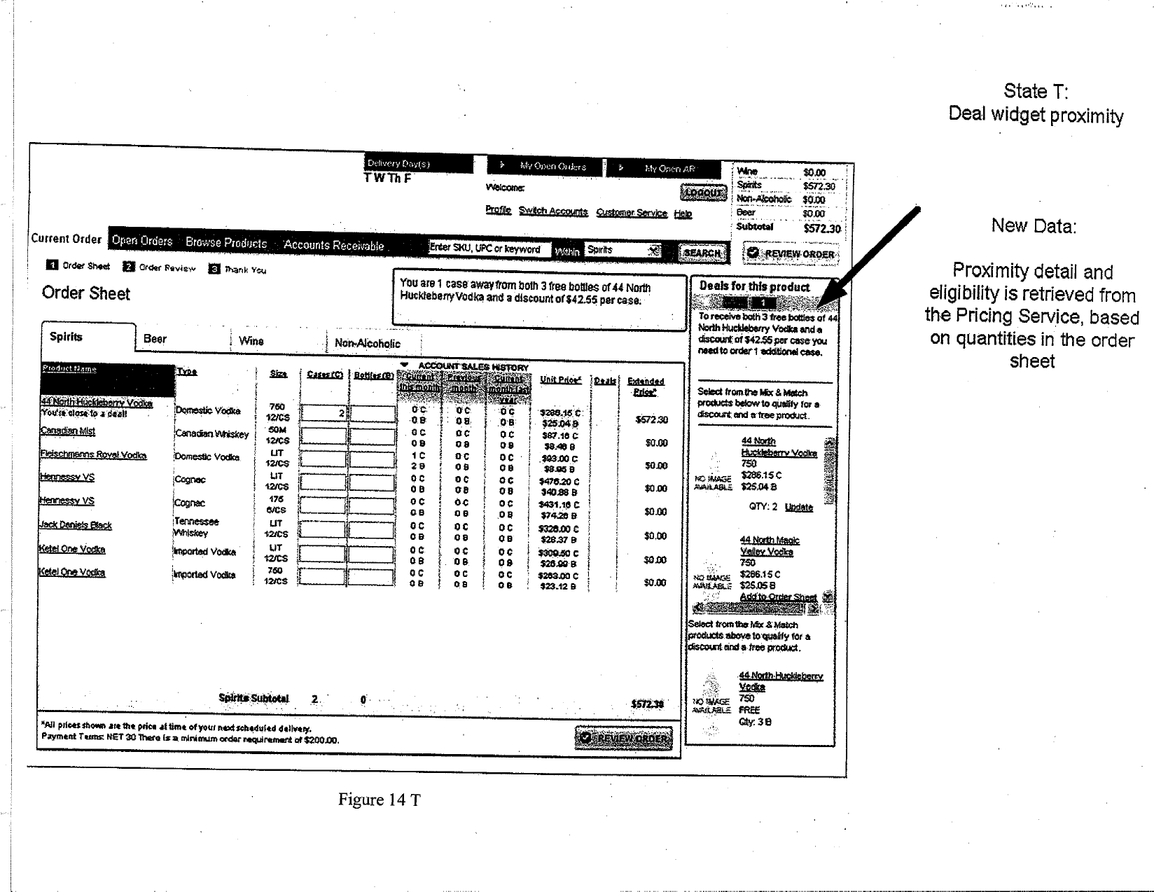

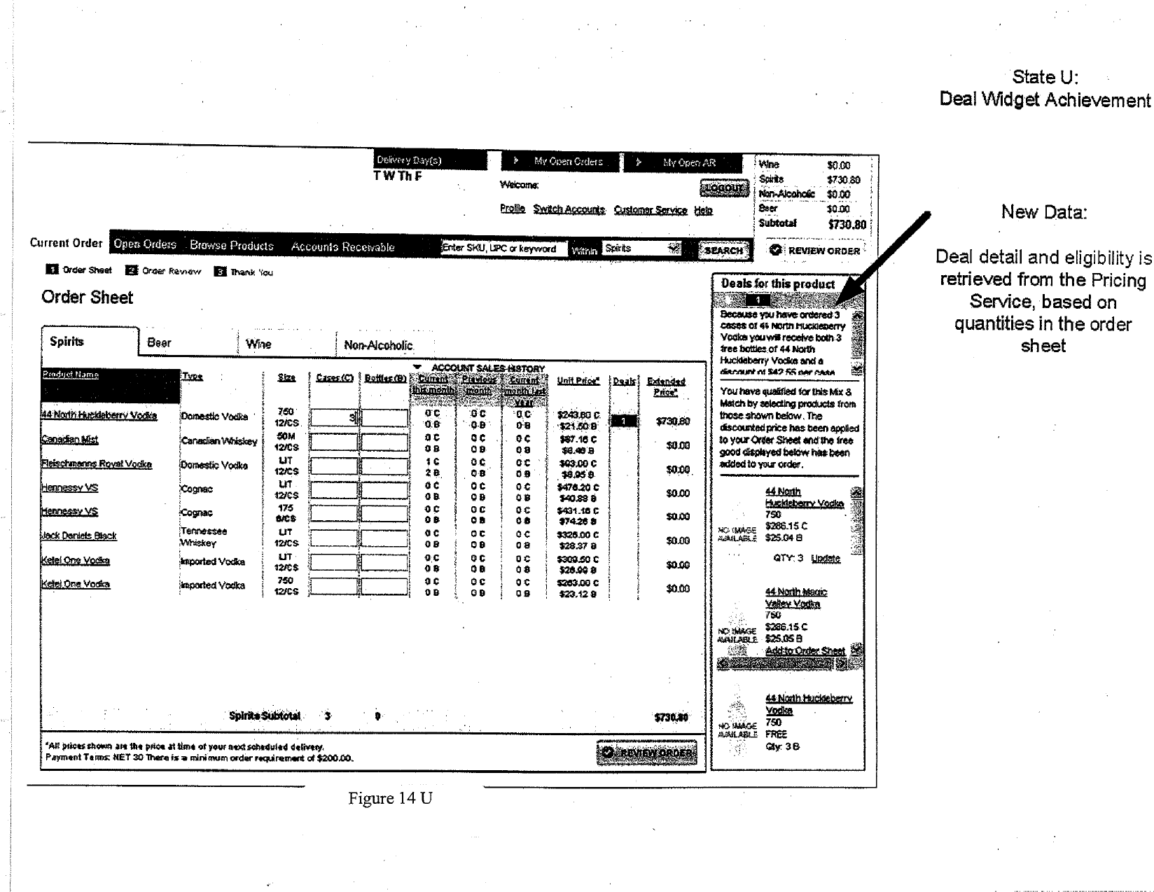

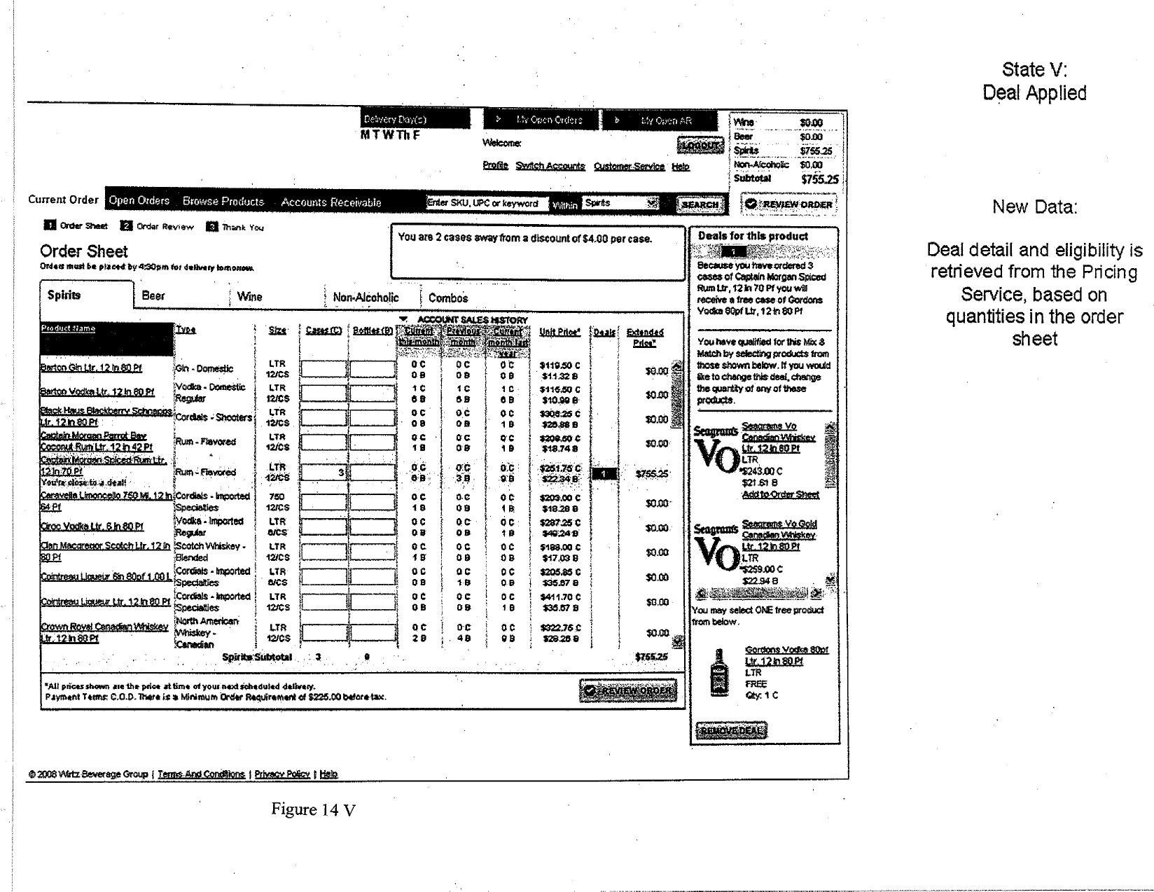

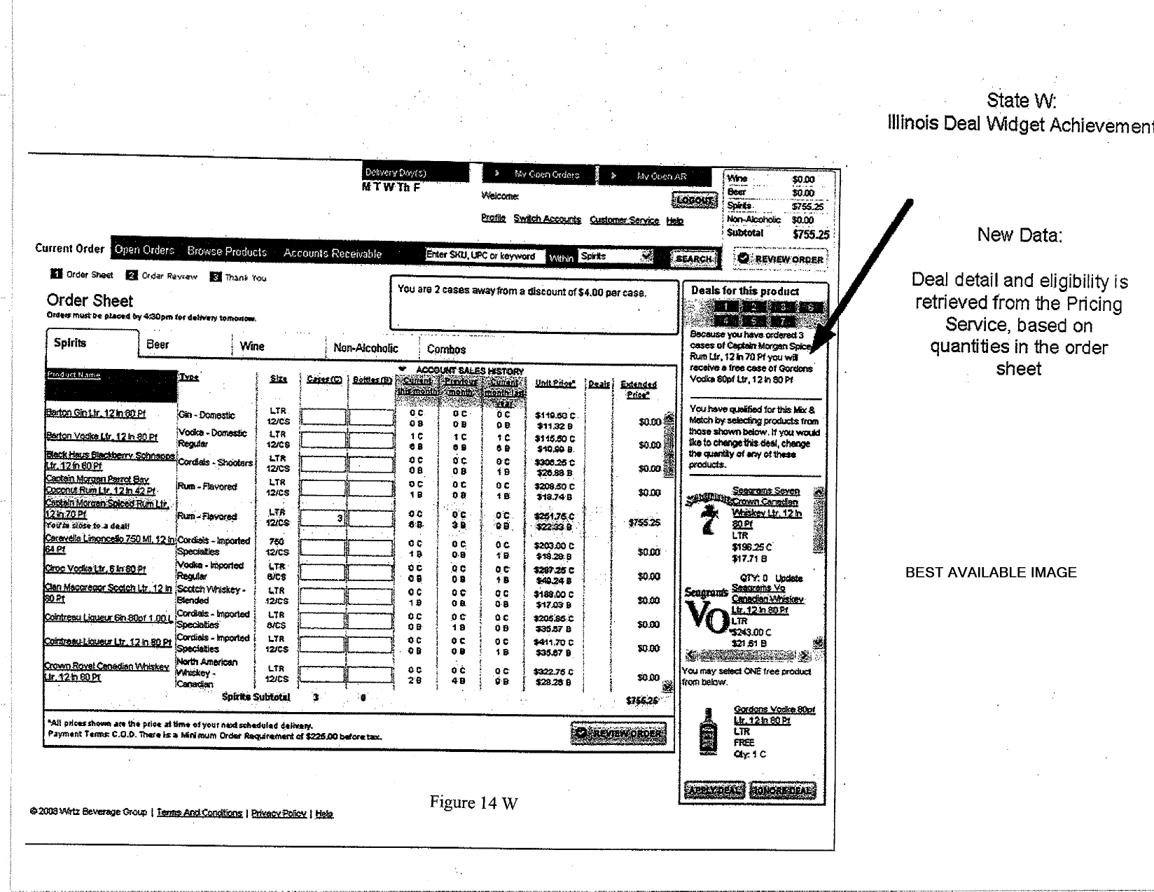

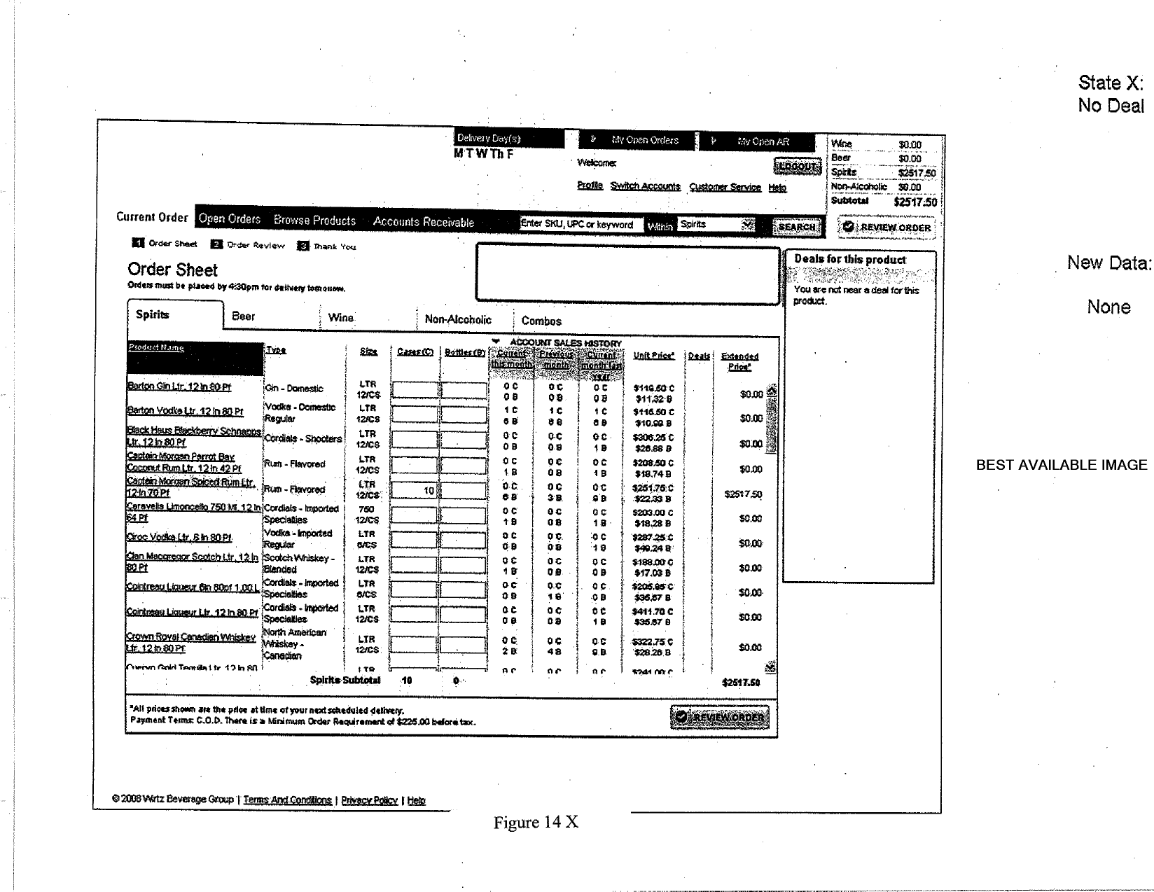

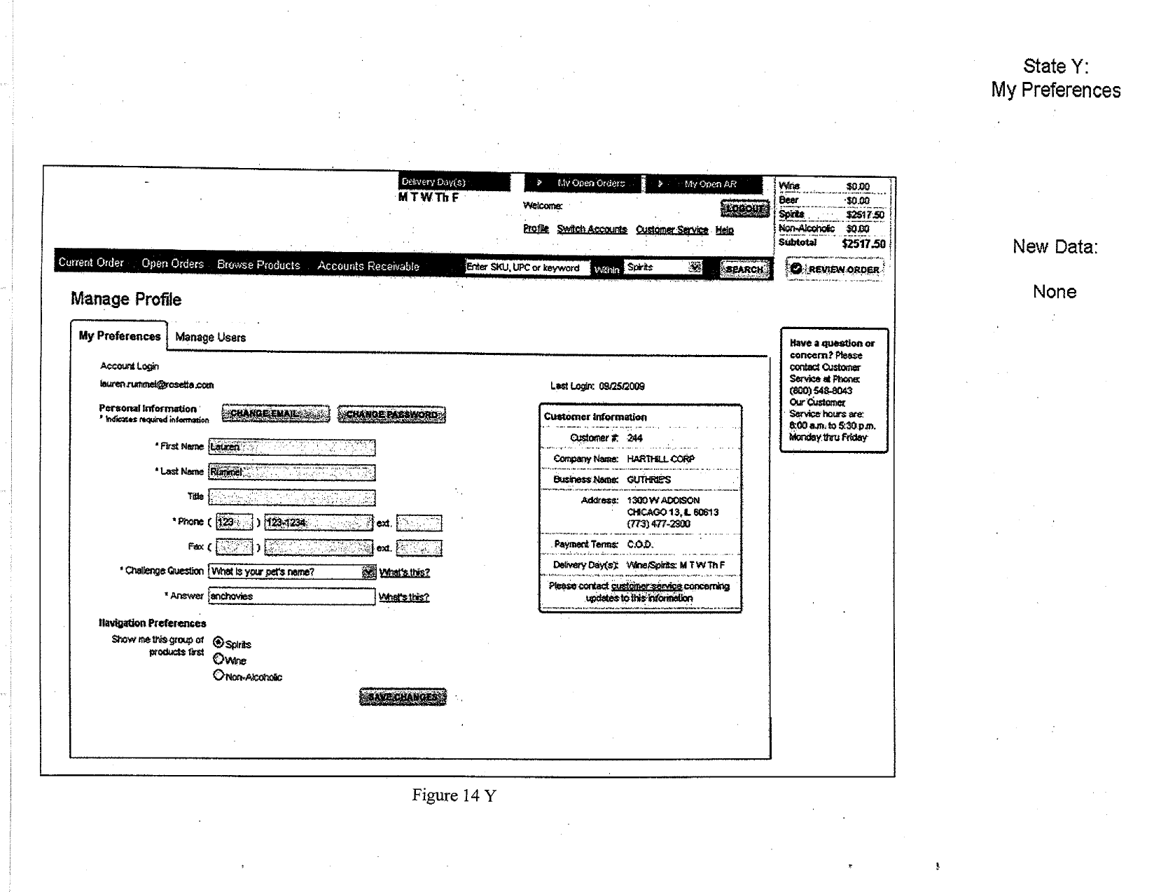

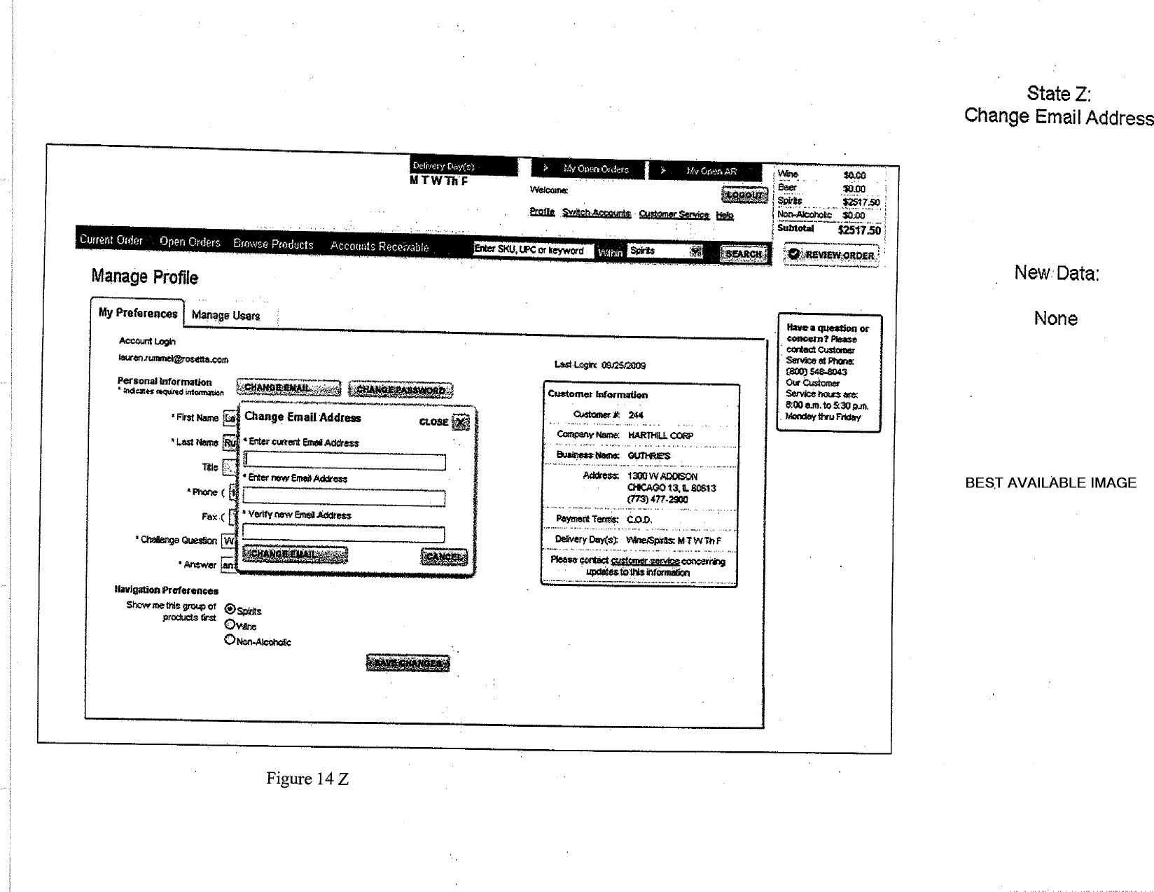

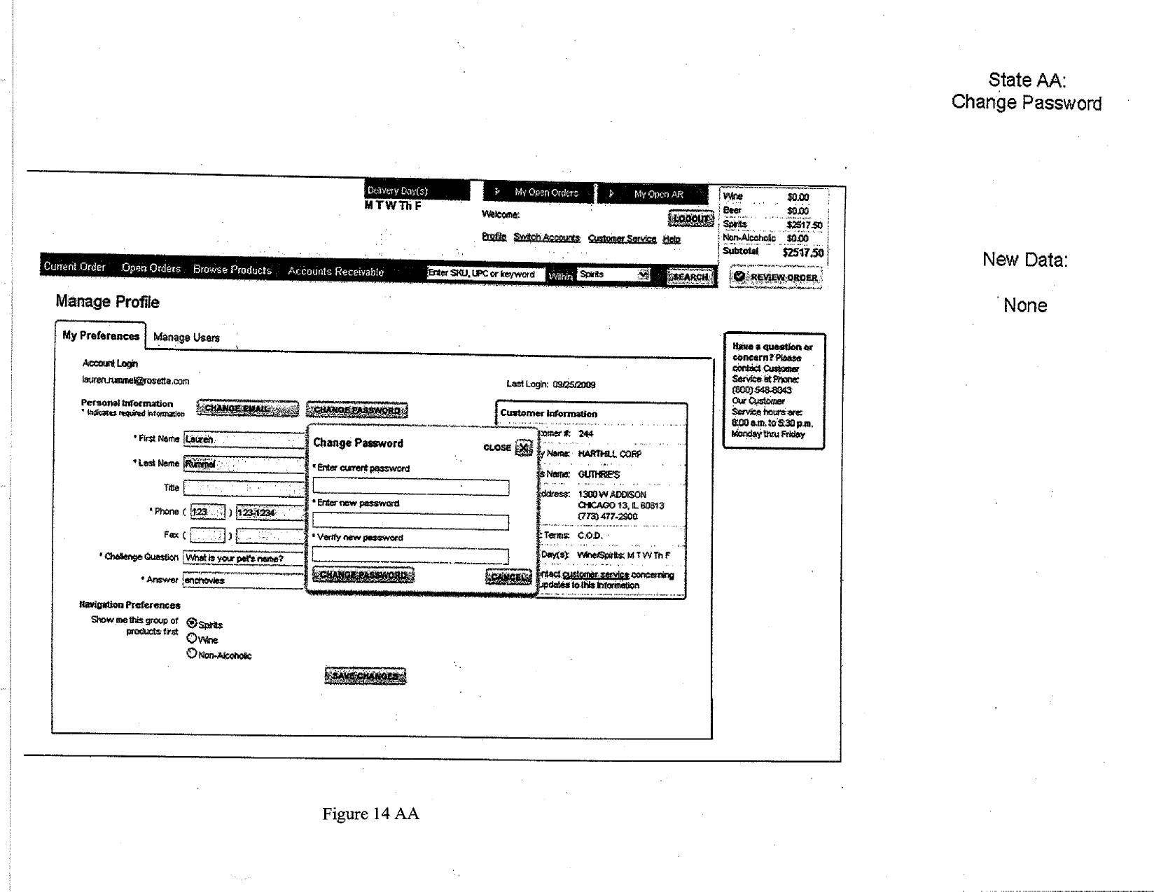

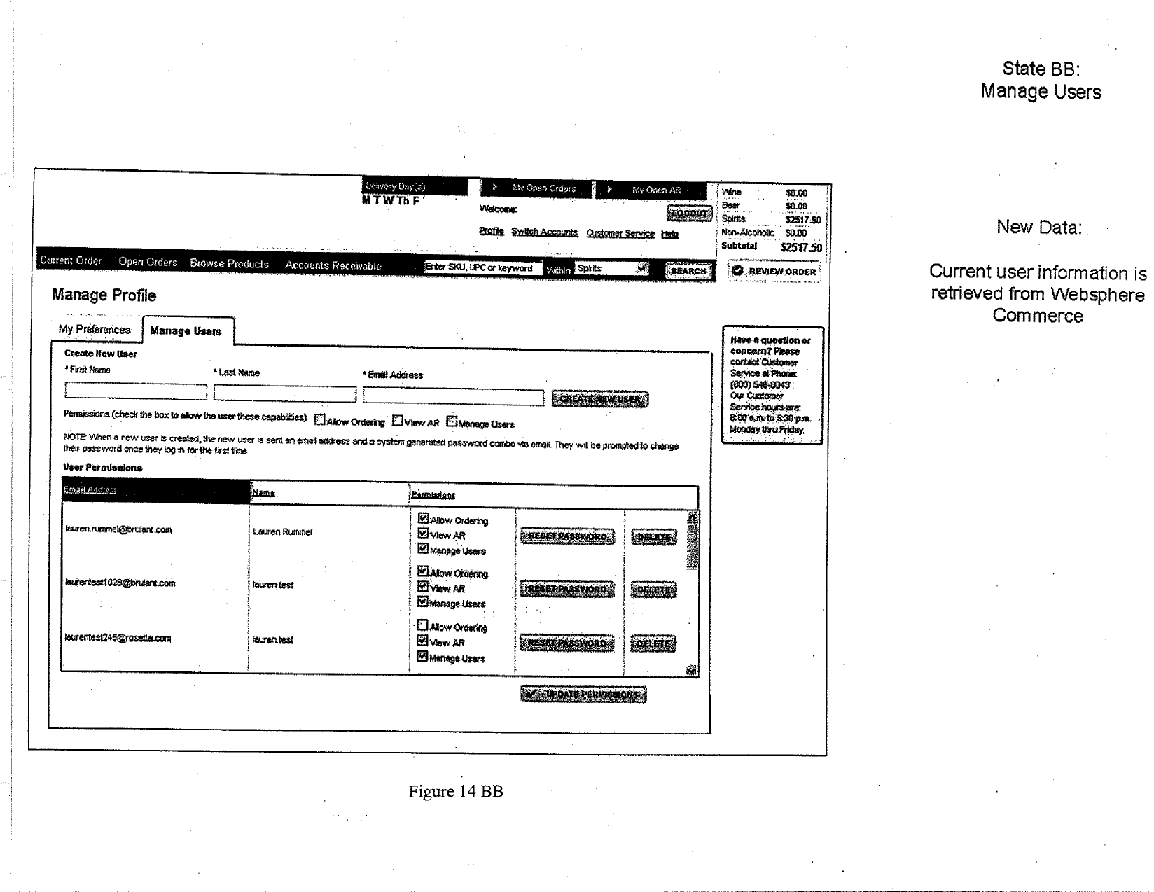

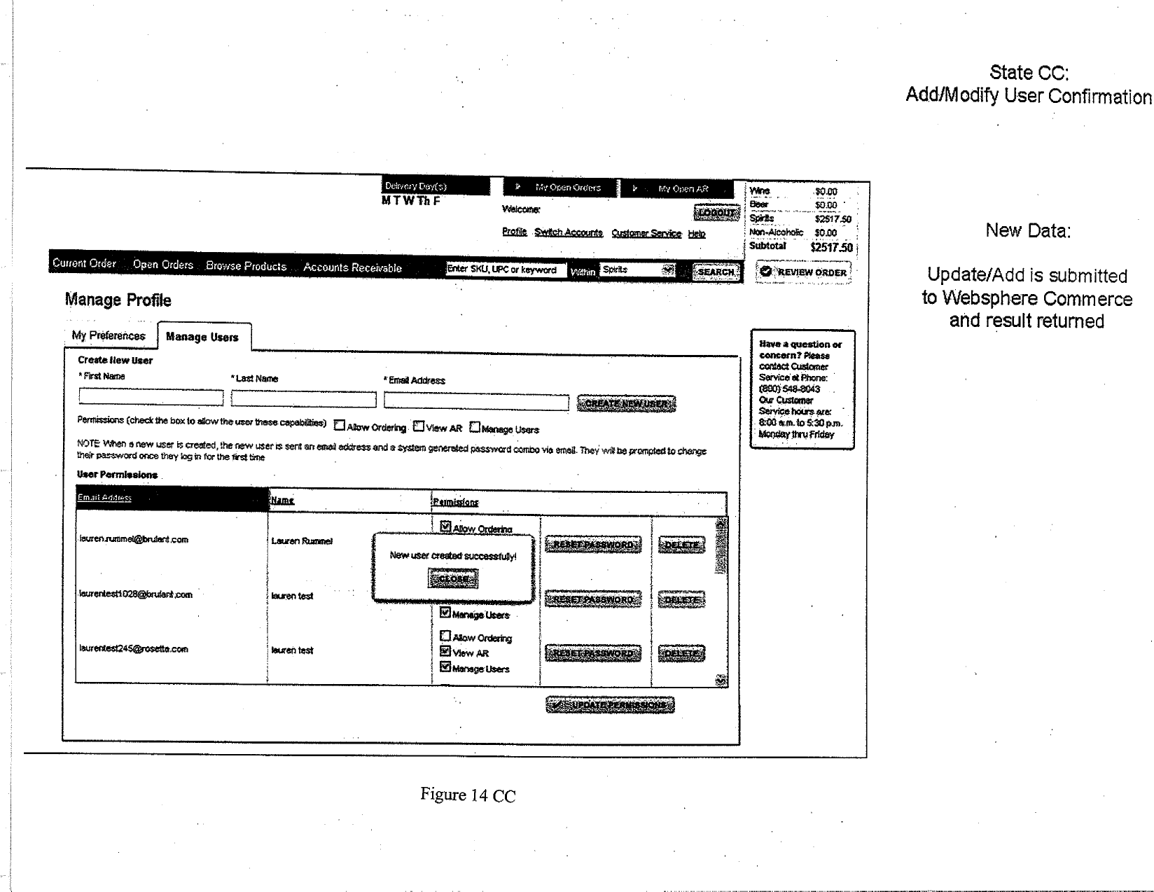

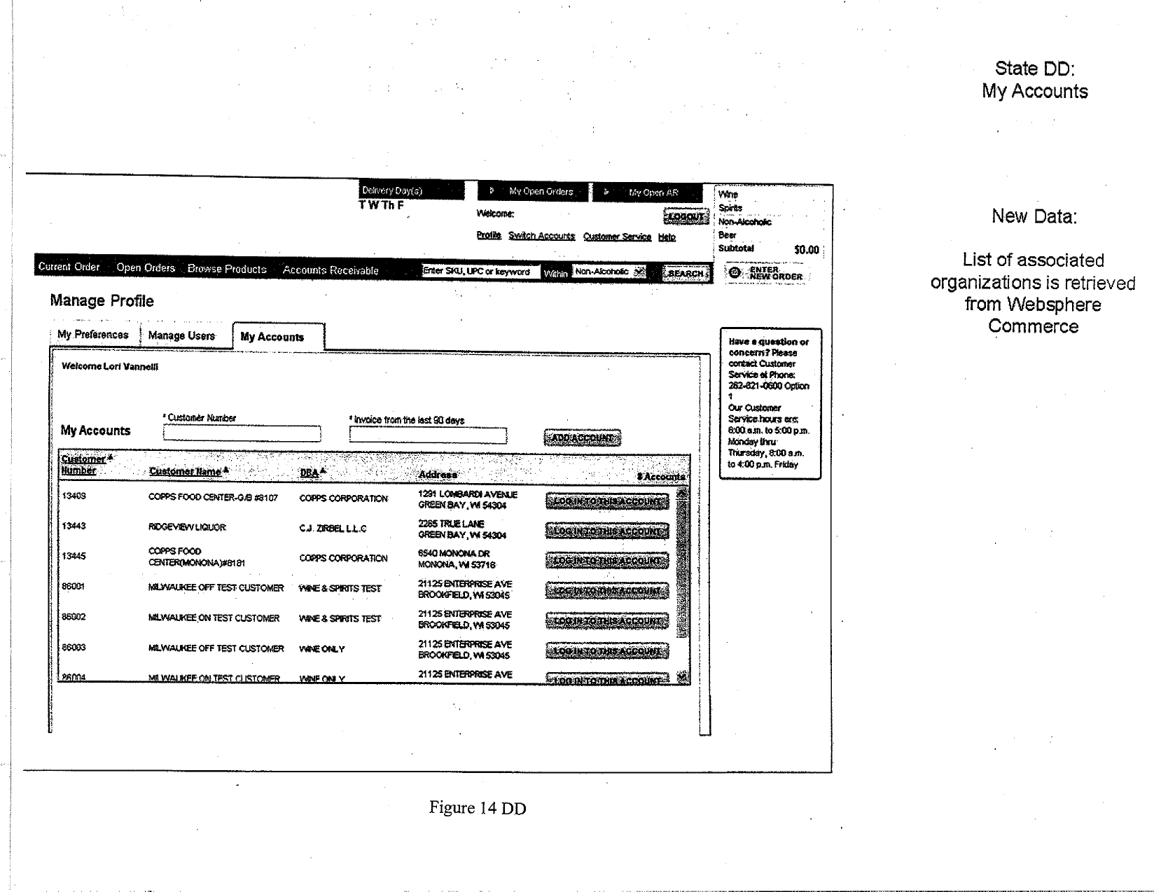

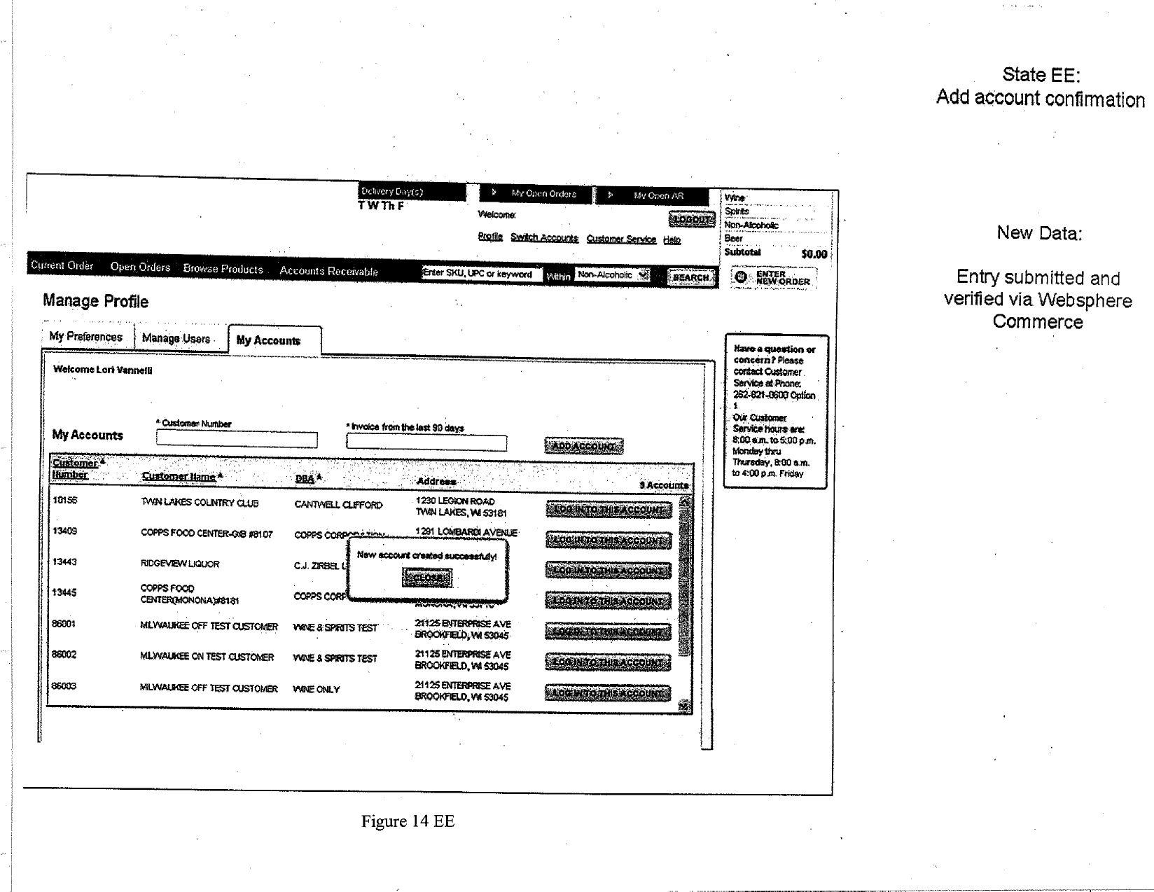

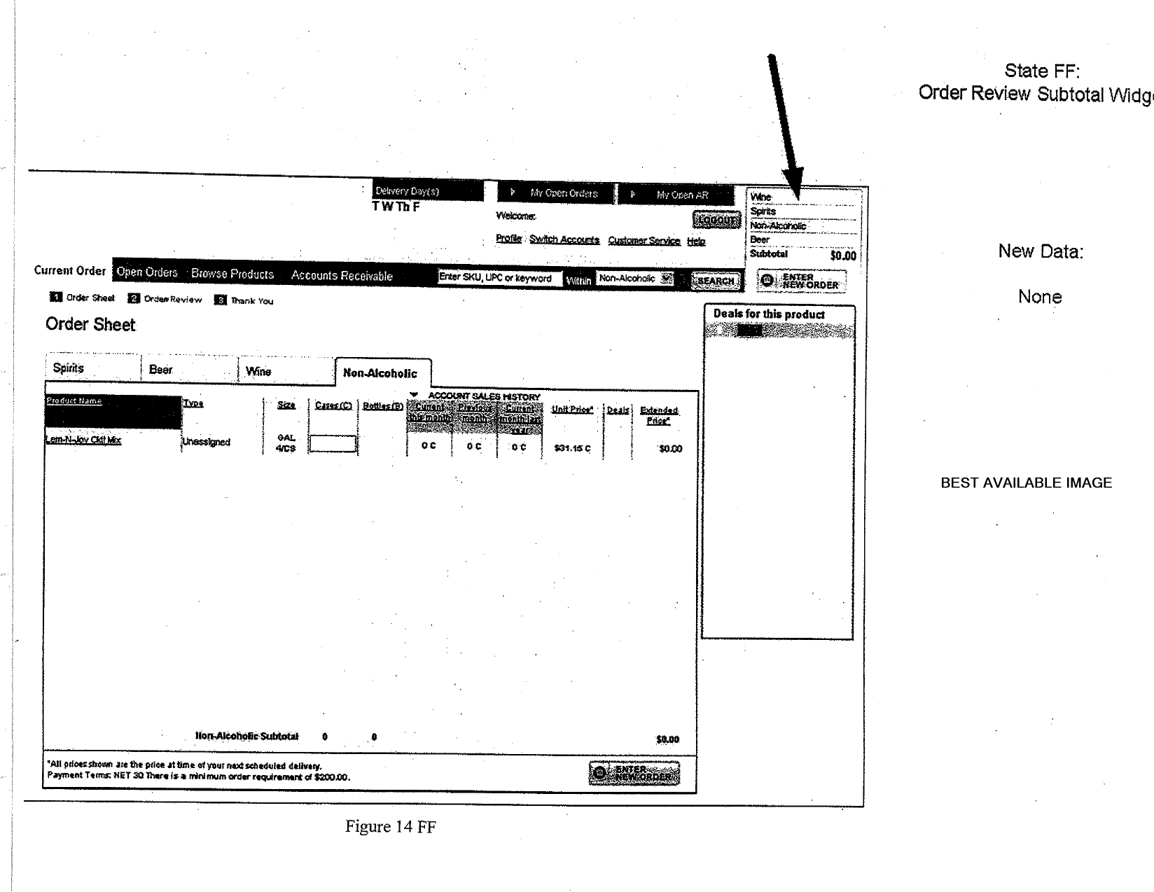

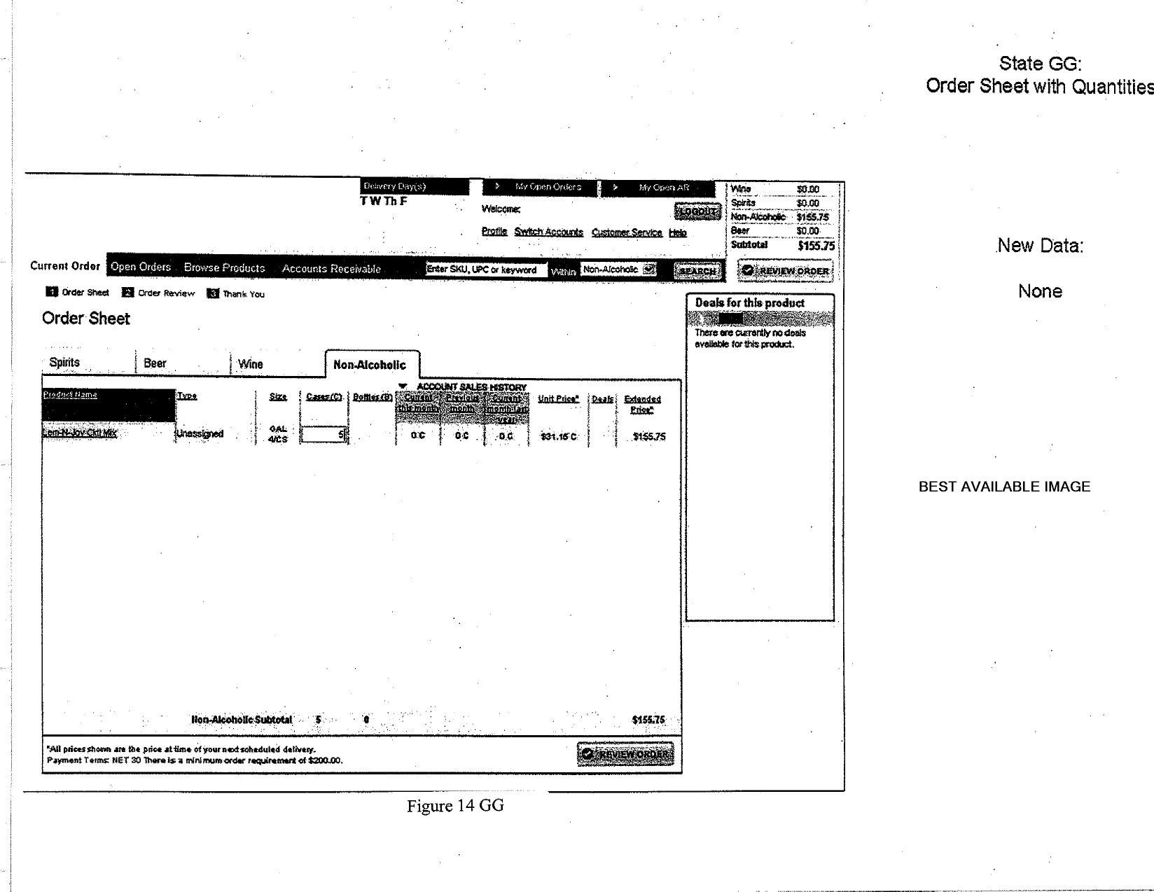

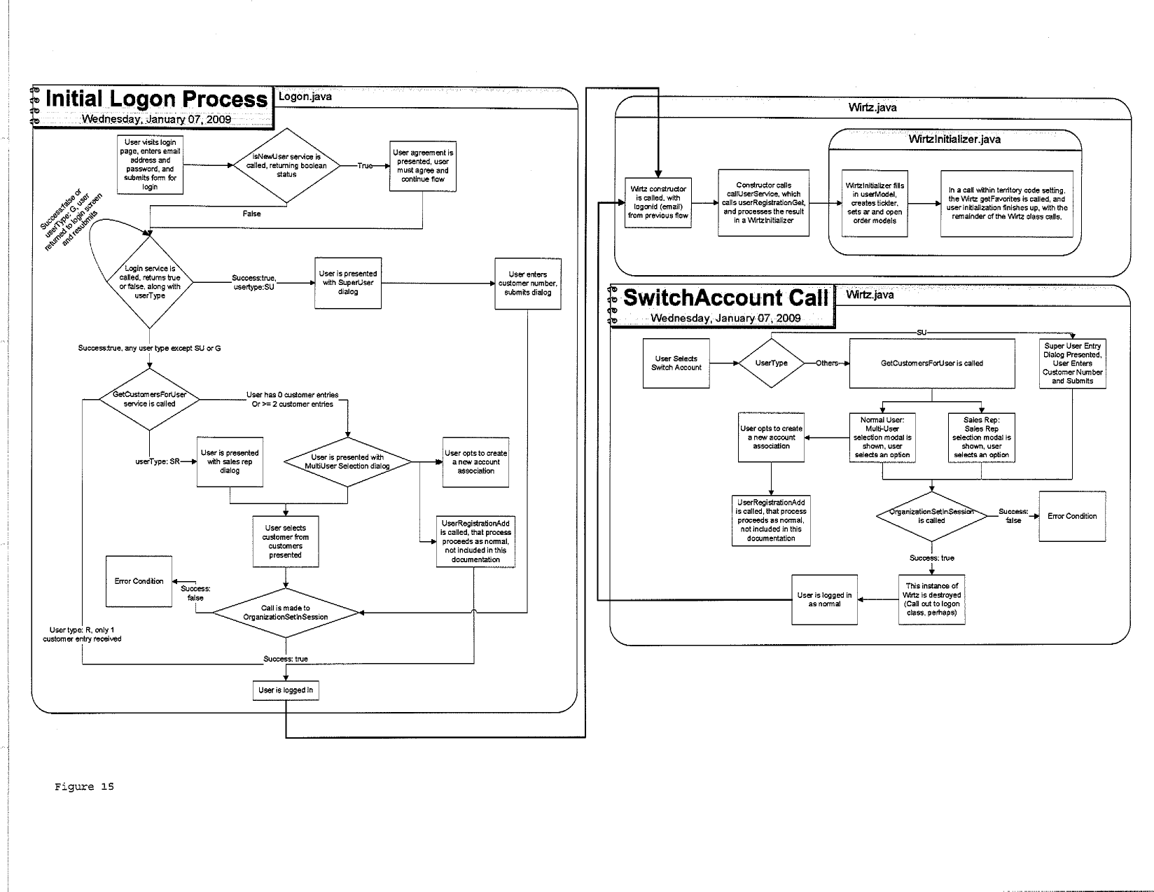

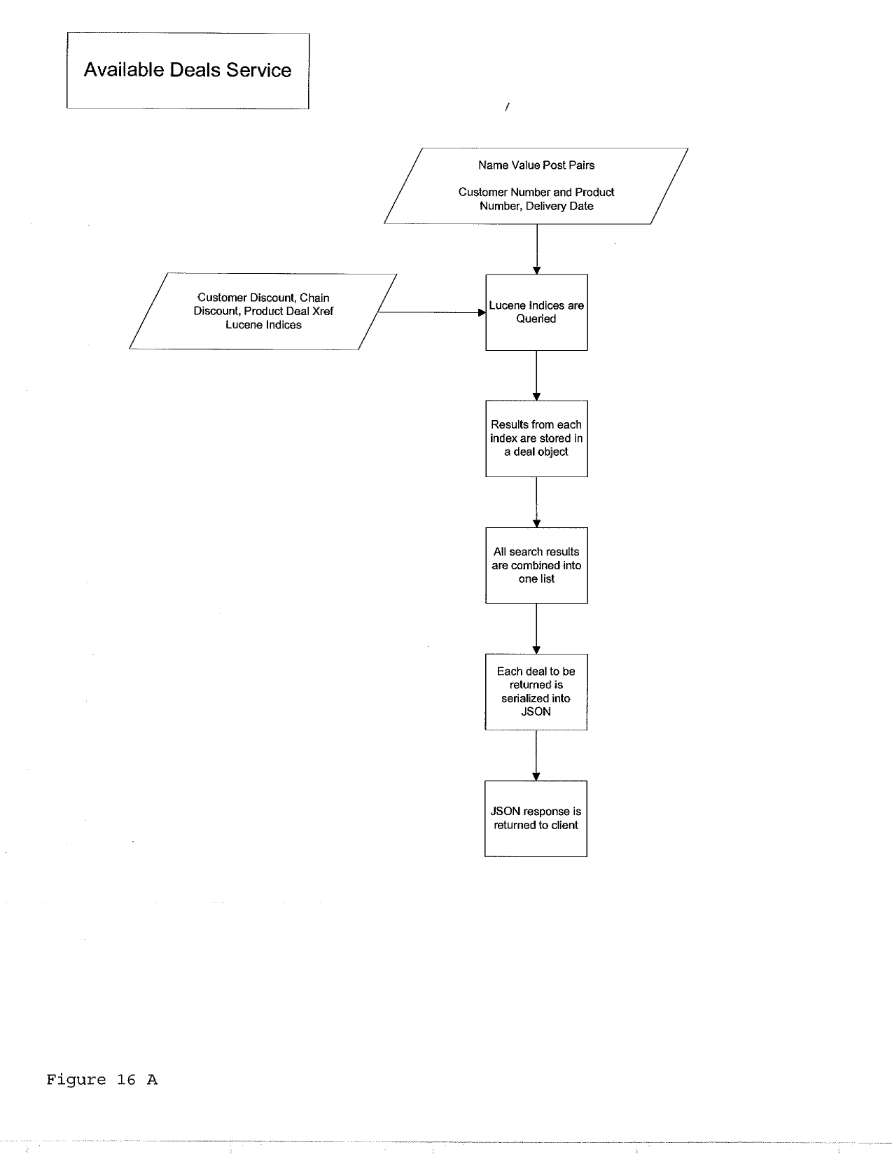

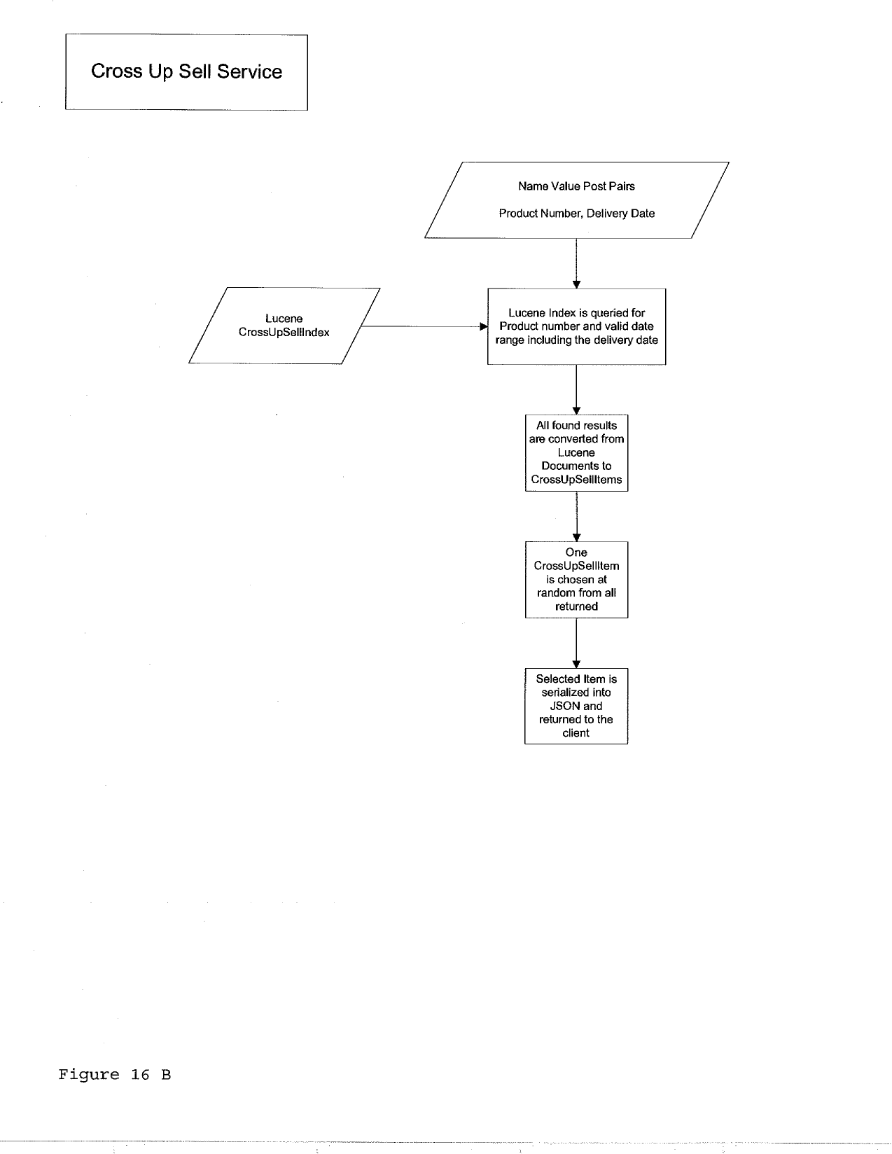

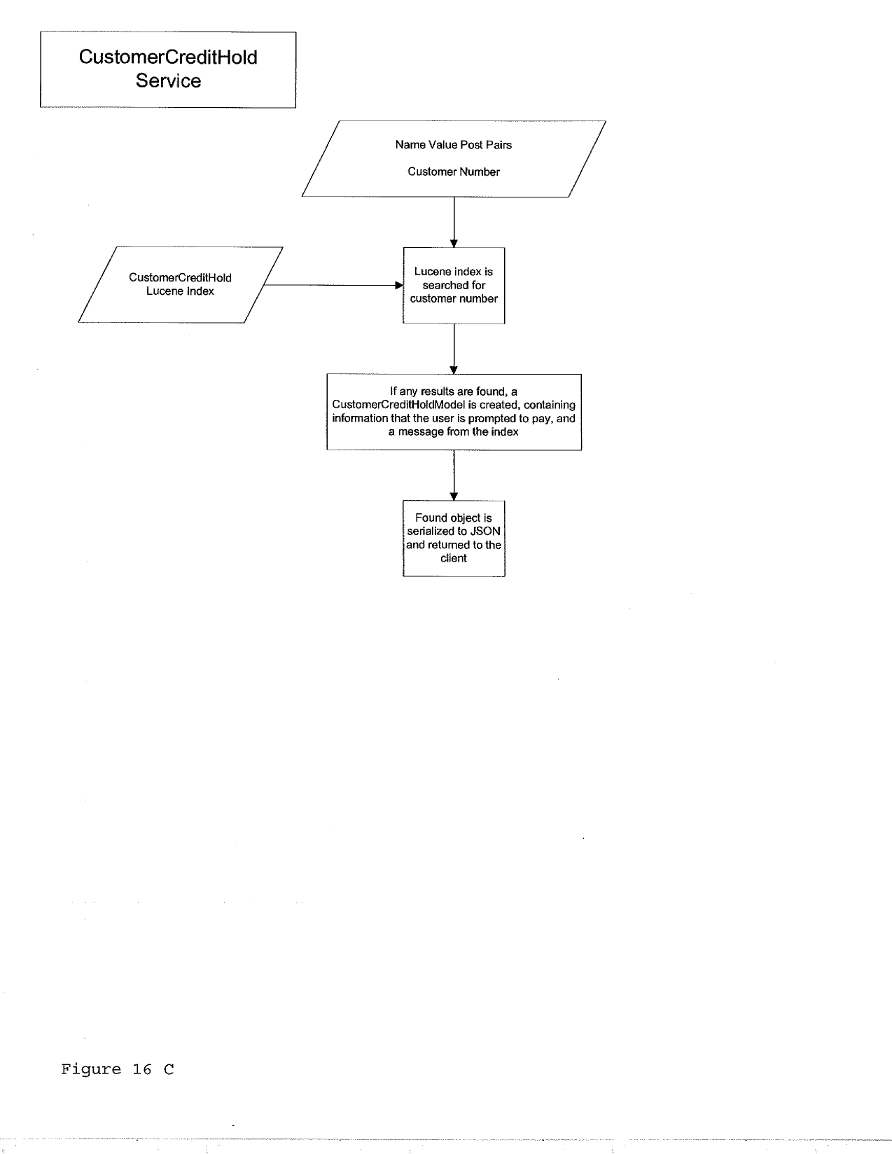

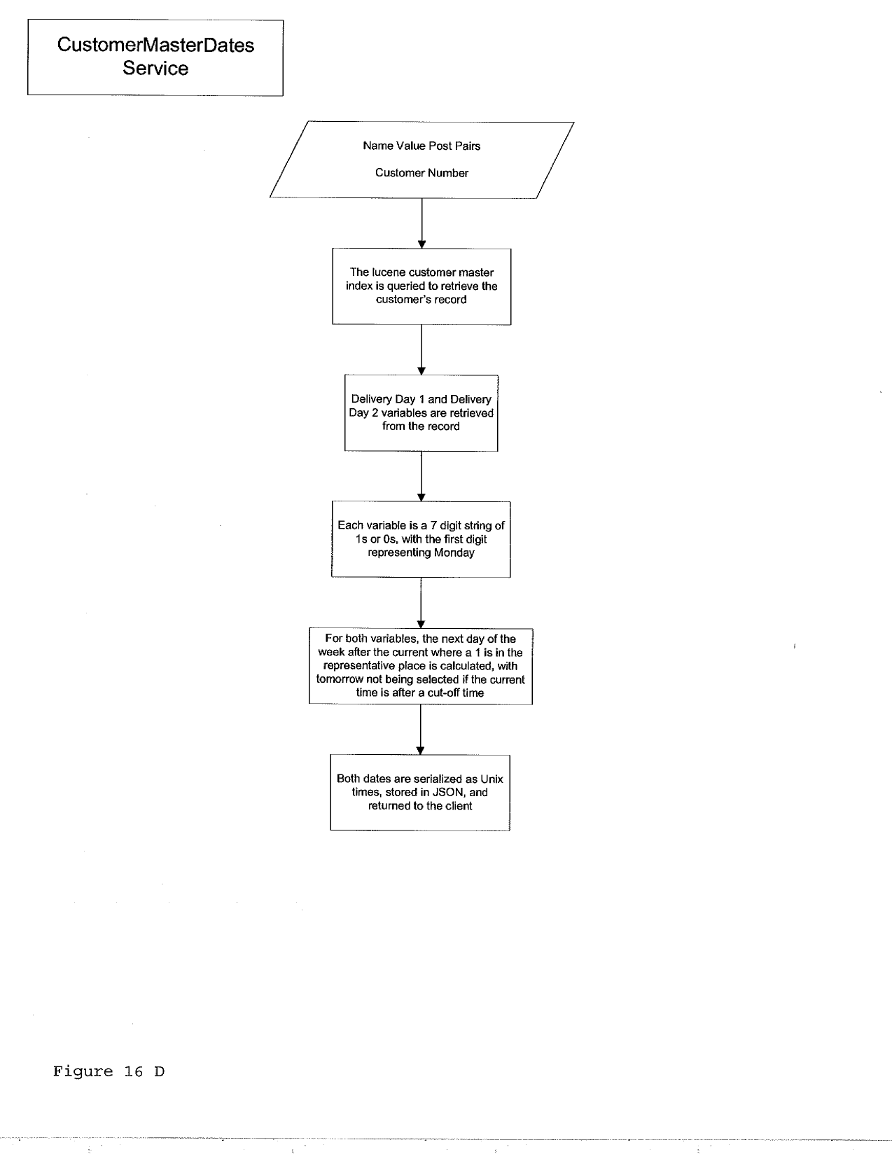

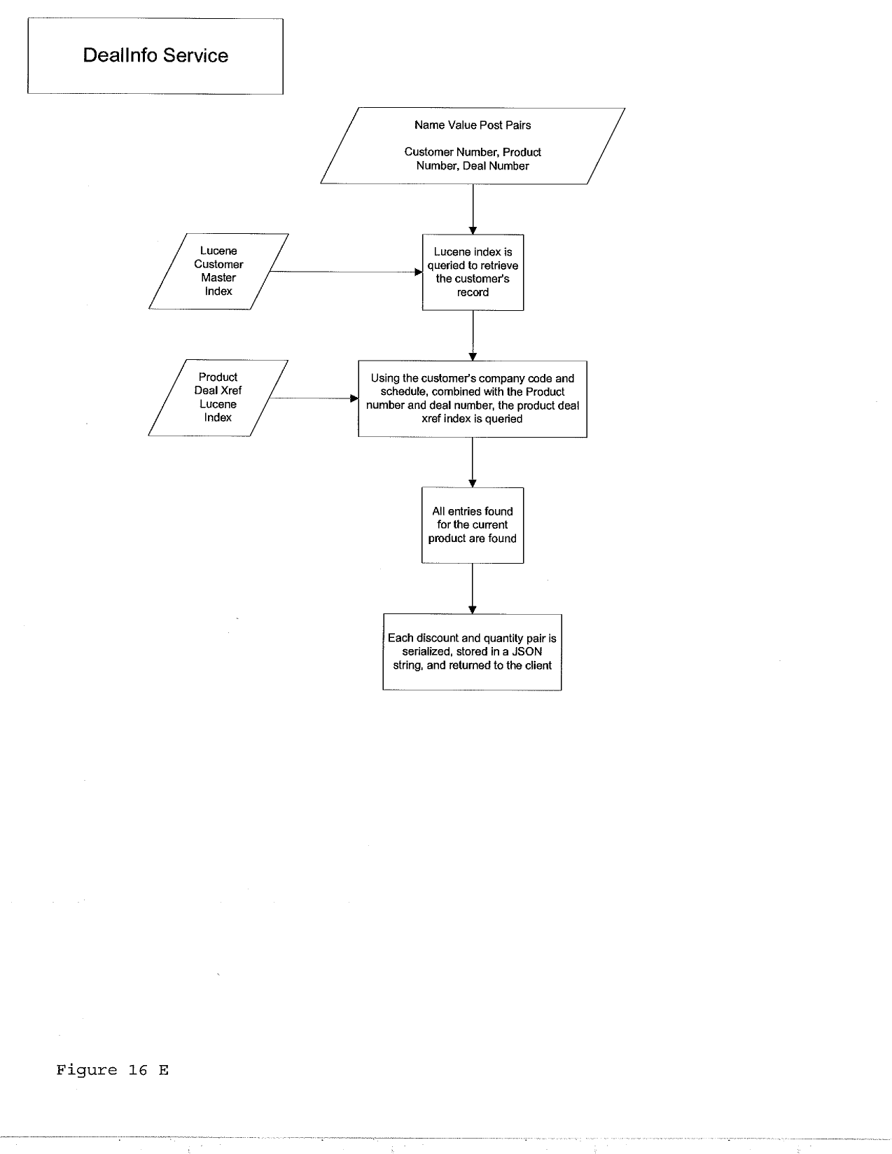

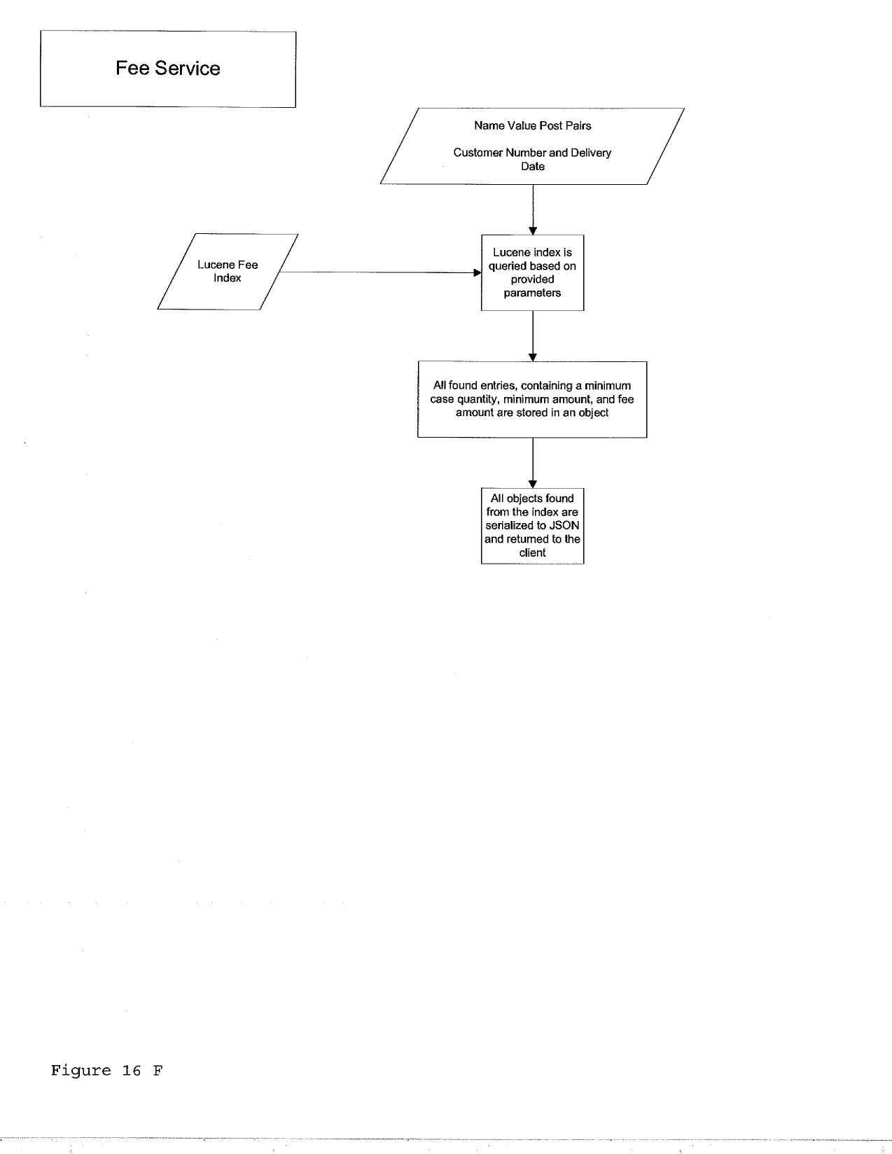

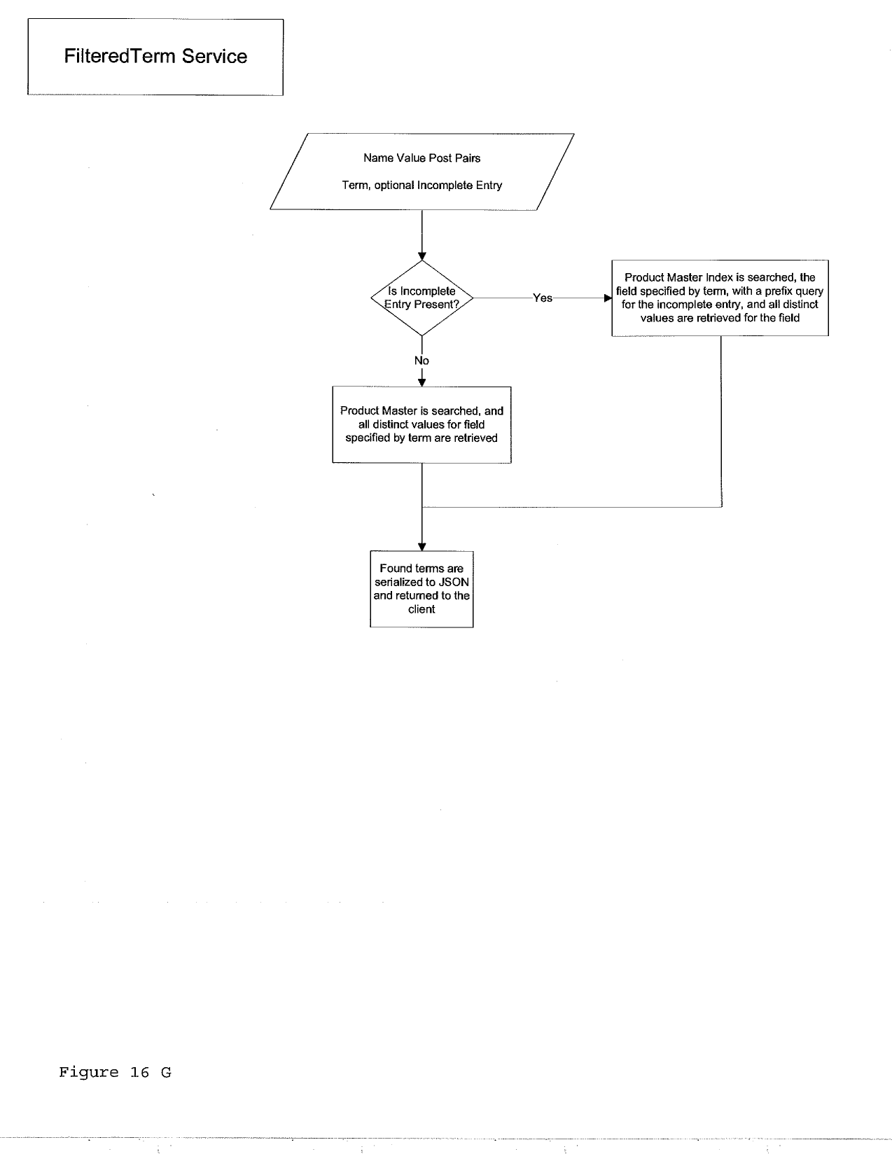

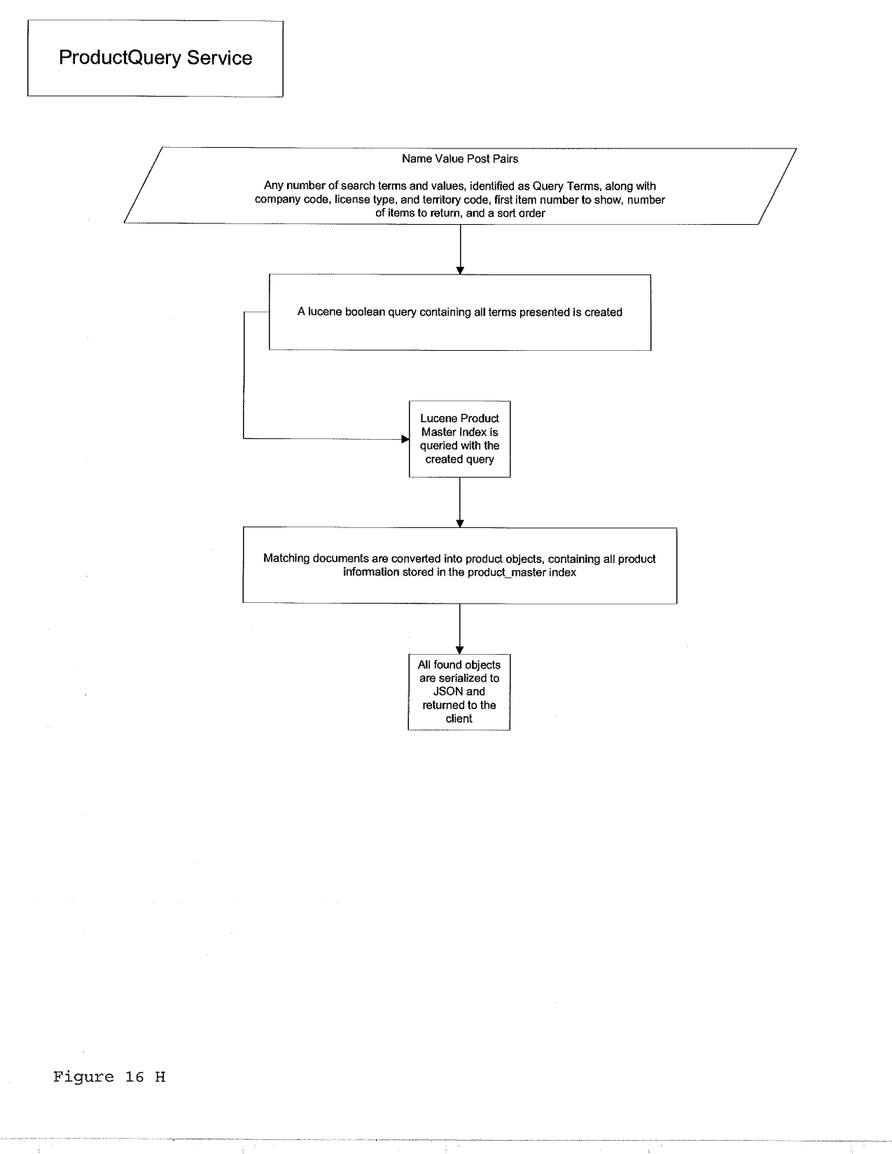

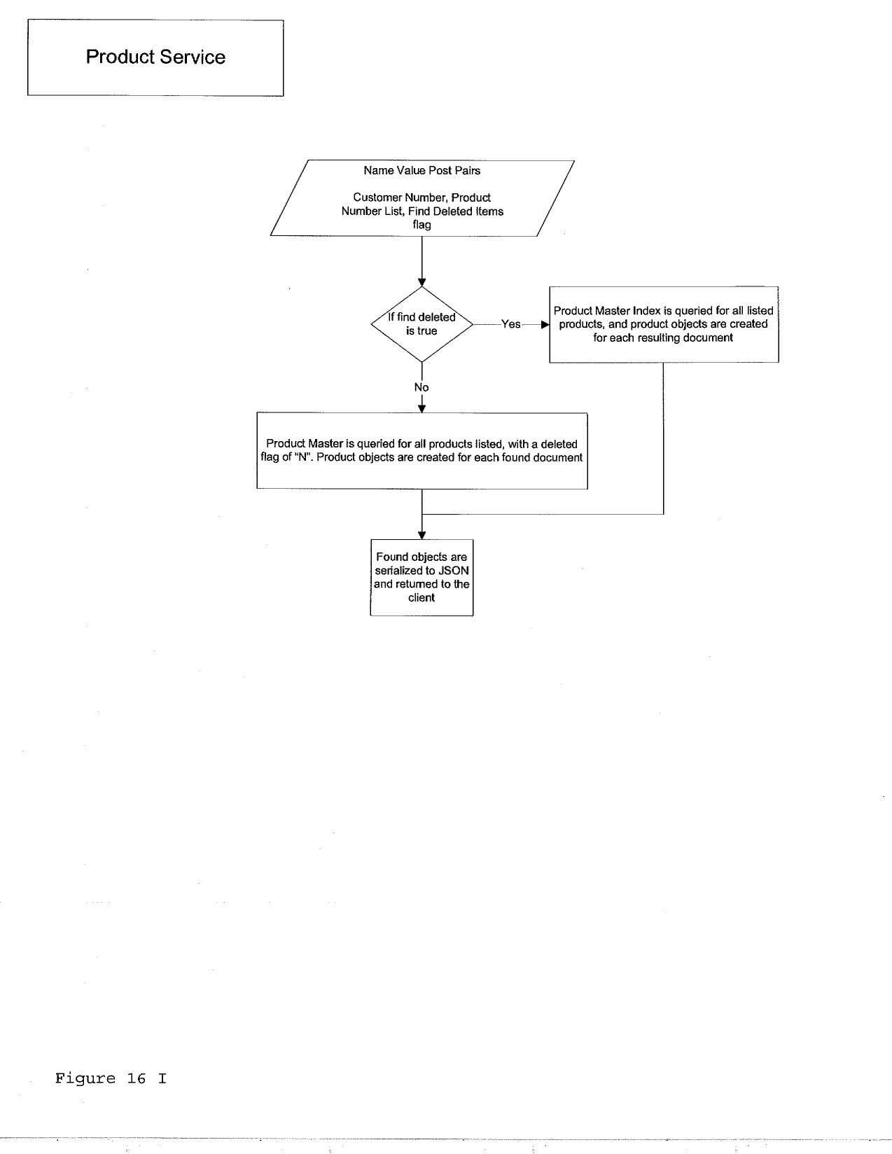

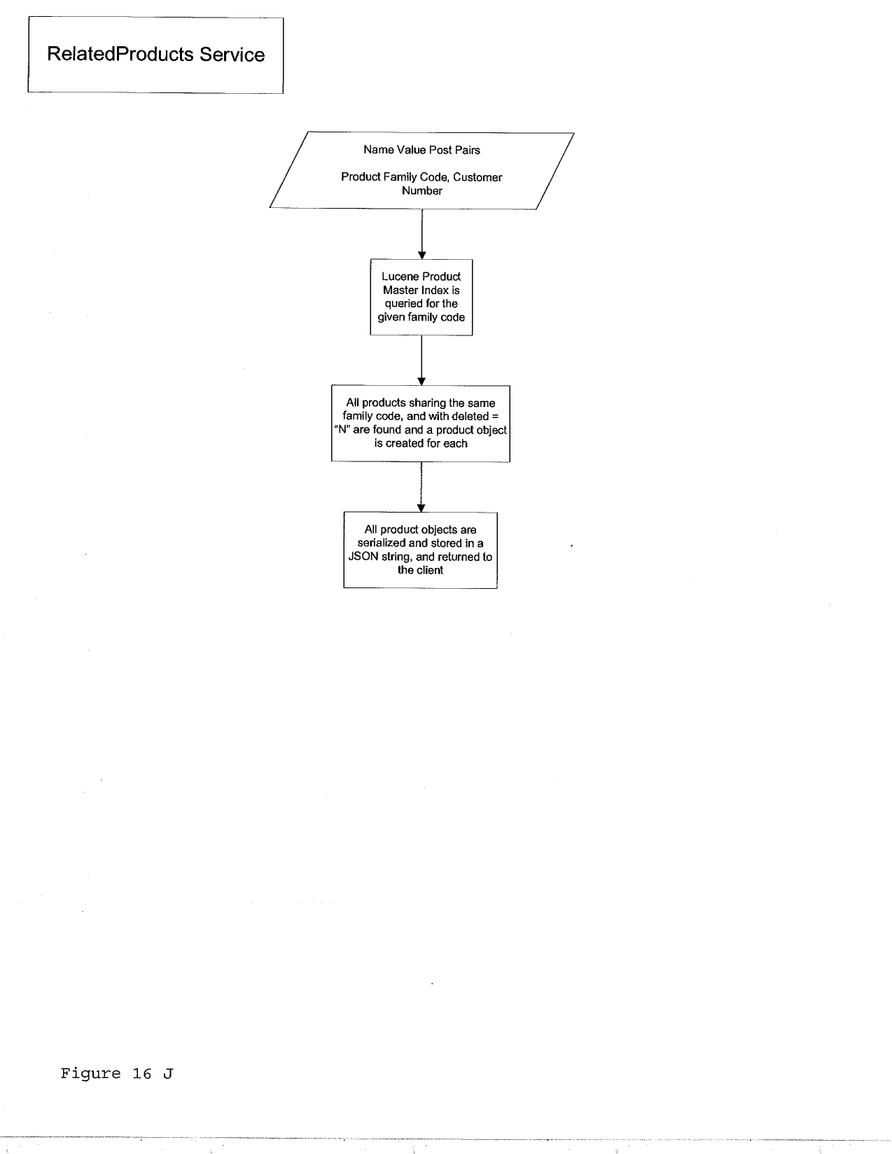

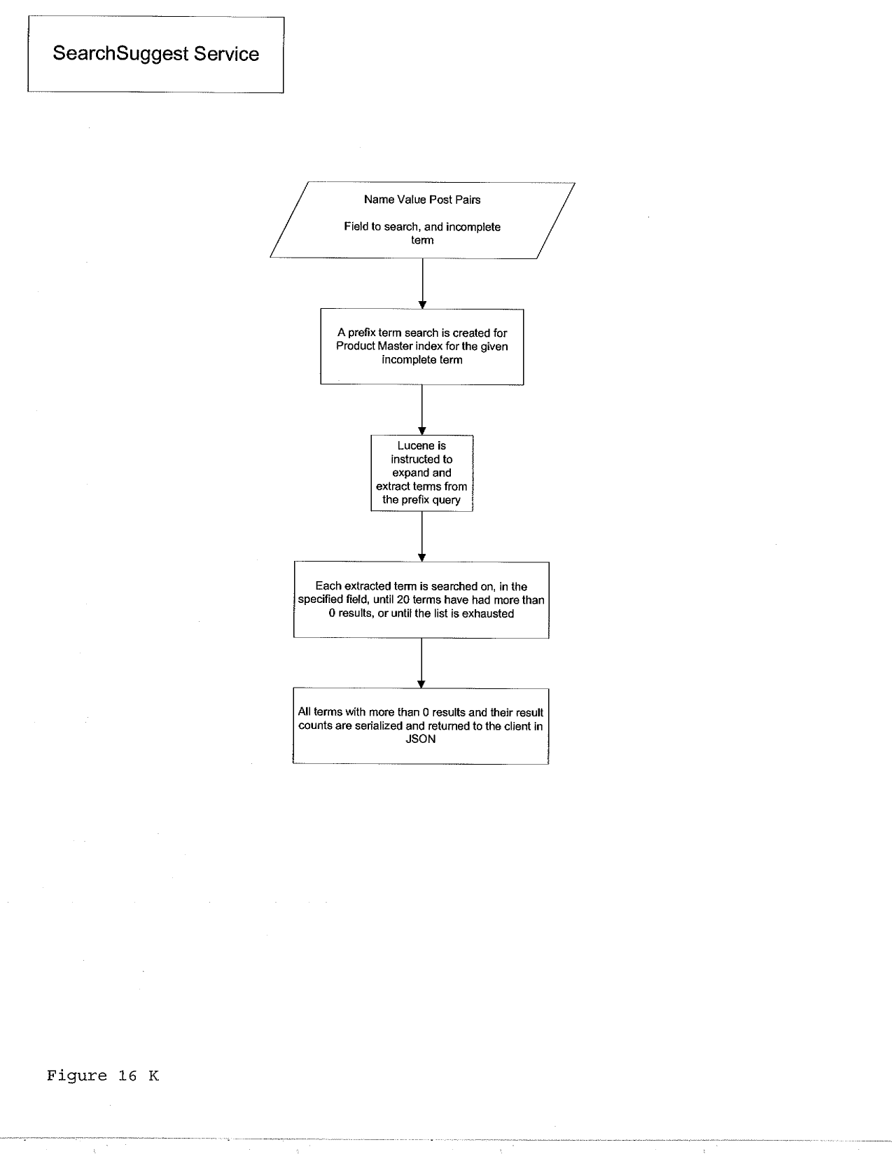

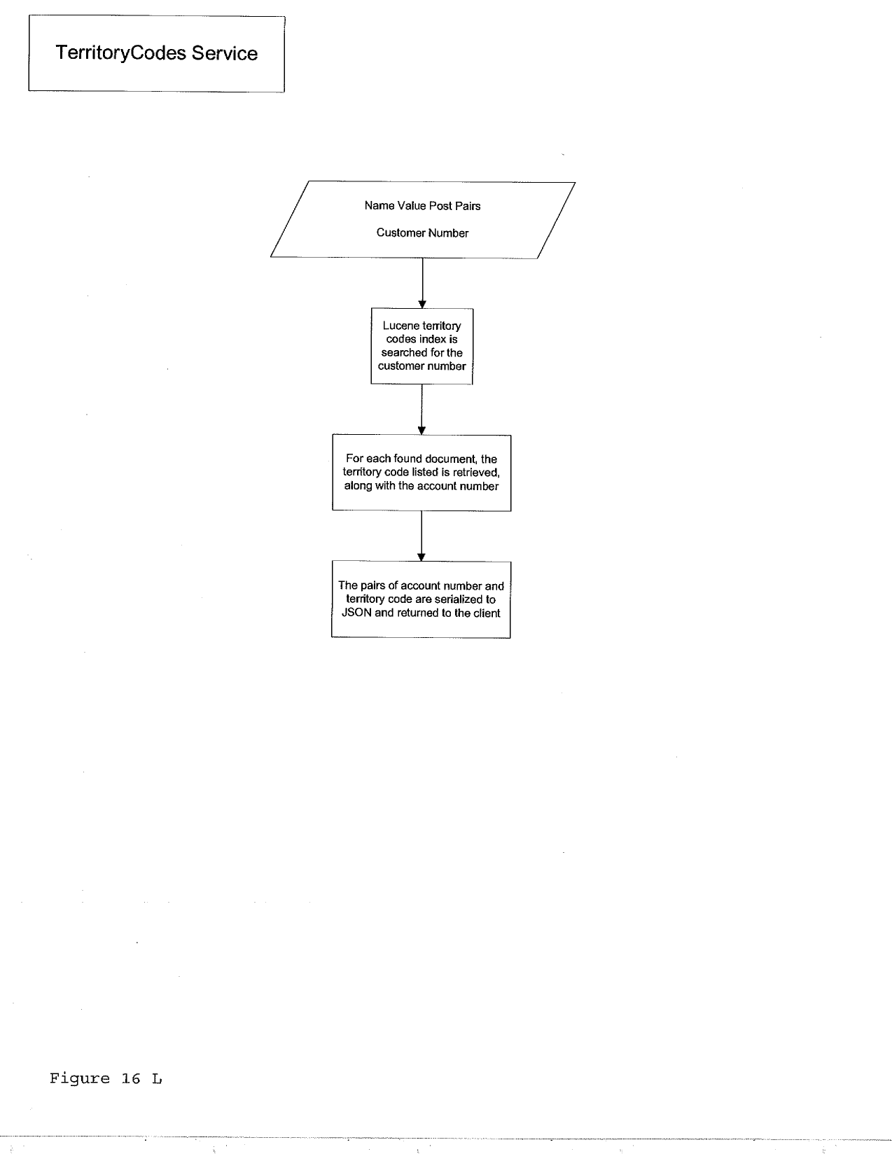

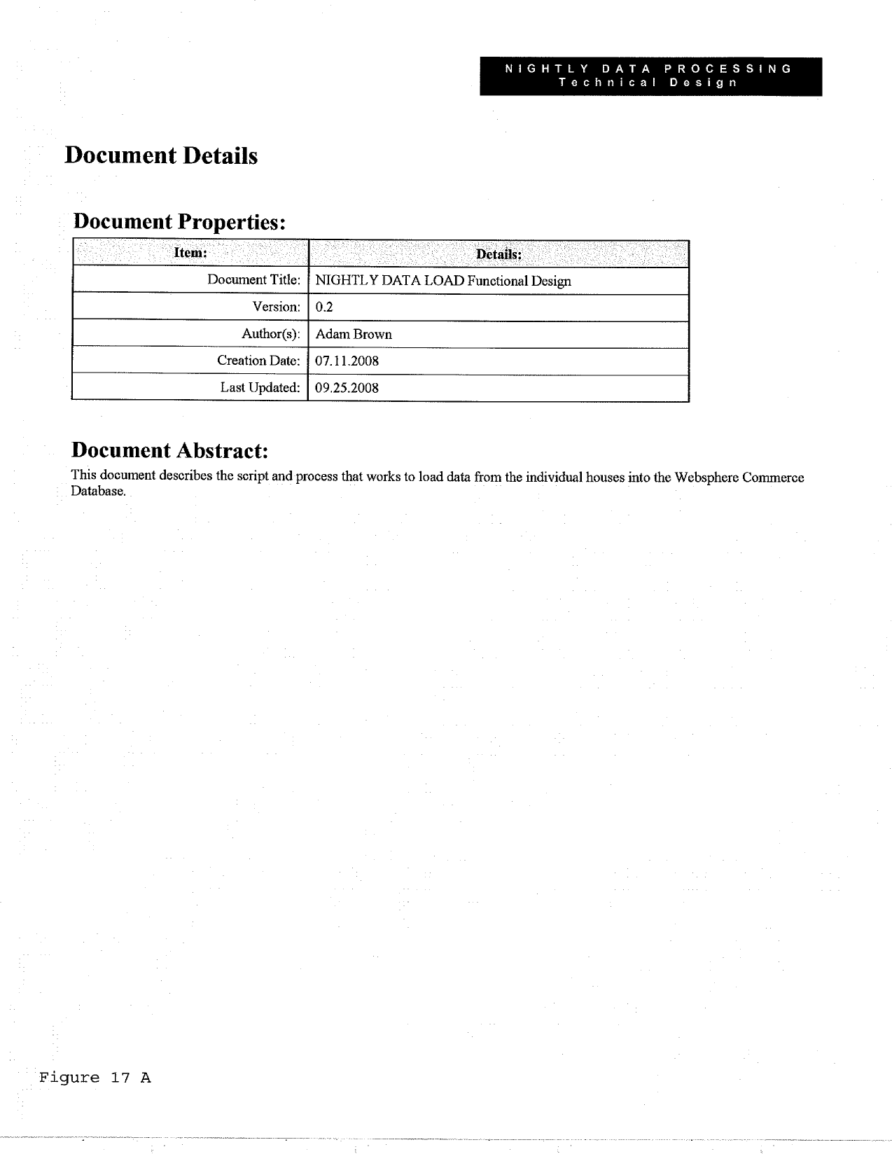

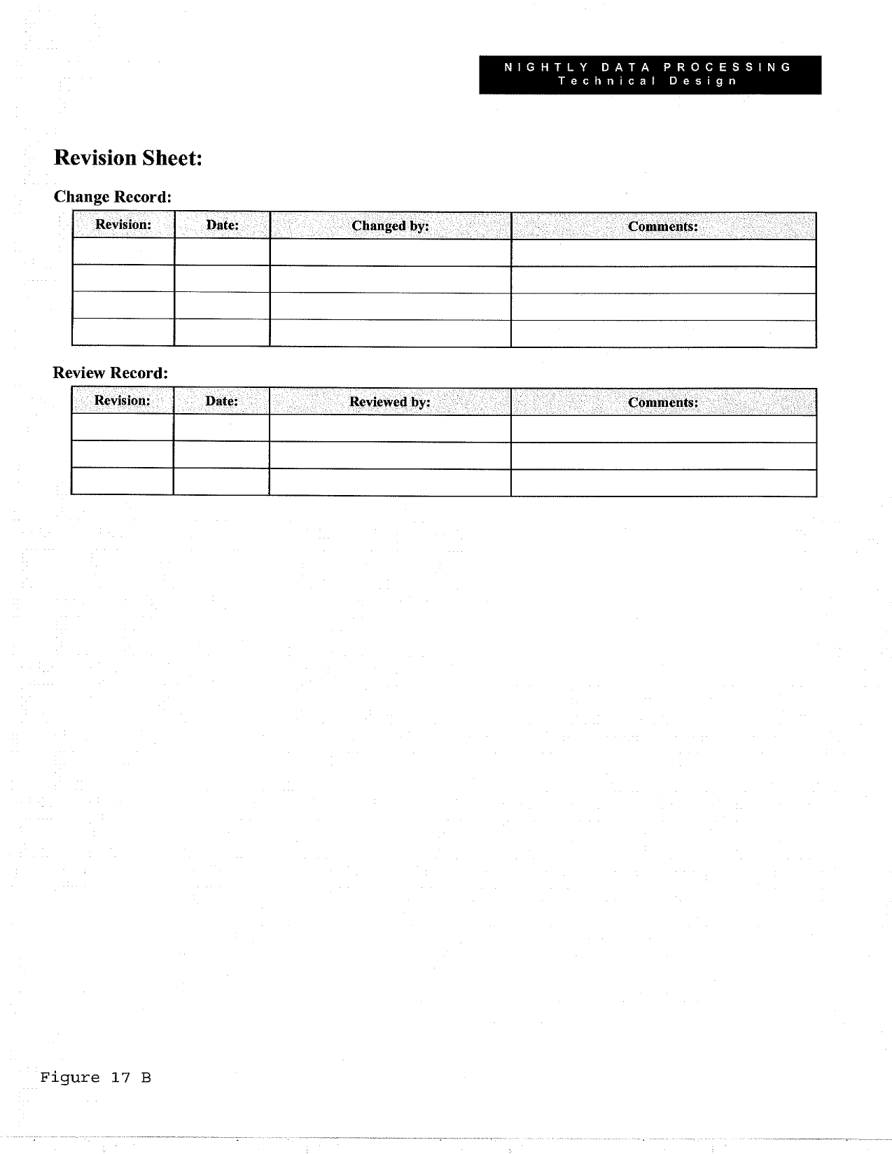

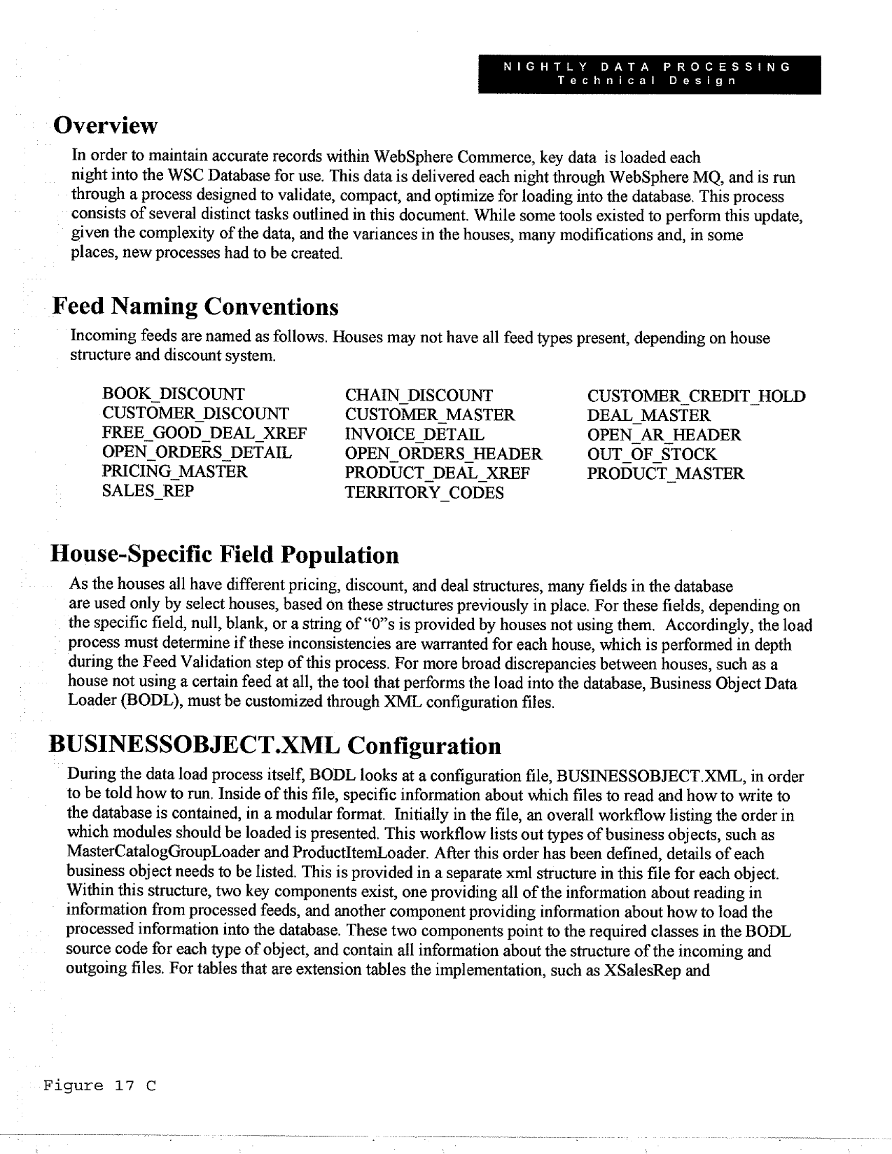

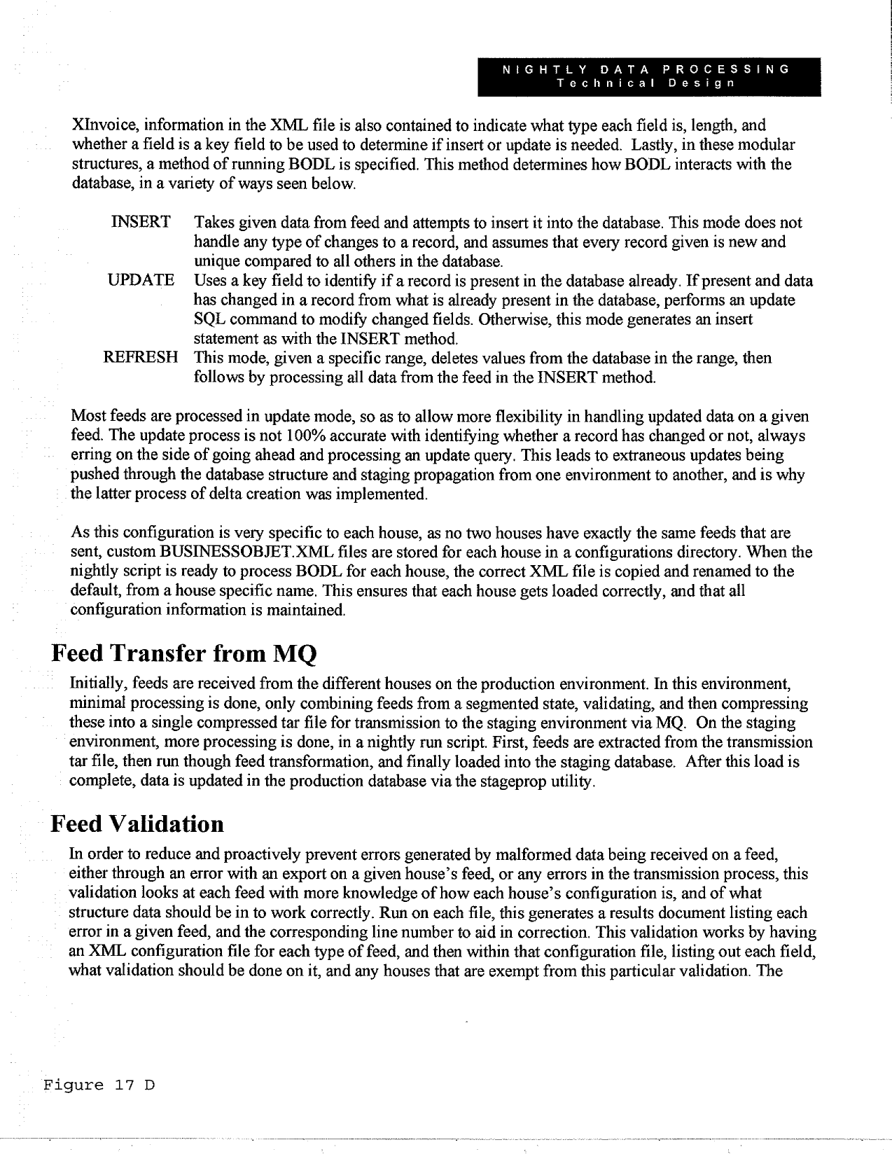

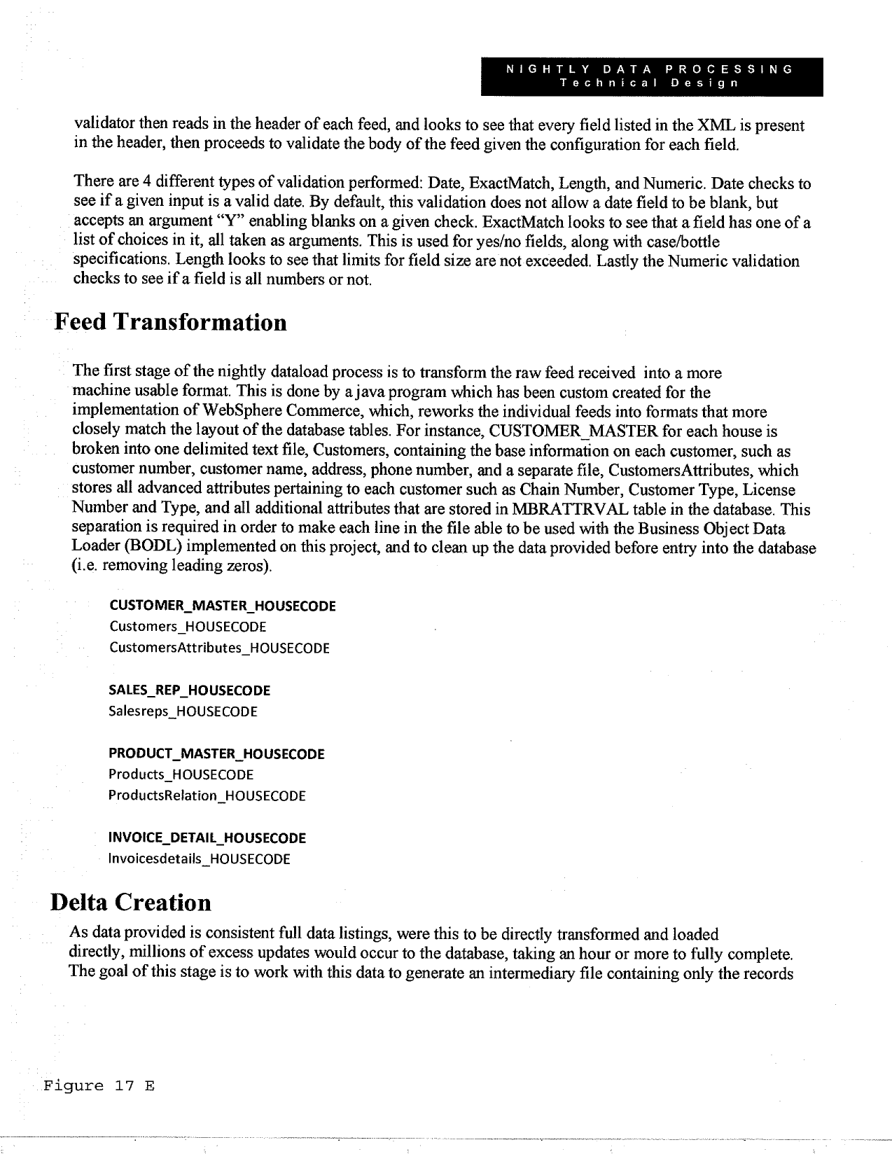

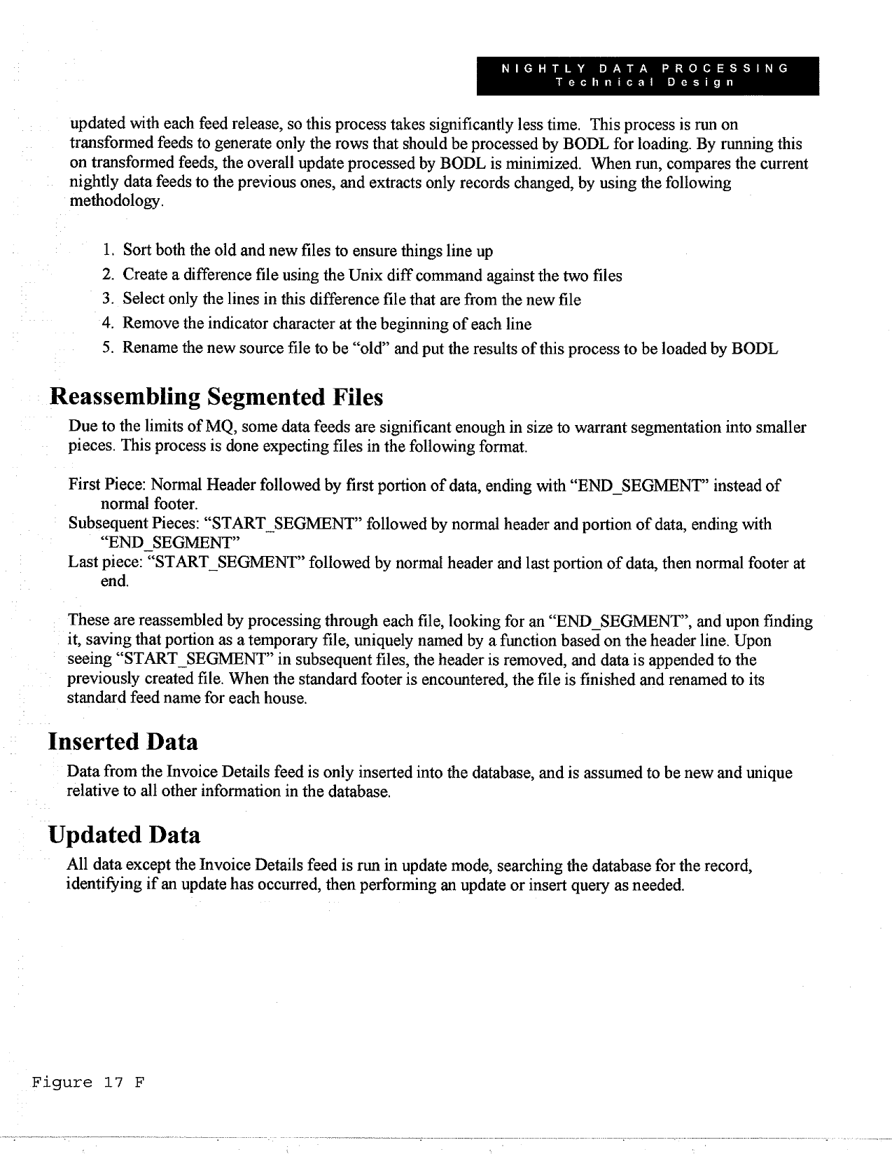

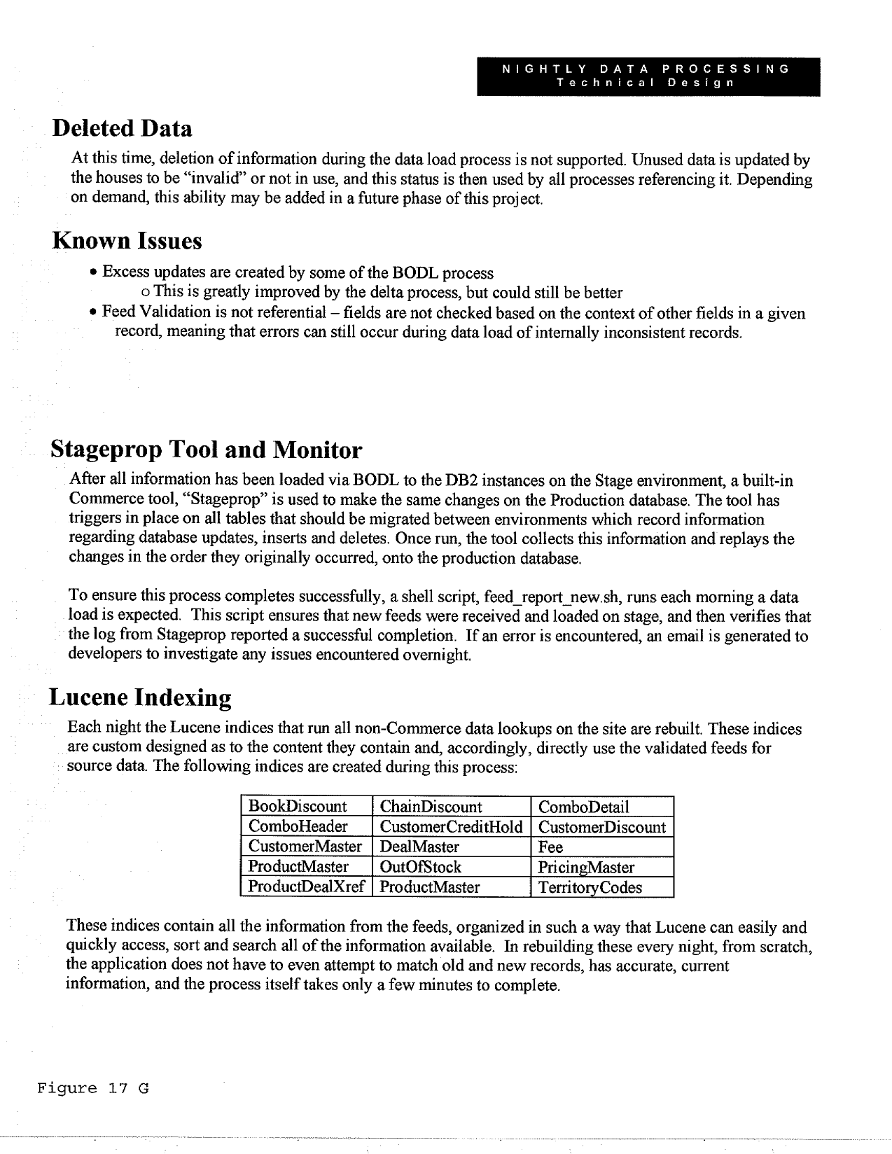

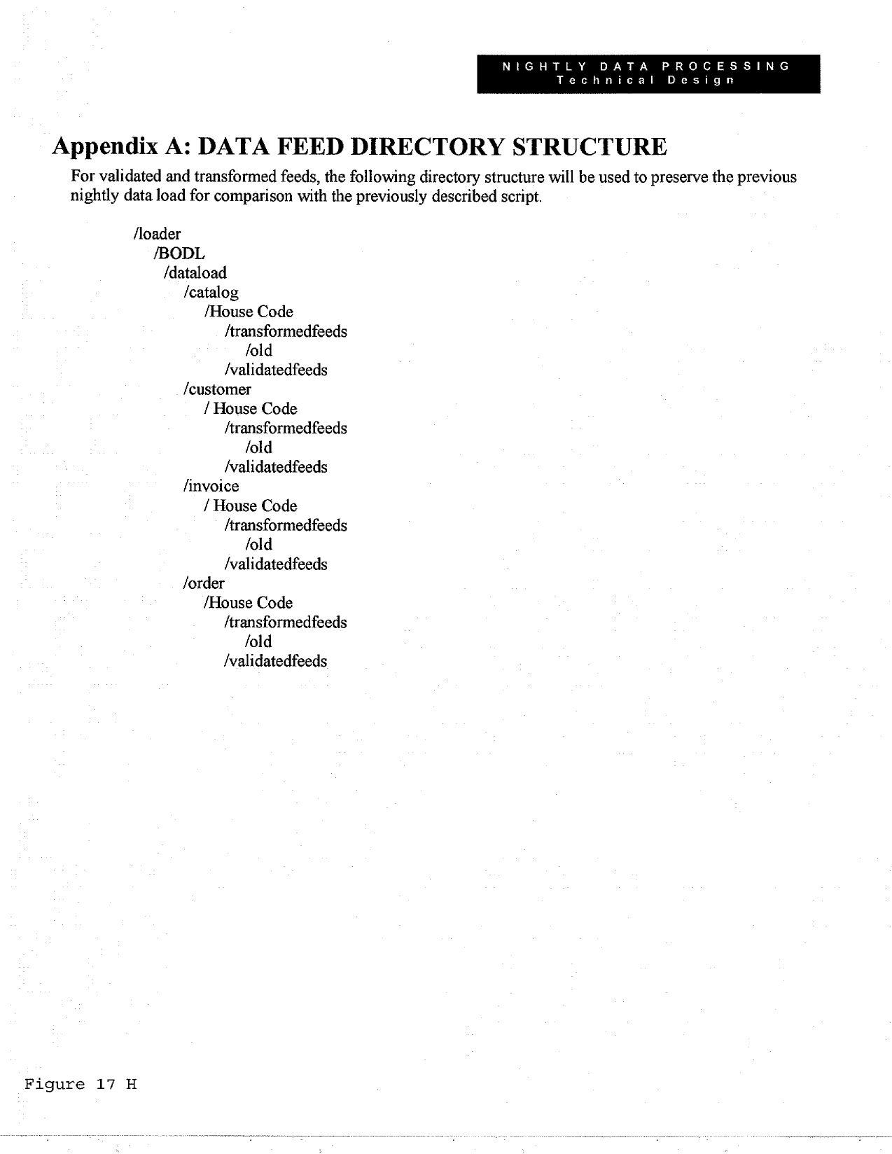

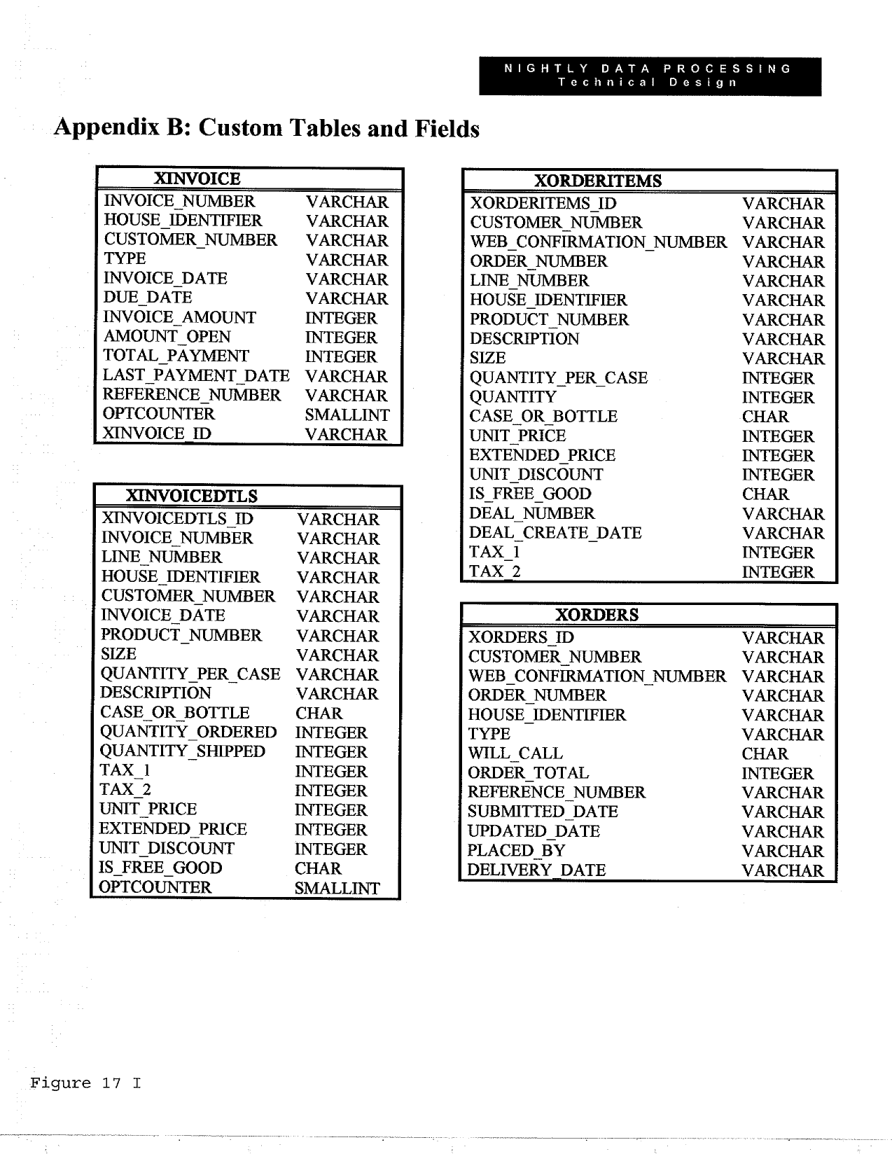

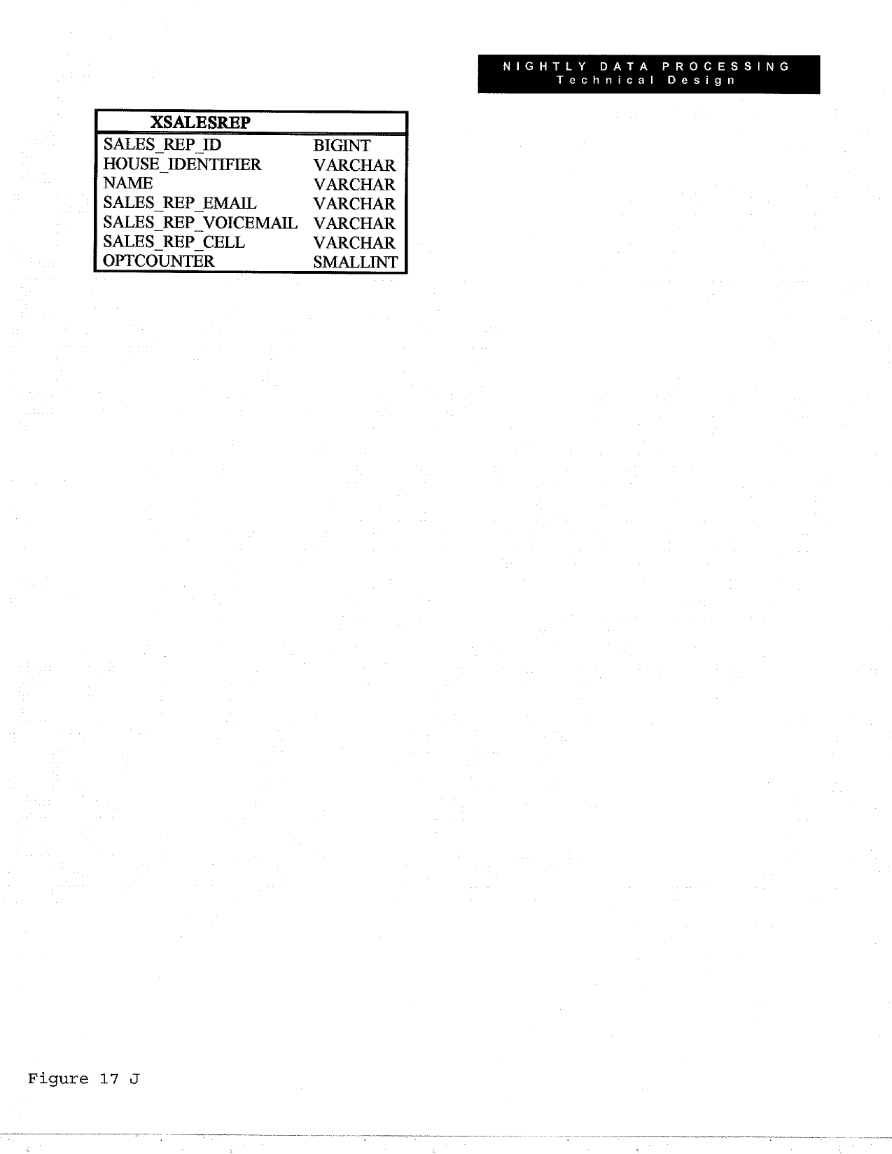

FIGS. 10-17 enable programmers with ordinary skill in the art to duplicate the described, preferred embodiment of the present invention, by laying out the details of the site/system.

The above description is not intended to limit the meaning of the words used in the following claims that define the invention. Other systems, methods, features, and advantages of the present invention will be, or will become, apparent to one having ordinary skill in the art upon examination of the foregoing drawings, written description and claims, and persons of ordinary skill in the art will understand that a variety of other designs still falling within the scope of the following claims may be envisioned and used. It is contemplated that these or other future modifications in structure, function or result will exist that are not substantial changes and that all such insubstantial changes in what is claimed are intended to be covered by the claims.

The terms in the following claims are intended to have their broadest meaning consistent with the requirements of law. Where alternative meanings are possible, the broadest meaning is intended. All words used in the claims are intended to be used in the normal, customary usage of grammar and the English language.

We claim:

1. An interactive online website enabling users to order products or services, comprising:
a prepopulated order sheet displaying at least some sales history of products or services previously purchased by a website user, the order sheet being organized to display a plurality of categories showing at least some of the products or services purchased by the consumer during a predetermined past period;
whereby the website is configured to permit the user to browse the prepopulated order sheet and to enter order quantities for selected products or services.

2. The website of claim 1, wherein the website user comprises one or more of the following: distributors; stores; retail chains; sales representatives.

3. The website of claim 1, further comprising a search tool permitting the user to commence a search by entering one or more of the following pieces of information in order to return relevant matches, and further enabling the user to then order products or services returned by the search with a subsequent single click: a SKU number associated with a product or service; a name associated with a product or service; or a UPC associated with a product or service.

4. The website of claim 1, wherein following one or more selections of products or services to be purchased by a website user, an order review screen is displayed showing all products or services on order and applicable prices and quantities for each selected product or service to be purchased, and wherein from the order review screen a single click enables the user to submit an order for the selected products or services to be purchased.

5. The website of claim 1, wherein upon entry by a website user of a quantity corresponding to a product or service displayed on the prepopulated order sheet, an order review screen is populated with one or more customized deals displayed to the user and pertaining to the selected products or services.

6. The website of claim 5, wherein the one or more displayed customized deals comprise one or more of the following: a discount; a free good; a mix-and-match deal; or a combo.

7. The website of claim 5, wherein the one or more displayed customized deals include an achievement indicator.

8. The website of claim 5, wherein the one or more displayed customized deals include a proximity indicator.

9. The website of claim 5, wherein the one or more displayed customized deals include achievement and proximity indicators.

10. The website of claim 5, wherein the one or more displayed customized deals update and may change based on the products or services selected on the order sheet.

11. The website of claim 4, wherein one or more of the following items, where applicable, are displayed on the order review screen and calculated to determine pricing for the ordered products or services: taxes; delivery fees; and deposits.

12. The website of claim 1, wherein invoice records are displayed on an accounts receivable webpage, the invoice records comprising orders placed both online and offline.

13. The website of claim 12, wherein the invoice records correspond to records of the user, or to records of a company affiliated with the user.

14. The website of claim 12, wherein a pay link is displayed on the accounts receivable webpage, enabling the user to select the pay link and to be redirected to a payment site.

15. The website of claim 1, wherein when products or services offered in a deal are view, the user is presented with an option to swap a currently displayed product or service with another product or service.

16. The website of claim 15, wherein the product or service offered to be swapped is a similar or comparable product or service of higher value than the currently displayed product or service.

17. The website of claim 1, wherein an advertisement is displayed on a web page, and the content of the advertisement is controllable by a provider of the website.

18. The website of claim 17, wherein the content of the advertisement may be customized based on characteristics of specific classes of users of the website.

19. The website of claim 1, wherein users can be associated with multiple accounts, accessible by a single login procedure.

20. The website of claim 1, wherein the website generates dynamic HTML web pages.

21. The website of claim 20, wherein the website generates dynamic HTML web pages using JAVA script.

22. The website of claim 20, wherein the website utilizes a search engine comprising a database layer.
